(19) United States
(12) Patent Application Publication
(10) Pub. No.: US 2024/0136715 A1
(43) Pub. Date: Apr. 25, 2024

(54) High-Isolation Terminal Antenna System

(71) Applicant: Honor Device Co., Ltd., Shenzhen (CN)

(72) Inventors: Dawei Zhou, Shenzhen (CN); Yuanpeng Li, Shenzhen (CN)

(21) Appl. No.: 18/548,036

(22) PCT Filed: Aug. 24, 2022
(86) PCT No.: PCT/CN2022/114817

§ 371 Date: Aug. 24, 2023

(30) Foreign Application Priority Data
Oct. 29, 2021 (CN) 202111278457.5

(51) Int. Cl. H01Q 7/00; H01Q 5/307

(52) U.S. Cl. CPC H01Q 7/00; H01Q 5/307

(57) ABSTRACT

A high-isolation terminal antenna system, to provide improved radiation performance and isolation by combining current loop antennas and/or magnetic loop antennas with different position features. The terminal antenna system includes a first antenna and a second antenna, and the first antenna and the second antenna include at least one current loop antenna or magnetic loop antenna. When the current loop antenna operates, a uniform magnetic field is distributed between a radiating element of the current loop antenna and a reference ground. When the magnetic loop antenna operates, a uniform electric field is distributed between a radiating element of the magnetic loop antenna and the reference ground. The first antenna and the second antenna are arranged at a same edge of an electronic device, or are arranged at two opposite edges of the electronic device.

This application claims priority to Chinese Patent Application No. 202111278457.5, filed with the China National Intellectual Property Administration on Oct. 30, 2021 and entitled “HIGH-ISOLATION TERMINAL ANTENNA SYSTEM”, which is incorporated herein by reference in its entirety.

### TECHNICAL FIELD

This application relates to the field of antenna technologies, and in particular, to a high-isolation terminal antenna system.

### BACKGROUND

Multiple antennas may be arranged in an electronic device, to support increasing wireless communication requirements of the electronic device. Mutual interference may be caused when the multiple antennas operate simultaneously, affecting overall radiation performance of the electronic device. Improving isolation between the multiple antennas can effectively reduce mutual impact in an operating process of the multiple antennas.

### SUMMARY

Embodiments of this application provide a high-isolation terminal antenna system, to provide good radiation performance and isolation by combining current loop antennas and/or magnetic loop antennas with different position features.

To achieve the foregoing objective, the following technical solutions are used in the embodiments of this application:

According to a first aspect, a high-isolation terminal antenna system is provided, and is applied to an electronic device. The terminal antenna system includes a first antenna and a second antenna, and the first antenna and the second antenna include at least one current loop antenna or magnetic loop antenna. When the current loop antenna operates, a uniform magnetic field is distributed between a radiating element of the current loop antenna and a reference ground; and when the magnetic loop antenna operates, a uniform electric field is distributed between a radiating element of the magnetic loop antenna and the reference ground. The first antenna and the second antenna are arranged at a same edge of the electronic device, or the first antenna and the second antenna are arranged at two opposite edges of the electronic device.

This solution provides two manners of obtaining high-isolation antennas that are arranged at different positions. In this example, the high-isolation antenna system may at least include one current loop antenna or magnetic loop antenna, to ensure that the antenna system can provide good radiation performance of at least one antenna for an operating frequency band. In addition, based on series position distribution or position distribution in parallel (in other words, the antennas are arranged at the same edge) and opposite position distribution (in other words, the antennas are arranged at two opposite edges), the two antennas can respectively excite orthogonal currents on a ground plane, to achieve a high-isolation characteristic.

In a possible design, when the first antenna is a magnetic loop antenna, the second antenna is a current loop antenna. This solution defines types of the antennas included in the antenna system in this application. For example, when one antenna is the magnetic loop antenna, the other antenna may be the current loop antenna.

In a possible design, the first antenna and the second antenna are fed directly; or the first antenna and the second antenna are fed in a coupled manner. This solution defines a feeding manner of the antennas included in the antenna system in this application. For example, any antenna in the terminal antenna system may be fed directly or in the coupled manner.

In a possible design, when the first antenna operates, a ground plane current is excited in a first direction; and when the second antenna operates, a ground plane current is excited in a second direction, where the first direction and the second direction are orthogonal. This solution provides descriptions indicating that the solution provided in this application can achieve the high-isolation characteristic. Because the two antennas can respectively excite the orthogonal (or approximately orthogonal) currents on the ground plane, the two antennas can achieve high isolation.

In a possible design, that the first antenna and the second antenna are arranged at a same edge of the electronic device includes: the first antenna and the second antenna are arranged at a first edge of the electronic device, and projections of the first antenna and the second antenna at the first edge do not overlap. This solution provides a specific position example of series distribution. In this example, two antennas in the terminal antenna system are used as an example. The two antennas may be distributed in series at the same edge of the electronic device (such as a mobile phone). For example, the two antennas are both located at an upper edge of the mobile phone, and distributed along an X axis, and the projections of the two antennas in a Y direction do not overlap, to implement the series distribution.

In a possible design, when the first antenna and the second antenna are fed directly, a feed point of the first antenna is arranged at an end of the first antenna close to the second antenna, and a feed point of the second antenna is arranged at an end of the second antenna close to the first antenna. Alternatively, a feed point of the first antenna is arranged at an end of the first antenna away from the second antenna, and a feed point of the second antenna is arranged at an end of the second antenna away from the first antenna. This solution provides a limitation on the feed point in the series distribution case. For example, the feed points of the two antennas may be arranged close to each other, or may be arranged away from each other.

In a possible design, the terminal antenna system further includes a third antenna, and the third antenna is also arranged at the first edge. Projections in a direction perpendicular to the first direction that are of radiating elements of the third antenna, the first antenna, and the second antenna do not overlap, and the second antenna is arranged between the first antenna and the third antenna. This solution provides an example of series distribution of three antennas. In this example, in addition to the first antenna and the second antenna, the third antenna may be further arranged. For example, the first antenna is arranged at a left part of a top edge of the mobile phone, the second antenna is arranged at a center of the top edge of the mobile phone, and the third antenna is arranged at a right part of the top edge of the mobile phone.

In a possible design, the first antenna is the magnetic loop antenna, the second antenna is the current loop antenna, and the third antenna is a magnetic loop antenna. This solution provides a limitation on a type of each antenna in a series distribution scenario of the three antennas.

In a possible design, the first antenna and the third antenna form a first distributed antenna pair, the first distributed antenna pair includes a first port, and the first port is connected to a port of the first antenna and a port of the third antenna; and when the terminal antenna system operates, feed signals of an equal amplitude and a same phase are respectively input to the first antenna and the third antenna through the first port. This solution provides an example of a feeding excitation manner of each antenna in the series distribution scenario of the three antennas. In this example, the first antenna and the third antenna may form the distributed antenna pair. The port of the first antenna and the port of the second antenna may be connected to the first port for feeding, and the first antenna and the third antenna are symmetrically fed through the first port. In this way, a ground plane current excited by the distributed antenna pair including the first antenna and the third antenna may be orthogonally distributed with the ground plane current excited by the second antenna, to achieve the high-isolation characteristic.

In a possible design, all the first antenna, the second antenna, and the third antenna are current loop antennas. This solution provides another limitation on a type of each antenna in a series distribution scenario of the three antennas.

In a possible design, the first antenna and the third antenna form a second distributed antenna pair, the second distributed antenna pair includes a second port, and the second port is connected to a port of the first antenna and a port of the third antenna; and when the terminal antenna system operates, feed signals of an equal amplitude and opposite phases are respectively input to the first antenna and the third antenna through the first port. A direction of a ground plane current excited by the second distributed antenna pair is orthogonal to a direction of the ground plane current excited by the second antenna. According to this solution, the first antenna and the third antenna (namely, a left current loop antenna and a right current loop antenna) may be asymmetrically fed, so that the ground plane current excited by the distributed antenna pair including the first antenna and the third antenna may be orthogonally distributed with the ground plane current excited by the second antenna, to achieve the high-isolation characteristic.

In a possible design, that the first antenna and the second antenna are arranged at a same edge of the electronic device includes: the first antenna and the second antenna are arranged at a first edge of the electronic device, and projections of the first antenna and the second antenna at the first edge at least partially overlap. This solution provides a specific position example of distribution in parallel. In this example, two antennas in the terminal antenna system are used as an example. The two antennas may be distributed in parallel at the same edge of the electronic device (such as a mobile phone). For example, the two antennas are both located at an upper edge of the mobile phone, and distributed along an X axis, and projections of the two antennas in a Y direction at least partially overlap, to implement the distribution in parallel.

In a possible design, planes on which radiating elements of the first antenna and the second antenna are located are orthogonal. This solution provides a specific implementation of the distribution in parallel. For example, the first antenna may be located on an xoz plane, and the second antenna may be located on an xoy plane. Projections on the X axis at least partially overlap.

In a possible design, when the first antenna is a current loop antenna, the second antenna is any one of the following antennas: a magnetic loop antenna, a CM wire antenna, or a DM slot antenna. This solution provides a limitation on types of the two antennas in the scenario of distribution in parallel. It may be understood that the current loop antenna can excite a transverse current, and the magnetic loop antenna, the CM wire antenna, and the DM slot antenna can excite a longitudinal current, so that the first antenna and the second antenna achieve the high-isolation characteristic.

In a possible design, that the first antenna and the second antenna are arranged at two opposite edges of the electronic device includes: the first antenna is arranged at a first position at a first edge of the electronic device, the second antenna is arranged at a second position at a second edge of the electronic device, and the first edge and the second edge are both adjacent to a third edge of the electronic device. This solution provides a specific position example of opposite distribution. In this example, two antennas in the terminal antenna system are used as an example. The two antennas may be arranged at two opposite edges of the electronic device (such as a mobile phone). For example, the first antenna is located at a left long edge of the mobile phone, and the second antenna is located at a right long edge of the mobile phone.

In a possible design, the first position and the second position are axially symmetrical about a center line of the third edge. This solution provides a limitation on an opposite position relationship between the first antenna and the second antenna. For example, the positions of the first antenna and the second antenna may be symmetrical about a center line of an upper edge of the mobile phone. In this way, the first antenna and the second antenna may be respectively located at upper, middle, or lower ends of the left and right long edges.

In a possible design, the first position is in the middle of the first edge, and the second position is in the middle of the second edge. This solution provides a specific limitation on the positions of the first antenna and the second antenna. For example, the first antenna may be in the middle of the left long edge, and the second antenna may be in the middle of the right long edge.

In a possible design, when the first antenna and the second antenna are fed directly, a feed point of the first antenna is arranged on a radiating element of the first antenna, a feed point of the second antenna is arranged on a radiating element of the second antenna, and the feed points of the first antenna and the second antenna are arranged on a same side of the radiating element of the first antenna and the radiating element of the second antenna. This solution provides an example of positions of the feed points of the directly fed antennas in scenarios of distribution in parallel and opposite distribution. For example, when the two antennas are distributed in parallel at an upper edge, the feed points of the two antennas may be both arranged at left ends or right ends of the radiating elements of the two antennas. For another example, when the two antennas are oppositely distributed at left and right edges, the feed points of the directly fed antennas may be both arranged at upper ends or lower ends of the radiating elements of the antennas.

In a possible design, the current loop antenna includes a current loop wire antenna and a current loop slot antenna. At least one first capacitor that is grounded is connected in parallel on a radiating element of the current loop wire antenna, and at least one second capacitor is connected in series on a radiating element of the current loop slot antenna. The first capacitor is used to adjust a current distribution on the current loop wire antenna to obtain a uniform magnetic field between the current loop wire antenna and the reference ground, and the second capacitor is used to adjust a current distribution on the current loop slot antenna to obtain a uniform magnetic field between the current loop slot antenna and the reference ground. This solution provides a specific description example of the current loop antenna.

In a possible design, the current loop wire antenna includes a current loop monopole antenna and a current loop dipole antenna, and the current loop slot antenna includes a current loop left-hand antenna and a current loop aperture antenna. This solution provides several specific type examples of the current loop antenna.

In a possible design, at least one first inductor that is grounded is connected in parallel on a radiating element of the magnetic loop wire antenna, and at least one second inductor is connected in series on a radiating element of the magnetic loop slot antenna. The first inductor is used to adjust a current distribution on the magnetic loop wire antenna to obtain a uniform electric field between the magnetic loop wire antenna and the reference ground, and the second inductor is used to adjust a current distribution on the magnetic loop slot antenna to obtain a uniform electric field between the magnetic loop slot antenna and the reference ground. This solution provides a specific description example of the magnetic loop antenna.

In a possible design, the magnetic loop wire antenna includes a magnetic loop monopole antenna and a magnetic loop dipole antenna, and the magnetic loop slot antenna includes a magnetic loop left-hand antenna and a magnetic loop aperture antenna. This solution provides several specific type examples of the magnetic loop antenna.

According to a second aspect, a high-isolation terminal antenna system is provided, and is applied to an electronic device. The terminal antenna system includes a first antenna and a second antenna, and the first antenna and the second antenna include at least one current loop antenna or magnetic loop antenna. The first antenna and the second antenna are arranged at a same edge of the electronic device; or the first antenna and the second antenna are arranged at two opposite edges of the electronic device. When the current loop antenna is a current loop monopole antenna or a current loop dipole antenna, a first capacitor that is grounded is arranged at at least one end of a radiating element of the current loop antenna. When the current loop antenna is a current loop aperture antenna or a current loop left-hand antenna, at least one second capacitor is arranged in series on a radiating element of the current loop antenna. Capacitance ranges of the first capacitor and the second capacitor are set as follows: when an operating frequency band of the current loop antenna is at 450 MHz to 1 GHz, a capacitance value of the first capacitor or the second capacitor is set within [1.5 pF, 15 pF]; when an operating frequency band of the current loop antenna is at 1 GHz to 3 GHz, a capacitance value of the first capacitor or the second capacitor is set within [0.5 pF, 15 pF]; or when an operating frequency band of the current loop antenna is at 3 GHz to 10 GHz, a capacitance value of the first capacitor or the second capacitor is set within [1.2 pF, 12 pF]. When the magnetic loop antenna is a magnetic loop monopole antenna or a magnetic loop dipole antenna, a first inductor that is grounded is disposed at at least one end of a radiating element of the magnetic loop antenna. When the magnetic loop antenna is a magnetic loop aperture antenna or a magnetic loop left-hand antenna, at least one second inductor is arranged in series on a radiating element of the magnetic loop antenna Inductance ranges of the first inductor and the second inductor are set as follows: when an operating frequency band of the magnetic loop antenna is at 450 MHz to 1 GHz, an inductance value of the first inductor or the second inductor is set within [5 nH, 47 nH]; when an operating frequency band of the magnetic loop antenna is at 1 GHz to 3 GHz, an inductance value of the first inductor or the second inductor is set within [1 nH, 33 nH]; or when an operating frequency band of the magnetic loop antenna is at 3 GHz to 10 GHz, an inductance value of the first inductor or the second inductor is set within [0.5 nH, 10 nH].

This solution provides two manners of obtaining high-isolation antennas that are arranged at different positions. In this example, the high-isolation antenna system may at least include one current loop antenna or magnetic loop antenna, to ensure that the antenna system can provide good radiation performance of at least one antenna for an operating frequency band. In addition, based on series position distribution or position distribution in parallel (in other words, the antennas are arranged at the same edge) and opposite position distribution (in other words, the antennas are arranged at two opposite edges), the two antennas can respectively excite orthogonal currents on a ground plane, to achieve a high-isolation characteristic. In addition, in this example, the values of the capacitors or the inductors arranged on the current loop antenna and the magnetic loop antenna are further limited.

In a possible design, when the first antenna is a magnetic loop antenna, the second antenna is a current loop antenna. This solution defines types of the antennas included in the antenna system in this application. For example, when one antenna is the magnetic loop antenna, the other antenna may be the current loop antenna.

In a possible design, the first antenna and the second antenna are fed directly: or the first antenna and the second antenna are fed in a coupled manner. This solution defines a feeding manner of the antennas included in the antenna system in this application. For example, any antenna in the terminal antenna system may be fed directly or in the coupled manner.

In a possible design, when the first antenna operates, a ground plane current is excited in a first direction; and when the second antenna operates, a ground plane current is excited in a second direction, where the first direction and the second direction are orthogonal. This solution provides descriptions indicating that the solution provided in this application can achieve the high-isolation characteristic. Because the two antennas can respectively excite the orthogonal (or approximately orthogonal) currents on the ground plane, the two antennas can achieve high isolation.

In a possible design, that the first antenna and the second antenna are arranged at a same edge of the electronic device includes: the first antenna and the second antenna are arranged at a first edge of the electronic device, and projections of the first antenna and the second antenna at the first edge do not overlap. This solution provides a specific position example of series distribution. In this example, two antennas in the terminal antenna system are used as an example. The two antennas may be distributed in series at the same edge of the electronic device (such as a mobile phone). For example, the two antennas are both located at an upper edge of the mobile phone, and distributed along an X axis, and the projections of the two antennas in a Y direction do not overlap, to implement the series distribution.

In a possible design, when the first antenna and the second antenna are fed directly, a feed point of the first antenna is arranged at an end of the first antenna close to the second antenna, and a feed point of the second antenna is arranged at an end of the second antenna close to the first antenna. Alternatively, a feed point of the first antenna is arranged at an end of the first antenna away from the second antenna, and a feed point of the second antenna is arranged at an end of the second antenna away from the first antenna. This solution provides a limitation on the feed point in the series distribution case. For example, the feed points of the two antennas may be arranged close to each other, or may be arranged away from each other.

In a possible design, the terminal antenna system further includes a third antenna, and the third antenna is also arranged at the first edge. Projections in a direction perpendicular to the first direction that are of radiating elements of the third antenna, the first antenna, and the second antenna do not overlap, and the second antenna is arranged between the first antenna and the third antenna. This solution provides an example of series distribution of three antennas. In this example, in addition to the first antenna and the second antenna, the third antenna may be further arranged. For example, the first antenna is arranged at a left part of a top edge of the mobile phone, the second antenna is arranged at a center of the top edge of the mobile phone, and the third antenna is arranged at a right part of the top edge of the mobile phone.

In a possible design, the first antenna is the magnetic loop antenna, the second antenna is the current loop antenna, and the third antenna is a magnetic loop antenna. This solution provides a limitation on a type of each antenna in a series distribution scenario of the three antennas.

In a possible design, the first antenna and the third antenna form a first distributed antenna pair, the first distributed antenna pair includes a first port, and the first port is connected to a port of the first antenna and a port of the third antenna; and when the terminal antenna system operates, feed signals of an equal amplitude and a same phase are respectively input to the first antenna and the third antenna through the first port. This solution provides an example of a feeding excitation manner of each antenna in the series distribution scenario of the three antennas. In this example, the first antenna and the third antenna may form the distributed antenna pair. The port of the first antenna and the port of the second antenna may be connected to the first port for feeding, and the first antenna and the third antenna are symmetrically fed through the first port. In this way, a ground plane current excited by the distributed antenna pair including the first antenna and the third antenna may be orthogonally distributed with the ground plane current excited by the second antenna, to achieve the high-isolation characteristic.

In a possible design, all the first antenna, the second antenna, and the third antenna are current loop antennas. This solution provides another limitation on a type of each antenna in a series distribution scenario of the three antennas.

In a possible design, the first antenna and the third antenna form a second distributed antenna pair, the second distributed antenna pair includes a second port, and the second port is connected to a port of the first antenna and a port of the third antenna; and when the terminal antenna system operates, feed signals of an equal amplitude and opposite phases are respectively input to the first antenna and the third antenna through the first port. A direction of a ground plane current excited by the second distributed antenna pair is orthogonal to a direction of the ground plane current excited by the second antenna. According to this solution, the first antenna and the third antenna (namely, a left current loop antenna and a right current loop antenna) may be asymmetrically fed, so that the ground plane current excited by the distributed antenna pair including the first antenna and the third antenna may be orthogonally distributed with the ground plane current excited by the second antenna, to achieve the high-isolation characteristic.

In a possible design, that the first antenna and the second antenna are arranged at a same edge of the electronic device includes: the first antenna and the second antenna are arranged at a first edge of the electronic device, and projections of the first antenna and the second antenna at the first edge at least partially overlap. This solution provides a specific position example of distribution in parallel. In this example, two antennas in the terminal antenna system are used as an example. The two antennas may be distributed in parallel at the same edge of the electronic device (such as a mobile phone). For example, the two antennas are both located at an upper edge of the mobile phone, and distributed along an X axis, and projections of the two antennas in a Y direction at least partially overlap, to implement the distribution in parallel.

In a possible design, planes on which radiating elements of the first antenna and the second antenna are located are orthogonal. This solution provides a specific implementation of the distribution in parallel. For example, the first antenna may be located on an xoz plane, and the second antenna may be located on an xoy plane. Projections on the X axis at least partially overlap.

In a possible design, when the first antenna is a current loop antenna, the second antenna is any one of the following antennas: a magnetic loop antenna, a CM wire antenna, or a DM slot antenna. This solution provides a limitation on types of the two antennas in the scenario of distribution in parallel. It may be understood that the current loop antenna can excite a transverse current, and the magnetic loop antenna, the CM wire antenna, and the DM slot antenna can excite a longitudinal current, so that the first antenna and the second antenna achieve the high-isolation characteristic.

In a possible design, that the first antenna and the second antenna are arranged at two opposite edges of the electronic device includes: the first antenna is arranged at a first position at a first edge of the electronic device, the second antenna is arranged at a second position at a second edge of the electronic device, and the first edge and the second edge are both adjacent to a third edge of the electronic device. This solution provides a specific position example of opposite distribution. In this example, two antennas in the terminal antenna system are used as an example. The two antennas may be arranged at two opposite edges of the electronic device (such as a mobile phone). For example, the first antenna is located at a left long edge of the mobile phone, and the second antenna is located at a right long edge of the mobile phone.

In a possible design, the first position and the second position are axially symmetrical about a center line of the third edge. This solution provides a limitation on an opposite position relationship between the first antenna and the second antenna. For example, the positions of the first antenna and the second antenna may be symmetrical about a center line of an upper edge of the mobile phone. In this way, the first antenna and the second antenna may be respectively located at upper, middle, or lower ends of the left and right long edges.

In a possible design, the first position is in the middle of the first edge, and the second position is in the middle of the second edge. This solution provides a specific limitation on the positions of the first antenna and the second antenna. For example, the first antenna may be in the middle of the left long edge, and the second antenna may be in the middle of the right long edge.

In a possible design, when the first antenna and the second antenna are fed directly, a feed point of the first antenna is arranged on a radiating element of the first antenna, a feed point of the second antenna is arranged on a radiating element of the second antenna, and the feed points of the first antenna and the second antenna are arranged on a same side of the radiating element of the first antenna and the radiating element of the second antenna. This solution provides an example of positions of the feed points of the directly fed antennas in scenarios of distribution in parallel and opposite distribution. For example, when the two antennas are distributed in parallel at an upper edge, the feed points of the two antennas may be both arranged at left ends or right ends of the radiating elements of the two antennas. For another example, when the two antennas are oppositely distributed at left and right edges, the feed points of the directly fed antennas may be both arranged at upper ends or lower ends of the radiating elements of the antennas.

According to a third aspect, an electronic device is provided. The electronic device is provided with the terminal antenna system according to any one of the first aspect and the possible designs of the first aspect. When the electronic device transmits or receives a signal, the signal is transmitted or received through the terminal antenna system.

It should be understood that all the technical features of the technical solutions provided in the second aspect and the third aspect can correspond to the terminal antenna system provided in the first aspect and the possible designs of the first aspect. Therefore, similar beneficial effects can be achieved. Details are not described herein again.

### BRIEF DESCRIPTION OF DRAWINGS

FIG. 1 is a schematic diagram of a multi-antenna scenario;

FIG. 2 is a schematic stacking diagram of an electronic device according to an embodiment of this application;

FIG. 3 is a schematic diagram of antenna arrangement on a metal housing according to an embodiment of this application;

FIG. 4 is a schematic composition diagram of an electronic device according to an embodiment of this application;

FIG. 5 is a schematic diagram of operation of a current loop antenna according to an embodiment of this application;

FIG. 6 is a schematic composition diagram of a current loop antenna according to an embodiment of this application;

FIG. 7 is a schematic diagram of a current loop antenna fed in a coupled manner according to an embodiment of this application;

FIG. 8 is a schematic diagram of operation of a magnetic loop antenna according to an embodiment of this application;

FIG. 9 is a schematic composition diagram of a magnetic loop antenna according to an embodiment of this application:

FIG. 10 is a schematic diagram of a magnetic loop antenna fed in a coupled manner according to an embodiment of this application:

FIG. 11 is a schematic diagram of a position of an antenna pair in series distribution according to an embodiment of this application:

FIG. 12 is a schematic diagram of a position of an antenna pair in distribution in parallel according to an embodiment of this application;

FIG. 13A is a schematic diagram of a position of an antenna pair in opposite distribution according to an embodiment of this application:

FIG. 13B is a schematic diagram of a position of an antenna pair in orthogonal distribution according to an embodiment of this application:

FIG. 13C is a schematic structural diagram of a CM antenna and a DM antenna according to an embodiment of this application:

FIG. 14 is a schematic diagram of orthogonality of ground plane currents according to an embodiment of this application:

FIG. 15 is a schematic diagram of a ground plane current distribution according to an embodiment of this application:

FIG. 16 is a schematic diagram of a ground electric field distribution according to an embodiment of this application:

FIG. 17A is a schematic diagram of an antenna pair in series according to an embodiment of this application;

FIG. 17B is a schematic diagram showing that a magnetic loop antenna excites a ground plane current according to an embodiment of this application:

FIG. 18 is a schematic diagram of a ground plane current of an antenna pair in series according to an embodiment of this application;

FIG. 19 is a schematic diagram of a directivity pattern of an antenna pair in series according to an embodiment of this application;

FIG. 20 is a schematic diagram of S parameters of an antenna pair in series according to an embodiment of this application;

FIG. 21 is a schematic diagram of efficiency of an antenna pair in series according to an embodiment of this application;

FIG. 22A is another schematic composition diagram of an antenna pair in series according to an embodiment of this application;

FIG. 22B is a schematic diagram of an antenna group including three antennas connected in series according to an embodiment of this application;

FIG. 22C is a schematic diagram of a directivity pattern of an antenna group in series according to an embodiment of this application;

FIG. 22D is a schematic diagram of isolation of an antenna group in series according to an embodiment of this application;

FIG. 22E is a schematic composition diagram of an antenna group in series according to an embodiment of this application;

FIG. 22F is a schematic diagram of a directivity pattern of an antenna group in series according to an embodiment of this application;

FIG. 23A is a schematic diagram of an antenna pair in parallel according to an embodiment of this application;

FIG. 23B is a schematic diagram of a structure implementation of an antenna pair in parallel according to an embodiment of this application;

FIG. 24 is a schematic diagram of a current of an antenna pair in parallel according to an embodiment of this application:

FIG. 25 is a schematic diagram of a directivity pattern of an antenna pair in parallel according to an embodiment of this application;

FIG. 26 is a schematic diagram of S parameters of an antenna pair in parallel according to an embodiment of this application;

FIG. 27 is a schematic diagram of efficiency of an antenna pair in parallel according to an embodiment of this application;

FIG. 28 is a schematic diagram of an antenna pair in parallel according to an embodiment of this application;

FIG. 29 is a schematic diagram of a directivity pattern of an antenna pair in parallel according to an embodiment of this application;

FIG. 30 is a schematic diagram of S parameters of an antenna pair in parallel according to an embodiment of this application;

FIG. 31 is a schematic diagram of efficiency of an antenna pair in parallel according to an embodiment of this application;

FIG. 32 is a schematic diagram of an antenna pair in parallel according to an embodiment of this application:

FIG. 33 is a schematic diagram of a current of an antenna pair in parallel according to an embodiment of this application;

FIG. 34 is a schematic diagram of a directivity pattern of an antenna pair in parallel according to an embodiment of this application;

FIG. 35 is a schematic diagram of S parameters of an antenna pair in parallel according to an embodiment of this application;

FIG. 36 is a schematic diagram of efficiency of an antenna pair in parallel according to an embodiment of this application;

FIG. 37 is a schematic diagram of an antenna pair in parallel according to an embodiment of this application;

FIG. 38 is a schematic diagram of a directivity pattern of an antenna pair in parallel according to an embodiment of this application:

FIG. 39 is a schematic diagram of S parameters of an antenna pair in parallel according to an embodiment of this application:

FIG. 40 is a schematic diagram of efficiency of an antenna pair in parallel according to an embodiment of this application:

FIG. 41 is a schematic diagram of an antenna pair in parallel according to an embodiment of this application;

FIG. 42 is a schematic diagram of an opposite antenna pair according to an embodiment of this application;

FIG. 43 is a specific example of an opposite antenna pair according to an embodiment of this application;

FIG. 44 is a schematic diagram of a current flow direction of an opposite antenna pair according to an embodiment of this application:

FIG. 45A is a schematic diagram of current simulation of an opposite antenna pair according to an embodiment of this application:

FIG. 45B is a schematic diagram of current simulation of an opposite antenna pair according to an embodiment of this application;

FIG. 45C is a schematic diagram of a directivity pattern of an opposite antenna pair according to an embodiment of this application:

FIG. 46 is a schematic diagram of S parameters of an opposite antenna pair according to an embodiment of this application;

FIG. 47 is a schematic diagram of an orthogonal antenna pair according to an embodiment of this application;

FIG. 48 is a schematic diagram of a directivity pattern of an orthogonal antenna pair according to an embodiment of this application;

FIG. 49 is a schematic diagram of S parameters of an orthogonal antenna pair according to an embodiment of this application:

FIG. 50 is a schematic diagram of an orthogonal antenna pair according to an embodiment of this application;

FIG. 51 is a schematic diagram of a directivity pattern of an orthogonal antenna pair according to an embodiment of this application;

FIG. 52 is a schematic diagram of S parameters of an orthogonal antenna pair according to an embodiment of this application;

FIG. 53A is a schematic diagram of an orthogonal antenna group including three antennas according to an embodiment of this application;

FIG. 53B is a schematic diagram of a current flow direction of an orthogonal antenna group including three antennas according to an embodiment of this application;

FIG. 54 is a schematic diagram of a directivity pattern of an orthogonal antenna group including three antennas according to an embodiment of this application;

FIG. 55 is a schematic diagram of S parameters of an orthogonal antenna group including three antennas according to an embodiment of this application;

FIG. 56 is a schematic diagram of a directivity pattern of an orthogonal antenna group including three antennas according to an embodiment of this application;

FIG. 57 is a schematic diagram of S parameters of an orthogonal antenna group including three antennas according to an embodiment of this application;

FIG. 58A is a schematic diagram of an orthogonal antenna group including three antennas according to an embodiment of this application;

FIG. 58B is a schematic diagram of current simulation of an orthogonal antenna group including three antennas according to an embodiment of this application;

FIG. 59 is a schematic diagram of a directivity pattern of an orthogonal antenna group including three antennas according to an embodiment of this application;

FIG. 60 is a schematic diagram of S parameters of an orthogonal antenna group including three antennas according to an embodiment of this application;

FIG. 61 is a schematic diagram of an orthogonal antenna group including three antennas according to an embodiment of this application;

FIG. 62 is a schematic diagram of a directivity pattern of an orthogonal antenna group including three antennas according to an embodiment of this application;

FIG. 63 is a schematic diagram of S parameters of an orthogonal antenna group including three antennas according to an embodiment of this application:

FIG. 64 is a schematic diagram of a directivity pattern of an orthogonal antenna group including three antennas according to an embodiment of this application; and

FIG. 65 is a schematic diagram of S parameters of an orthogonal antenna group including three antennas according to an embodiment of this application.

### DESCRIPTION OF EMBODIMENTS

With development of wireless communication technologies, multiple antennas usually need to be arranged in an electronic device to meet requirements of the electronic device on wireless communication functions. Operating frequency bands of some antennas may overlap partially or completely, thereby improving communication capabilities of the corresponding frequency bands.

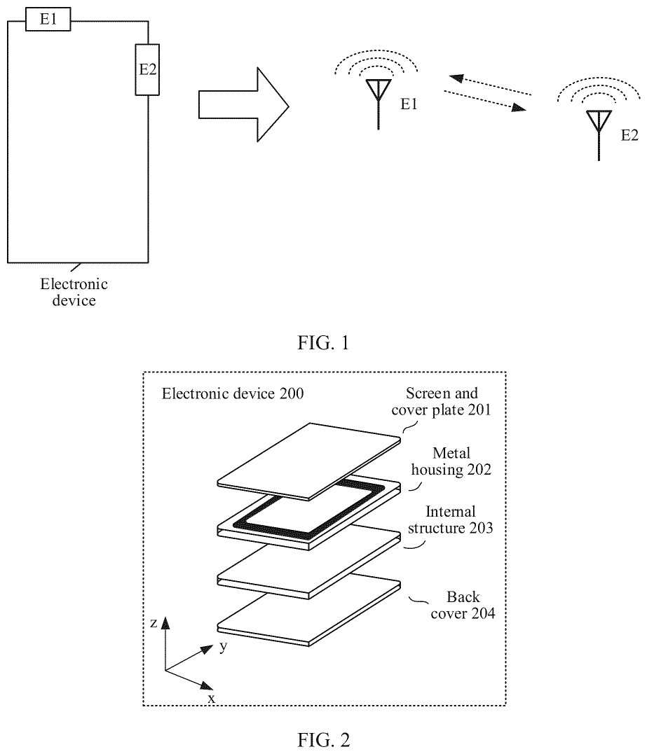

With reference to FIG. 1, an example in which antennas arranged in an electronic device include E1 and E2 and operating frequency bands of E1 and E2 overlap is used. When the electronic device performs wireless communication by using the operating frequency band corresponding to E1 and E2, E1 and E2 may operate simultaneously. For example, when E1 operates, a signal of the electronic device may be transmitted in an electromagnetic wave form. A resonance frequency corresponding to the electromagnetic wave may fall within the operating frequency band of E1, so that the signal is transmitted. E2 may convert an electromagnetic wave in external space into a signal (such as an analog signal) that the electronic device can process, to receive the signal.

It may be understood that because E1 and E2 has the same operating frequency band, signals received by E2 may include a signal sent by E1. It is clear that the electronic device does not need to receive the signal. Therefore, the signal is an invalid signal for operation of E2. In other words, when E1 and E2 operate simultaneously, the two antennas may affect each other. This reduces wireless communication efficiency of the antennas.

The foregoing uses a scenario in which E1 performs transmission and E2 performs reception as an example. In another scenario, a similar problem may also exist to reduce the wireless communication efficiency of the antennas. For example, in a scenario in which E1 performs reception and E2 performs transmission, a similar mechanism also causes the same problem. In addition, when the operating frequency bands of E1 and E2 are different, using an example in which the operating frequency band of E1 is lower than that of E2, although the operating frequency band of E1 does not overlap that of E2, a multiple of a corresponding resonance frequency when E1 operates may also affect operation of E2.

To resolve a problem of mutual impact in a multi-antenna scenario, the impact between antennas can be reduced by improving isolation (isolation) between the antennas. Better isolation between the antennas indicates smaller mutual impact between the antennas. The isolation may be identified by a normalized value. Using dual-port isolation as an example, the isolation may be identified by S21 (or S12) in S parameters, and values of S21 at different frequencies correspond to dual-port isolation at the frequencies. After normalization, a maximum value of the isolation does not exceed 0. A larger absolute value of the isolation indicates better isolation and smaller impact between the antennas. Correspondingly, a smaller absolute value of the isolation indicates worse isolation and larger impact between the antennas. For ease of description, in the following examples, the absolute value of the isolation is referred to as the isolation for short. For example, that the absolute value of the isolation is large is referred to as that the isolation is large for short. For another example, that the absolute value of the isolation is small is referred to as that the isolation is small for short.

It should be understood that radiation performance of antennas also affects isolation between the antennas. Still with reference to the example shown in FIG. 1, when E1 and E2 affect each other and no other impact is considered, better radiation performance of the antennas indicates smaller isolation between the antennas and greater mutual impact. For example, if the radiation performance of E1 is better, isolation from E2 is worse at a frequency or in a frequency band with good radiation performance. However, to ensure the wireless communication function of the electronic device, the antenna needs to provide good radiation performance. In other words, the antenna in the electronic device needs to not only provide good radiation performance but also have high isolation between the antennas. This imposes high requirements on a multi-antenna design in the electronic device.

To resolve the foregoing problem, embodiments of this application provide a high-isolation antenna solution, to enable antennas to provide good radiation performance and have high isolation. It should be noted that the radiation performance in the embodiments of this application may refer to radiation efficiency and/or system efficiency of the corresponding antenna. The radiation efficiency may identify a maximum radiation capability of an antenna system, and the system efficiency identifies a status of efficiency that the antenna can provide under a current environment and port matching.

The following first describes an implementation scenario of the high-isolation antenna solution provided in the embodiments of this application.

The antenna solution provided in the embodiments of this application can be applied to an electronic device of a user, to support a wireless communication function of the electronic device. For example, the electronic device may be a portable mobile device such as a mobile phone, a tablet computer, a personal digital assistant (personal digital assistant, PDA), an augmented reality (augmented reality, AR)/virtual reality (virtual reality, VR) device, and a media player, or the electronic device may be a wearable electronic device such as a smartwatch. A specific form of the device is not particularly limited in the embodiments of this application.

FIG. 2 is a schematic structural diagram of an electronic device 200 according to an embodiment of this application. As shown in FIG. 2, the electronic device 200 provided in this embodiment of this application may be sequentially provided with a screen and a cover plate 201, a metal housing 202, an internal structure 203, and a back cover 204 from top to bottom along a z-axis.

The screen and the cover plate 201 may be configured to implement a display function of the electronic device 200. The metal housing 202 may be used as a main frame of the electronic device 200, and provide a rigid support for the electronic device 200. The internal structure 203 may include a set of electronic components and mechanical components for implementing various functions of the electronic device 200. For example, the internal structure 203 may include a shielding cover, a screw, and a reinforcement rib. The back cover 204 may be an exterior surface of the back of the electronic device 200, and may be made of a glass material, a ceramic material, plastic, and the like in different implementations.

The antenna solution provided in the embodiments of this application can be applied to the electronic device 200 shown in FIG. 2, to support a wireless communication function of the electronic device 200. In some embodiments, antennas in the antenna solution may be arranged on the metal housing 202 of the electronic device 200. In some other embodiments, antennas m the antenna solution may be arranged on the back cover 204 or the like of the electronic device 200.

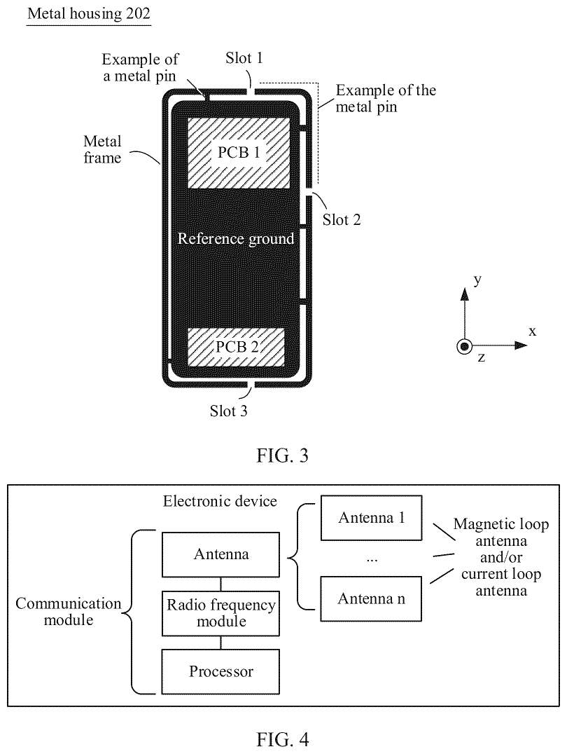

In an example, the metal housing 202 has a metal framework. FIG. 3 is a schematic composition diagram of the metal housing 202. In this example, the metal housing 202 may be made of a metal material such as aluminum alloy. As shown in FIG. 3, the metal housing 202 may be provided with a reference ground. The reference ground may be a metal material with a large area and used to provide most of the rigid support, and provide a zero potential reference for the electronic components. In the example shown in FIG. 3, a metal frame may further be arranged around the reference ground. The metal frame may be complete and closed, and may include metal bars, where a part or all of the metal bars are suspended. In some other implementations, the metal frame may alternatively be a metal frame shown in FIG. 3 that is segmented by one or more slots. For example, in the example in FIG. 3, a slot 1, a slot 2, and a slot 3 may be provided at different positions of the metal frame. These slots may segment the metal frame to obtain separate metal branches. In some embodiments, a part or all of the metal branches may be used as a radiating branch of the antenna, to implement structure reuse in an antenna arrangement process, and reduce antenna arrangement difficulty. When the metal branch is used as the radiating branch of the antenna, a position of a slot correspondingly arranged at one or two ends of the metal branch may be flexibly selected based on arrangement of the antenna.

In the example shown in FIG. 3, one or more metal pins may further be arranged on the metal frame. In some examples, a screw hole may be arranged on the metal pin to fasten another structural component by using a screw. In some other examples, the metal pin may be coupled with a feed point, so that when a metal branch connected to the metal pin is used as a radiating branch of the antenna, the antenna is fed through the metal pin. In some other examples, the metal pin may alternatively be coupled with another electronic component, to implement a corresponding electric connection function.

This example also shows arrangement of a printed circuit board (printed circuit board, PCB) on the metal housing. An example in which a main board (main board) and a sub board (sub board) are separately designed is used. In some other examples, the main board and the sub board may alternatively be connected, for example, in an L-shaped PCB design. In some embodiments of this application, the main board (such as a PCB 1) may be configured to bear the electronic components for implementing various functions of the electronic device 200, for example, a processor, a memory, and a radio frequency module. The sub board (such as a PCB 2) may also be configured to bear the electronic components, for example, a universal serial bus (Universal Serial Bus, USB) interface, a related circuit, and a speak box (speak box). For another example, the sub board may alternatively be configured to bear a radio frequency circuit corresponding to an antenna arranged at the bottom (in other words, in a negative y-axis direction of the electronic device).

All the antenna solutions provided in the embodiments of this application can be applied to an electronic device having the composition shown in FIG. 2 or FIG. 3.

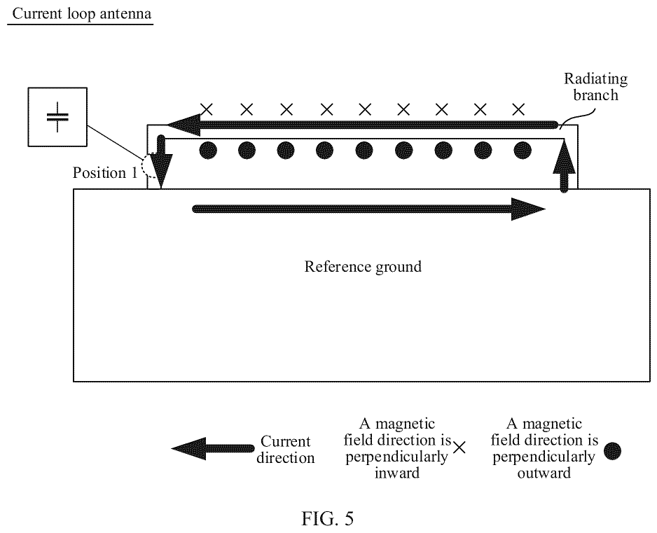

It should be noted that the electronic device 200 in the foregoing example is merely a possible composition. In some other embodiments of this application, the electronic device 200 may alternatively have another logical composition. For example, to implement the wireless communication function of the electronic device 200, a communication module shown in FIG. 4 may be arranged in the electronic device. The communication module may include an antenna, a radio frequency module that performs signal exchange with the antenna, and a processor that performs signal exchange with the radio frequency module. For example, the signal exchange between the radio frequency module and the antenna may be analog signal exchange. The signal exchange between the radio frequency module and the processor may be analog signal exchange or digital signal exchange. In some implementations, the processor may be a baseband processor.

In this example, multiple antennas, for example, an antenna 1 to an antenna n shown in FIG. 4, may be arranged in the electronic device. The n antennas may include one or more magnetic loop antennas and/or current loop antennas.

With reference to the accompanying drawings, the following first briefly describes the magnetic loop antenna and the current loop antenna.

For example, by using a composition feature of the current loop antenna in the solutions provided in the embodiments of this application, the antenna may have a current distribution and a magnetic field distribution shown in FIG. 5 during operation. In the embodiments of this application, a radiation feature with the current distribution and/or magnetic field distribution shown in FIG. 5 may also be referred to as a current loop radiation feature.

As shown in FIG. 5, during radiation, the antenna forms co-directional currents on a radiating branch, and a direction of the current on the radiating branch of the current loop antenna is opposite to a direction of a current on a ground plane used as a reference ground (where for example, the ground plane is close to an edge of the current loop antenna), to form a current loop by the radiating branch and the ground plane. The current loop forms an outward magnetic field perpendicular to a paper surface between the radiating branch of the antenna and the reference ground. A capacitor that is grounded is connected in parallel at an end of the radiating branch, to form a uniform magnetic field distribution, thereby implementing radiation with a radiation feature of the current loop antenna. Radio frequency energy is coupled through the magnetic field to the reference ground, namely, the ground plane of the electronic device. In some embodiments, the current loop radiation feature described above may be achieved by arranging a capacitor in series and/or parallel on the radiating branch. For example, with reference to FIG. 5, the capacitor may be arranged at a position 1. It should be understood that, based on an electrical energy storage characteristic of the capacitor, a change of the current on the radiating branch tends to be smooth. Because the magnetic field corresponds to the current, a magnetic field change in a nearby region of the radiating branch (such as a region between the radiating branch and the reference ground) tends to be smooth, to obtain a uniformly distributed magnetic field.

In a preferred embodiment, a dielectric material is arranged between the radiating branch of the antenna and the reference ground. Because an electromagnetic field formed by the current loop antenna shown in FIG. 5 between the radiating branch of the antenna and the reference ground is mainly a uniform magnetic field, and loss of magnetic field coupling energy is zero when the magnetic field coupling energy passes through the dielectric material, in other words, the dielectric material causes no loss to the formed uniform magnetic field, the current loop antenna has better radiation performance compared with an antenna in an existing technology.

It is experimentally verified that the current loop antenna with the uniform magnetic field distribution can provide better radiation performance under a same spatial condition. For example, the current loop antenna can provide better radiation efficiency, system efficiency, and bandwidth.

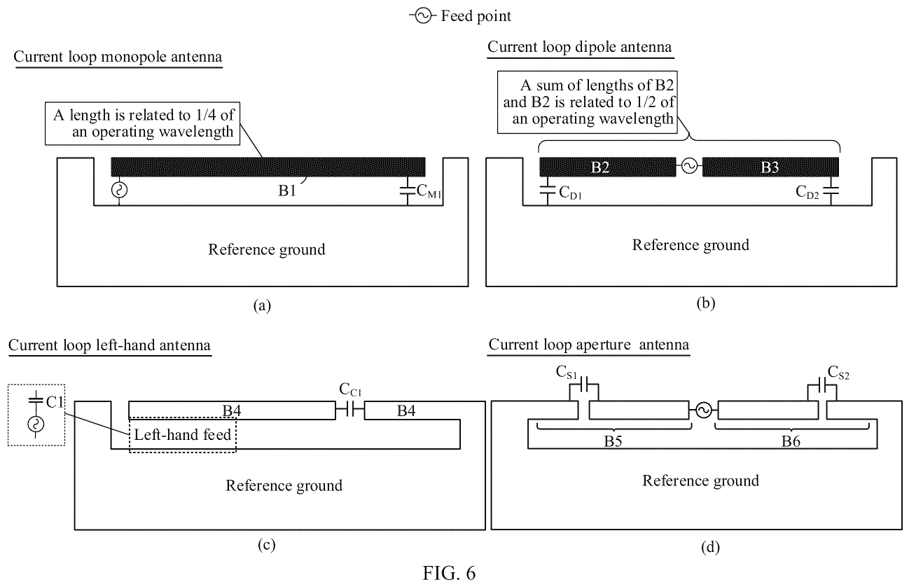

In an example, FIG. 6 shows several possible specific implementations of the current loop antenna. It should be noted that in different implementations of this application, based on a difference in composition structures of current loop antennas, the current loop antennas may be classified into a current loop wire antenna and a current loop slot antenna. The current loop wire antenna may include a current loop monopole antenna, a current loop dipole antenna, and the like. The current loop slot antenna may include a current loop left-hand antenna, a current loop aperture antenna, and the like.

A first capacitor connected in parallel may be arranged on the current loop wire antenna to achieve an operating mechanism shown in FIG. 5. In some implementations, one or more capacitors may alternatively be connected in series on a radiating element of the current loop wire antenna, thereby improving radiation performance of the current loop wire antenna.

Corresponding to the current loop wire antenna, the current loop slot antenna may be provided with a second capacitor connected in series, to achieve the operating mechanism shown in FIG. 5. In some implementations, more capacitors may be connected in series on a radiating element of the current loop slot antenna, thereby improving radiation performance of the current loop wire antenna.

It can be learned that a capacitor that is grounded is arranged at at least one end of the radiating element of each of the current loop slot antenna and the current loop wire antenna. In the embodiments of this application, when the current loop antenna operates in different frequency bands, a value of the grounded capacitor arranged at the end may vary.

For example, when the operating frequency band of the current loop antenna is a low band (Low Band, LB), values of capacitors C1 and C2 arranged at the end of the radiating branch may fall within [1.5 pF, 15 pF]. When the operating frequency band of the current loop antenna is a mid band (Mid Band, MB), values of capacitors C1 and C2 arranged at the end of the radiating branch may fall within [0.5 pF, 15 pF]. When the operating frequency band of the current loop antenna is a high band (High Band, HB), values of capacitors C1 and C2 arranged at the end of the radiating branch may fall within [1.2 pF, 12 pF].

In the embodiments of this application, an operating frequency band covered by an antenna pair may include a low band, a mid band, and/or a high band. In some embodiments, the low band may include a frequency band range of 450 MHz to 1 GHz. The mid band may include a frequency band range of 1 GHz to 3 GHz. The high band may include a frequency band range of 3 GHz to 10 GHz. It may be understood that in different embodiments, the low band, the mid band, and the high band may include but are not limited to operating frequency bands required by a Bluetooth (Bluetooth. BT) communication technology, a global positioning system (global positioning system, GPS) communication technology, a wireless fidelity (wireless fidelity, Wi-Fi) communication technology, a global system for mobile communications (global system for mobile communications, GSM) communication technology, a wideband code division multiple access (wideband code division multiple access, WCDMA) communication technology, a long term evolution (long term evolution. LTE) communication technology, a 5G communication technology, a SUB-6G communication technology, and another communication technology in the future. In some implementations, the LB, MB, and HB can include common frequency bands such as a 5G NR band, a Wi-Fi 6E band, and a UWB.

The following uses specific examples to describe different compositions of the current loop antenna.

(a) in FIG. 6 is a schematic diagram of a current loop monopole antenna. The current loop monopole antenna may include a radiating element B1. When the current loop monopole antenna operates in a fundamental mode (for example, a mode of ¼ of a wavelength), a length of the radiating element B1 may correspond to ¼ of an operating wavelength of the antenna. For example, the length of B1 may be less than ¼ of the operating wavelength. One end of B1 is electrically connected to a feed point, and the other end of B1 is grounded through a capacitor (for example, a capacitor C_{M1}), to form the current loop monopole antenna.

(b) in FIG. 6 is a schematic diagram of a current loop dipole antenna. The current loop dipole antenna may include radiating elements B2 and B3. B2 and B3 may be connected through a feed point, an end of B2 away from B3 may be grounded through a capacitor C_{D1}, and an end of B3 away from B2 may be grounded through a capacitor C_{D2}. When the current loop dipole antenna operates in a fundamental mode (for example, a mode of ¼ of a wavelength), lengths of the radiating elements B2 and B3 may correspond to ¼ of an operating wavelength. In other words, a length of a radiating branch (for example, B2 plus B3) of the current loop dipole antenna corresponds to ½ of the operating wavelength. For example, the length of B2 may be less than ¼ of the operating wavelength. For another example, the length of B3 may be less than ¼ of the operating wavelength. In other words, the length of the radiating branch (for example, B2 plus B3) of the current loop dipole antenna may be less than ½ of the operating wavelength. In some embodiments, a sum of the lengths of B2 and B3 may be greater than ¼ of the operating wavelength and less than ½ of the operating wavelength.

(c) in FIG. 6 is a schematic diagram of a current loop left-hand antenna. The current loop left-hand antenna may include a radiating element B4. A capacitor Cca may be connected in series on B4. One end of B4 may be grounded, and the other end may be connected to a left-hand feed. In this example, the left-hand feed may include a feed point and a left-hand capacitor connected in series with the feed point. The left-hand capacitor may be used to excite generation of a left-hand mode on B4. For a structure and an operating mechanism of the left-hand antenna, refer to CN201380008276.8 and CN201410109571.9. Details are not described herein again.

(d) in FIG. 6 is a schematic diagram of a current loop aperture antenna. The current loop aperture antenna may include radiating elements B5 and B6. The radiating elements B5 and B6 are connected through a feed point. An end of B5 away from B6 and an end of B6 away from B5 may be grounded separately. In this way, B5, B6, and a reference ground may form an aperture for radiation. In this example, a capacitor C_{S1} may be connected in series on B5, and a capacitor C_{S2} may be connected in series on B6.

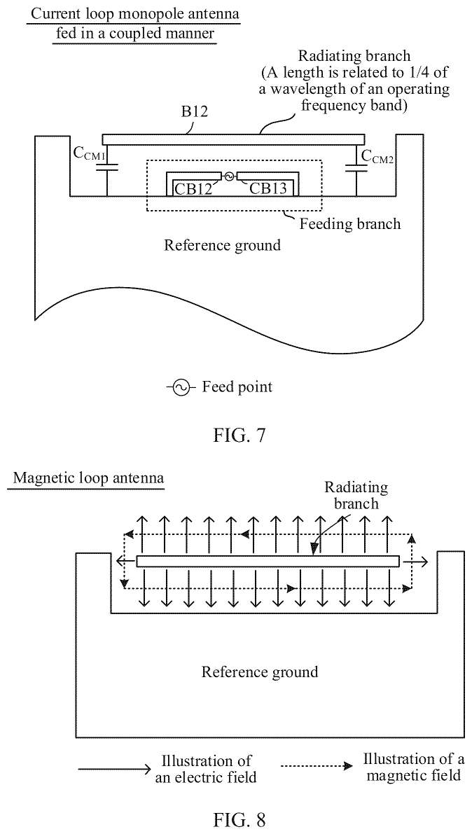

In the example shown in FIG. 6, descriptions are provided by using an example in which feeding is implemented in a direct feeding manner. In some other implementations of this application, the foregoing current loop antenna may alternatively be excited in a coupled feeding manner. For example, FIG. 7 is a schematic diagram of a current loop monopole antenna fed in a coupled manner.

As shown in FIG. 7, the current loop monopole antenna may include a radiating branch and a feeding branch. The radiating branch may include a radiating element B12, and two ends of B12 are grounded through capacitors C_{CM1} and C_{CM2} respectively. The feeding branch may be used for coupled feeding, and may include a first feeding part CB12 and a second feeding part CB13. CB13 and CB12 are connected through a feed point, and the other end of each of CB12 and CB13 is grounded. The feeding branch may be arranged between the radiating branch and a reference ground. In this way, the radiating branch is excited by the feeding branch, namely, CB12 and CB13, to perform radiation with a current loop radiation feature.

It should be understood that other current loop antennas may also be excited in the coupled feeding manner. There may also be multiple structures of the feeding branch. For details, refer to the following patent applications: No. 202110961752.4, No. 202110963510.9, No. 202110961755.8, and No. 202110962491.8. Details are not described herein again.

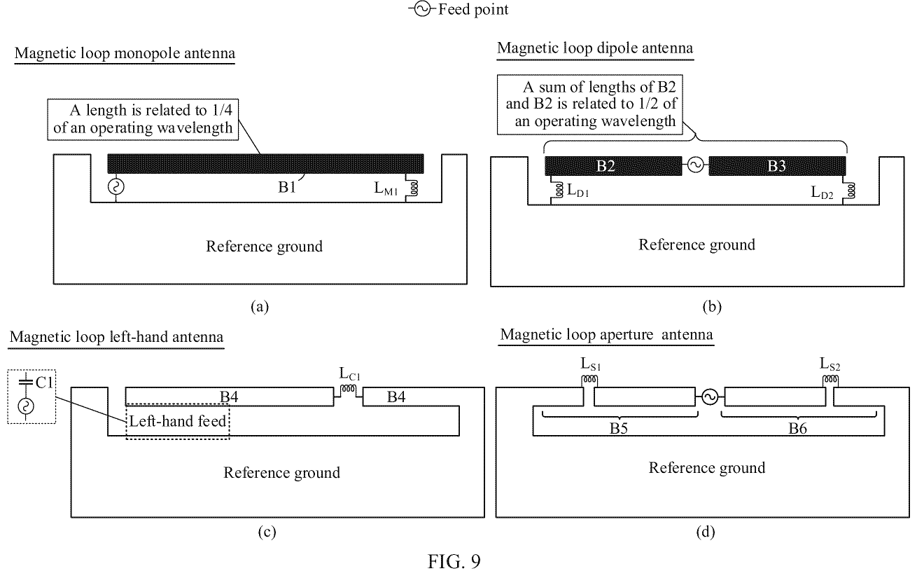

Examples of descriptions of the current loop antenna are provided with reference to FIG. 5. FIG. 6, and FIG. 7. The following briefly describes the magnetic loop antenna with reference to FIG. 8 and FIG. 9.

For example, FIG. 8 is a schematic diagram of the magnetic loop antenna. As shown in FIG. 8, the magnetic loop antenna may include at least one radiating branch. The radiating branch may be used for radiation with a radiation feature of the magnetic loop antenna. The radiation feature of the magnetic loop antenna described in this embodiment of this application may include: A uniform electric field distribution is generated between the radiating branch and the reference ground. For example, as shown in FIG. 8, a uniform downward electric field may be distributed between the radiating branch of the antenna and the reference ground. Certainly, in some other scenarios, because a feed signal constantly changes, the electric field may alternatively be uniformly distributed upwards.

In a possible implementation, for the magnetic loop antenna provided in this embodiment of this application, an inductor may be connected in series and/or parallel on the radiating branch based on an existing electric field antenna, so that a position with a high potential on a radiating element can be grounded in a closest path through the inductor, to reduce the potential at the position and pull down an electric field near the position with the high potential. Correspondingly, a magnetic energy storage characteristic of the inductor is set, to cause a time difference between an electric field change and a current change in an area with a low electric field. Therefore, when a current increases according to a current provided by the feed point, an electric field in the original area with the low electric field may be rapidly enhanced, and an electric field in an original area with a high electric field remains high for a subsequent period of time. In this way, the uniformly distributed electric field near the radiating branch is obtained.

It should be understood that when space near the radiating branch has the uniformly distributed electric field, a closed magnetic loop may be formed in the space. In other words, the radiation feature of the magnetic loop antenna in this embodiment of this application may include: generating a closed magnetic loop distribution near the radiating branch. For example, as shown in FIG. 8, a closed magnetic loop in a counterclockwise direction may be formed near the radiating branch of the antenna. In some other scenarios, because the feed signal constantly changes, the magnetic loop may alternatively be closed and distributed in a clockwise direction. This is similar to the foregoing descriptions of the electric field distribution.

Based on the foregoing characteristic descriptions of the magnetic loop antenna (for example, the radiation feature of the magnetic loop antenna) provided in the embodiments of this application in the operating process, because the magnetic loop antenna provided in the embodiments of this application can generate the uniform electric field (or the closed magnetic loop) for radiation during operation, with reference to the foregoing descriptions, the magnetic loop antenna can provide better radiation performance than a common electric field antenna with a non-uniform electric field.

In a preferred embodiment, a magnetic medium material is arranged between the radiating branch of the antenna and the reference ground. An electromagnetic field formed by the magnetic loop antenna shown in FIG. 8 between the radiating branch of the antenna and the reference ground is mainly the uniform electric field, radio frequency energy is coupled to a ground plane of the reference ground of the electronic device through the electric field, and loss of electric field coupling energy is zero when the electric field coupling energy passes through the magnetic medium material, in other words, the magnetic medium material causes no loss of the formed uniform electric field. Therefore, the magnetic loop antenna has better radiation performance compared with an existing electric field antenna with a non-uniform electric field.

It should be noted that in different implementations of this application, based on a difference in composition structures of magnetic loop antennas, the magnetic loop antennas may be classified into a magnetic loop wire antenna and a magnetic loop slot antenna. The magnetic loop wire antenna may include a magnetic loop monopole antenna, a magnetic loop dipole antenna, and the like. The magnetic loop slot antenna may include a magnetic loop left-hand antenna, a magnetic loop aperture antenna, and the like.

A first inductor connected in parallel may be arranged on the magnetic loop wire antenna to achieve an operating mechanism shown in FIG. 8. In some implementations, one or more inductors may alternatively be connected in series on the radiating element of the magnetic loop wire antenna, thereby improving radiation performance of the magnetic loop wire antenna.

Corresponding to the magnetic loop wire antenna, the magnetic loop slot antenna may be provided with a second inductor connected in series, to achieve the operating mechanism shown in FIG. 8. In some implementations, more inductors may be connected in series on a radiating element of the magnetic loop slot antenna, thereby improving radiation performance of the magnetic loop wire antenna.

It can be learned that an inductor that is grounded is arranged at at least one end of the radiating element of each of the magnetic loop slot antenna and the magnetic loop wire antenna. In the embodiments of this application, when the magnetic loop antenna operates in different frequency bands, a value of the grounded inductor arranged at the end may vary.

For example, when the magnetic loop wire antenna operates in the LB, an inductance value of the inductor may fall within a range of 5 nH to 47 nH. When the magnetic loop wire antenna operates in the MB, an inductance value of the inductor may fall within a range of 1 nH to 33 nH. When the magnetic loop wire antenna operates in the HB, an inductance value of the inductor may fall within a range of 0.5 nH to 10 nH.

FIG. 9 is a schematic diagram of several possible magnetic loop antennas.

(a) in FIG. 9 shows a magnetic loop monopole antenna. The magnetic loop monopole antenna may include a radiating element B1, one end of B1 may be grounded through an inductor L_{M1}, and the other end of B1 may be connected to a feed point. When the antenna operates in a fundamental mode, a length of B1 may be related to ¼ of an operating wavelength. For example, the length of B1 may be less than ¼ of the operating wavelength.

(b) in FIG. 9 shows a magnetic loop dipole antenna. The magnetic loop dipole antenna may include radiating elements B2 and B3. B2 may be connected to B3 through a feed point. An end of B2 away from B3 may be grounded through an inductor L_{D1}, and an end of B3 away from B2 may be grounded through an inductor L_{D2}. In some embodiments, B2 and B3 may be arranged symmetrical about the feed point. When the antenna operates in a fundamental mode, a length of B2 (or B3) may be related to ¼ of an operating wavelength. For example, the length of B2 may be less than ¼ of the operating wavelength. For another example, the length of B3 may be less than ¼ of the operating wavelength. For another example, a length of a radiating branch, of the antenna, including B2 and B3 may be less than ½ of the operating wavelength and greater than ¼ of the operating wavelength.

(c) in FIG. 9 shows a magnetic loop left-hand antenna. The magnetic loop left-hand antenna may include a radiating element B4. One end of B4 may be grounded, and the other end may be connected to a left-hand feed. For a form of the left-hand feed, refer to the left-hand feed shown in FIG. 6. An inductor L_{C1} may be connected in series on B4.

(d) in FIG. 9 shows a magnetic loop aperture antenna. The magnetic loop aperture antenna may include radiating elements B5 and B6. B5 and B6 may be connected through a feed point. An end of B5 away from B6 and an end of B6 away from B5 may be grounded separately. In this way, B5, B6, and a reference ground may enclose an aperture for radiation. In this example, an inductor L_{S1} may be connected in series on B5, and an inductor L_{S2} may be connected in series on B6.

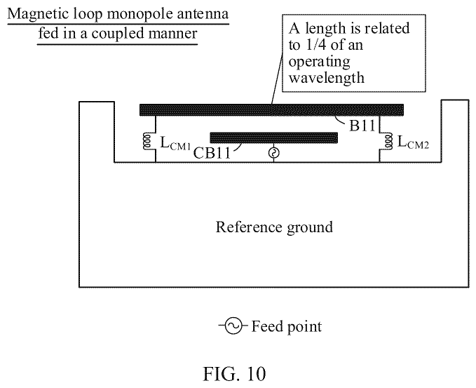

In the example shown in FIG. 9, descriptions are provided by using an example in which excitation is implemented in a direct feeding manner. In some other embodiments of this application, the magnetic loop antenna may alternatively be excited in a coupled feeding manner. For example, FIG. 10 is a schematic diagram of a magnetic loop monopole antenna fed in a coupled manner. As shown in FIG. 10, two ends of a radiating element B11 of the antenna may be grounded through inductors (such as L_{CM1} and L_{CM2}). A feeding branch CB11 may be arranged between a radiating branch and a reference ground, and two ends of CB11 may be suspended. CB11 may be connected to a feed point. For example, the feed point may be arranged at a center of CB11. In this way, the magnetic loop antenna can be excited, so that B11 performs radiation with a magnetic loop radiation feature. It should be understood that other magnetic loop antennas may also be excited in the coupled feeding manner. There may also be multiple structures of the feeding branch. For details, refer to the following patent applications: No. 202111034604.4, No. 202111034603.X, No. 202111034611.4, and No. 202111033384.3. Details are not described herein again.

In the high-isolation antenna solution provided in the embodiments of this application, the current loop antenna and/or the magnetic loop antenna provided in the foregoing examples and/or an existing antenna may be used to form an antenna pair in an antenna system including multiple antennas, where the antenna pair may have high isolation. In addition, because the current loop antenna/magnetic loop antenna provides good radiation performance, radiation performance of the antenna system including the antenna pair can be ensured while the high isolation is achieved.

In the embodiments of this application, relative position relationships of two or more antennas may include a series position relationship, a position relationship in parallel, an opposite position relationship, and an orthogonal position relationship. Using two antennas as an example, series position arrangement may include that the two or more antennas are arranged at a same edge of an electronic device, and projections of the antennas at the edge do not overlap. Position arrangement in parallel may include that the two or more antennas are arranged at a same edge of an electronic device, and projections of the two antennas in parallel at the edge at which the two antennas are arranged at least partially overlap. In some embodiments, planes on which radiating elements of the two antennas in parallel are located are orthogonal. Opposite position arrangement may include that the two antennas are arranged at two opposite edges of an electronic device. Orthogonal position arrangement may include that the two antennas are arranged at two adjacent edges of the electronic device.

It should be understood that based on a distinction between a common mode and a differential mode, existing antennas may at least include a common mode (Common Mode, CM) antenna, a differential mode (Differential Mode, DM) antenna, and the like. Based on different implementation forms, the CM antenna and the DM antenna may further be classified into a CM wire (Wire) antenna, a CM slot (Slot) antenna, a DM wire antenna, and a DM slot antenna. In some embodiments, the CM slot antenna may be excited through asymmetrical feeding. Correspondingly, the DM slot antenna may be excited through symmetrical feeding.

The embodiments of this application use an example in which the high-isolation antenna pair includes two antennas. The two antennas may at least include one current loop antenna or magnetic loop antenna. The other antenna in the high-isolation antenna pair may be a current loop antenna, a magnetic loop antenna, a CM antenna, or a DM antenna. Table 1 lists an illustration of radiation combination effects of the two antennas in the antenna pair achieved when different antenna forms are arranged in parallel. For ease of description, an example in which the two antennas are arranged in parallel at a center of one edge of the electronic device is used.

TABLE 1

| | | | | | Magnetic | Current |
|---|---|---|---|---|---|---|
| Antenna | CM wire | DM wire | CM slot | DM slot | loop | loop |
| pair | antenna | antenna | antenna | antenna | antenna | antenna |
| Current | High | Strong | Strong | High | High | Strong |
| loop | isolation | coupling | coupling | isolation | isolation | coupling |
| antenna | | | | | | |
| Magnetic | Strong | High | High | Strong | Strong | High |
| loop | coupling | isolation | isolation | coupling | coupling | isolation |
| antenna | | | | | | |

As listed in Table 1, the current loop antenna and any of the following antennas may achieve the high-isolation effect: the magnetic loop antenna, the CM wire antenna, and the DM slot antenna.

The magnetic loop antenna and any of the following antennas may achieve the high-isolation effect: the current loop antenna, the DM wire antenna, and the CM slot antenna.

The high-isolation effect achieved by the current loop antenna or the magnetic loop antenna and another antenna may be obtained from orthogonal spatial field distributions formed by exciting orthogonal (or approximately orthogonal) currents on the ground plane. In a specific implementation, the foregoing antenna pair composition with the high-isolation characteristic may achieve the high-isolation effect through the series position arrangement, the position arrangement in parallel, or the opposite position arrangement.

In addition, Table 1 also lists possible compositions of antenna pairs with strong coupling, which differs from the high-isolation effect. It should be noted that the two antennas in the antenna pair with the high-isolation effect can respectively excite orthogonal currents on the ground plane during operation. Therefore, the high-isolation effect can be achieved through the position arrangement such as series arrangement, arrangement in parallel, or opposite arrangement. Correspondingly, two antennas in the antenna pair with strong coupling can excite parallel or approximately parallel currents on the ground plane during operation, to achieve a high-isolation characteristic of the antenna pair with strong coupling through orthogonal position arrangement. The strong coupling relationship may be that when two radiation systems (such as two antennas) operate simultaneously, a significant mutual effect such as positive superposition or negative superposition is caused. For example, when the two antennas operate simultaneously, directions of ground plane currents respectively excited by the antennas are the same or approximately the same, to correspond to the strong coupling relationship.

As listed in Table 1, in the position relationship in parallel, antenna combinations with the strong-coupling characteristic may include:
an antenna combination including the current loop antenna and any of the following antennas: the current loop antenna, the DM wire antenna, and the CM slot antenna; and
an antenna combination including the magnetic loop antenna and any of the following antennas: the magnetic loop antenna, the CM wire antenna, and the DM slot antenna.

It should be understood that in the series and opposite position arrangement, a case in which each antenna excites a ground plane current is similar to the case in the position arrangement in parallel. Therefore, in the series or opposite position arrangement, the high-isolation or strong-coupling characteristic corresponding to the position relationship in parallel can also be obtained.

The following first provides examples of descriptions of the series position arrangement, the position arrangement in parallel, the opposite position arrangement, the orthogonal position arrangement, and the like with reference to the accompanying drawings.

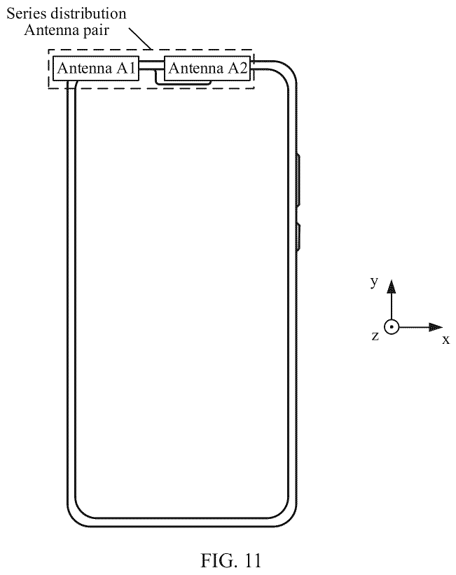

In some embodiments, FIG. 11 shows series distribution of two antennas (for example, an antenna A1 and an antenna A2) included in an antenna pair. In a series distribution scenario, the antenna A1 and the antenna A2 may be located at a same edge of an electronic device. In addition, the antennas A1 and A2 distributed in series may be located at different positions at the same edge. In other words, projections of the antenna A1 and the antenna A2 in a midperpendicular direction of the electronic device do not overlap. With reference to FIG. 11, the antenna A1 and the antenna A2 may be distributed at a top edge of the electronic device, and are arranged on an approximately straight line. This is similar to that the antenna A1 and the antenna A2 are connected in series on the straight line one after the other. Therefore, the similar distribution of the antenna A1 and the antenna A2 is referred to as the series distribution in the present invention. In this way, the antenna A1 and the antenna A2 are located at different positions on an X-axis at the top edge. In some other examples, the antenna A1 and the antenna A2 distributed in series may alternatively be both located at a side edge of the electronic device. In this way, the antenna A1 and the antenna A2 are located at different positions on a Y-axis at the side edge. Alternatively, the antenna A1 and the antenna A2 distributed in series may alternatively be both located at a bottom edge of the electronic device. In this way, the antenna A1 and the antenna A2 are located at different positions on an X-axis at the bottom edge.

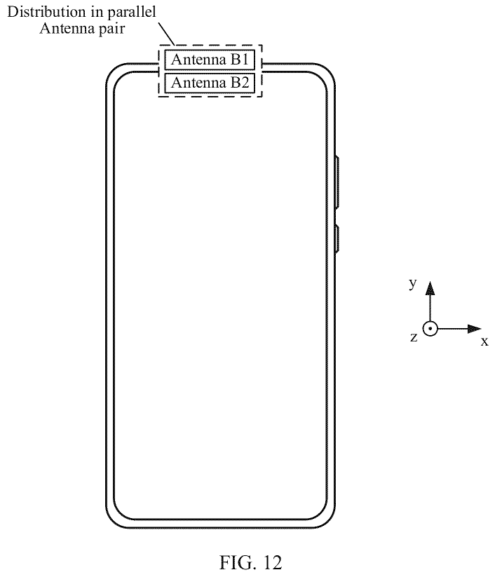

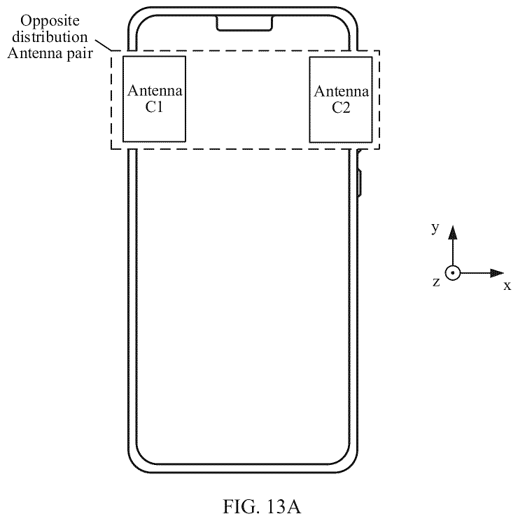

In some other embodiments, FIG. 12 shows distribution in parallel of two antennas (for example, an antenna B1 and an antenna B2) included in an antenna pair. The antenna B1 and the antenna B2 may be located at a same edge, such as a top edge, of an electronic device, and projections of the antenna B1 and the antenna B2 at the same edge, such as the top edge, partially or completely overlap. Therefore, the distribution of the antenna B1 and the antenna B2 is referred to as the distribution in parallel in the present invention. With reference to FIG. 12, the antenna B1 and the antenna B2 may be distributed in parallel at the top edge of the electronic device. Projections of the antenna B1 and the antenna B2 may partially or completely overlap in a midperpendicular direction (namely, a negative Y-axis direction) of the electronic device. In some other examples, the antenna B1 and the antenna B2 distributed in parallel may alternatively be both located at a side edge of the electronic device. Projections of the antenna B1 and the antenna B2 may partially or completely overlap in a mid perpendicular direction (namely, a positive or negative X-axis direction) of the electronic device. In some other examples, the antenna B1 and the antenna B2 distributed in parallel may alternatively be both located at a bottom edge of the electronic device. Projections of the antenna B1 and the antenna B2 may partially or completely overlap in a midperpendicular direction (namely, a positive Y-axis direction) of the electronic device.

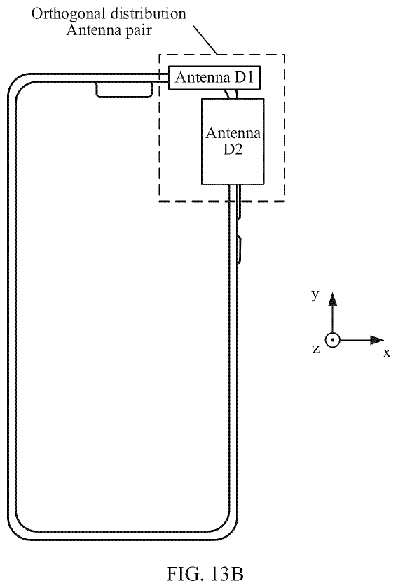

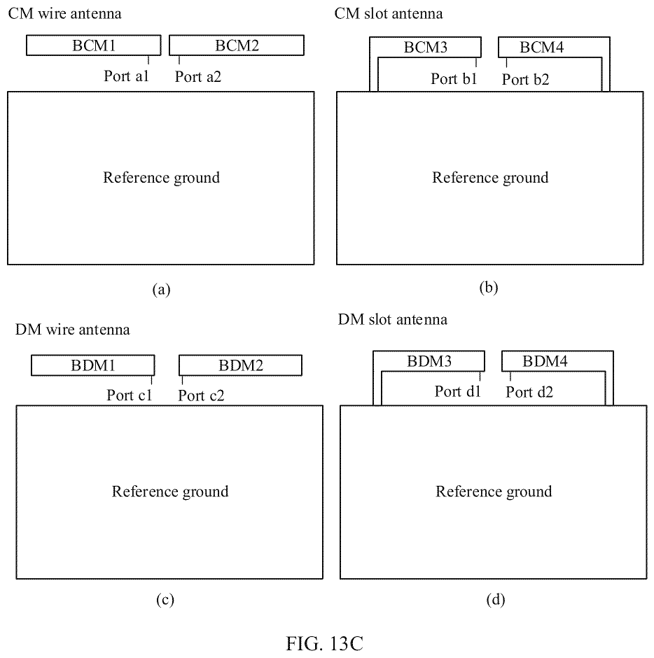

In some other embodiments, FIG. 13A shows opposite distribution of two antennas (for example, an antenna C1 and an antenna C2) included in an antenna pair. The antenna C1 and the antenna C2 are respectively located at two opposite edges of an electronic device. The distribution of the antenna C1 and the antenna C2 is referred to as the opposite distribution in the present invention. In some implementations, projections of the antenna C1 and the antenna C2 at either of the two opposite edges at least partially overlap. An optimal embodiment is that the projections of the antenna C1 and the antenna C2 at either of the two opposite edges completely overlap, in other words, the antenna C1 and the antenna C2 are arranged opposite to each other completely at the two opposite edges of the electronic device. In the example shown in FIG. 13A, the antenna C1 and the antenna C2 may be oppositely distributed at left and right edges of the electronic device. Projections of the antenna C1 and the antenna C2 in an X-axis direction may at least partially overlap. In some other examples, the antenna C1 and the antenna C2 distributed opposite to each other may alternatively be located at top and bottom edges of the electronic device respectively. Projections of the antenna C1 and the antenna C2 in a Y-axis direction may at least partially overlap.

In some other embodiments, FIG. 13B shows orthogonal distribution of two antennas (for example, an antenna D1 and an antenna D2) included in an antenna pair. The antenna D1 and the antenna D2 are located at two adjacent edges of an electronic device respectively. The distribution of the antenna D1 and the antenna D2 is referred to as the orthogonal distribution in the present invention. With reference to FIG. 13B, the antenna D1 may be located at a top edge of the electronic device, and the corresponding antenna D2 may be located at a side edge of the electronic device. In some other examples, the antenna D1 may be located at a side edge of the electronic device, and the corresponding antenna D2 may be located at a top edge or a bottom edge of the electronic device. In some other embodiments, the antenna D1 may be located at a bottom edge of the electronic device, and the corresponding antenna D2 may be located at a side edge of the electronic device.

It may be understood that the descriptions of the relative position relationship in FIG. 11 to FIG. 13B may also be described as a difference between parallel distribution and the orthogonal distribution. For example, in the series distribution shown in FIG. 11, the distribution in parallel shown in FIG. 12, and the opposite distribution shown in FIG. 13A, the edges of the electronic device at which the two antennas are located are the same edge or the two edges parallel to each other. Therefore, in the embodiments of this application, the series distribution, the distribution in parallel, and the opposite distribution may also be referred to as the parallel distribution. Correspondingly, in the orthogonal distribution shown in FIG. 13B, the two adjacent edges of the electronic device at which the two antennas are located may be non-parallel, for example, may be perpendicular or approximately perpendicular.

With reference to the foregoing descriptions about that the combination of different types of antennas achieves the high-isolation characteristic, in some embodiments, the current loop antenna and the magnetic loop antenna, the CM wire antenna, or the DM slot antenna; and the magnetic loop antenna and the current loop antenna, the DM wire antenna, or the CM slot antenna may achieve the high-isolation characteristic in a parallel distribution form. Correspondingly, the current loop antenna and the current loop antenna, the CM slot antenna, or the DM wire antenna; and the magnetic loop antenna and the magnetic loop antenna, the DM slot antenna, or the CM wire antenna may achieve the high-isolation characteristic in an orthogonal distribution form.

In addition, in the foregoing examples, descriptions are provided by using achievement of the high-isolation characteristic of the high-isolation antenna pair including two antennas as an example. The embodiments of this application further provide achievement of a high-isolation characteristic and an operating mechanism of a high-isolation antenna group including three or more antennas. A specific implementation is elaborated on in the following descriptions.

For example, FIG. 13C is a schematic diagram of several different CM antennas and DM antennas. In this example, based on radiation characteristics of the antennas, the CM antennas/DM antennas may be classified into a wire (Wire) antenna and a slot (Slot) antenna.

As shown in (a) in FIG. 13C, the CM wire antenna may include a radiating element BCM1 and a radiating element BCM2, ends of BMC1 and BMC2 that are opposite to each other may be respectively provided with feed ports. Using an example in which BCM1 is arranged on a left side of BCM2, a port a1 may be arranged at a right end of the radiating element BMC1, and a port a2 may be arranged at a left end of BCM2. Ends of BCM1 and BCM2 away from the ports a1 and a2 are suspended. When the CM wire antenna operates, symmetrical feed signals (namely, signals of an equal amplitude and a same phase) may be fed into the ports a1 and a2 to feed the CM wire antenna. It should be noted that (a) in FIG. 13C shows merely an example of the CM wire antenna, and a structural composition of the CM wire antenna may vary in another implementation. For example, BCM1 and BCM2 may alternatively be connected, and a feed point may be arranged at a connecting point between BCM1 and BCM2 to achieve a radiation function similar to that of the structure shown in (a) in FIG. 13C.

As shown in (b) in FIG. 13C, the CM slot antenna may include two radiating elements, for example, BCM3 and BCM4. An end of BCM3 is arranged opposite to an end of BCM4, and the opposite ends may be respectively provided with ports. For example, a port b1 is arranged at an end of BCM3 close to BCM4, and a port b2 is arranged at an end of BCM4 close to BCM3. When the CM slot antenna operates, asymmetrical feed signals (namely, signals of an equal amplitude and opposite phases) may be fed into the ports b1 and b2 to feed the CM slot antenna. An end of BCM4 away from BCM3 is grounded, and correspondingly, an end of BCM3 away from BCM4 is grounded. It should be noted that (b) in FIG. 13C shows merely an example of the CM slot antenna, and a structural composition of the CM slot antenna may vary in another implementation. For example, the two opposite ends of BCM3 and BCM4 are respectively connected to positive and negative electrodes of a feed point, to implement the feeding of the asymmetrical feed signals.

As shown in (c) in FIG. 13C, the DM wire antenna may include two radiating elements BDM1 and BDM2. An end of BDM1 away from BDM2 is suspended. Correspondingly, an end of BDM2 away from BDM1 is suspended. Ports may be respectively arranged at ends of BDM1 and BDM2 close to each other. This is similar to a case of the foregoing CM wire antenna. For example, a port c1 may be arranged at the end of BDM1 close to BDM2, and a port c2 may be arranged at the end of BDM2 close to BDM1. The symmetrical feed signals are fed into the CM wire antenna. However, when the DM wire antenna operates, asymmetrical feed signals may be fed into the ports c1 and c2 respectively, to feed the DM wire antenna. It should be understood that (c) in FIG. 13C shows merely an example of the DM wire antenna, and a structural composition of the DM wire antenna may vary in another implementation. For example, the asymmetrical feed signals for BDM1 and BDM2 may be fed by connecting the opposite ends of BDM1 and BDM2 to positive and negative electrodes of a feed point respectively.

As shown in (d) in FIG. 13C, the DM slot antenna may include two radiating elements, for example, BDM3 and BDM4. An end of BDM3 is arranged opposite to an end of BDM4, and ends of the two radiating elements away from each other are grounded separately. The opposite ends may be respectively provided with ports. For example, a port d1 may be arranged at the end of BDM3 close to BDM4, and a port d2 may be arranged at the end of BDM4 close to BDM3. When the DM slot antenna operates, symmetrical feed signals may be fed into the ports d1 and d2 to excite the DM slot antenna. It should be understood that (d) in FIG. 13C shows merely an example of the DM slot antenna, and a structural composition of the DM slot antenna may vary in another implementation. For example, BDM3 and BDM4 may be connected to each other, and a feed point may be arranged at a connection position. The DM slot antenna may be symmetrically fed through the feed point.

It should be noted that in the high-isolation antenna solution provided in the embodiments of this application, good radiation performance can be provided because at least one current loop antenna or magnetic loop antenna is used.

High-isolation characteristics of both the high-isolation antenna pair including two antennas and a high-isolation antenna group including more antennas are mostly generated through orthogonality of currents excited on a ground plane.

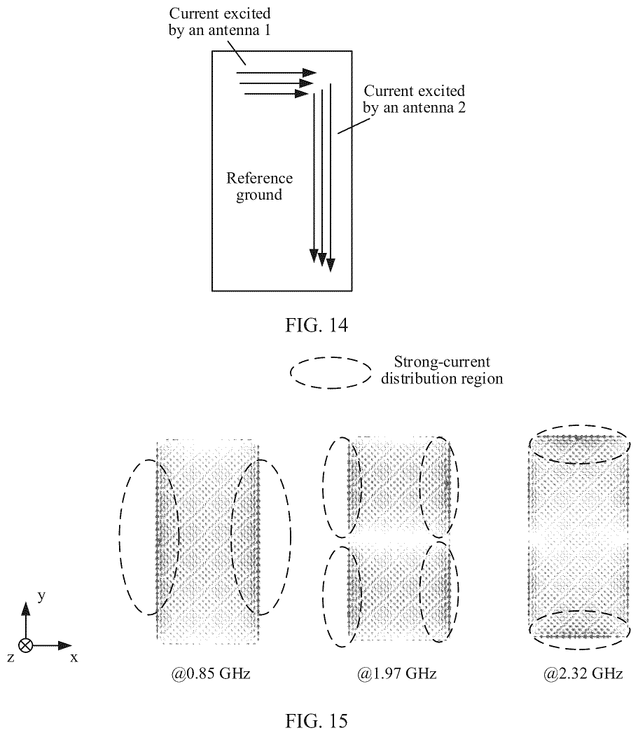

For example, with reference to FIG. 14, in some embodiments, the high-isolation antenna pair is used as an example. One antenna (for example, an antenna 1) may excite a transverse current on the ground plane, and the other antenna (for example, an antenna 2) may excite a longitudinal current on the ground plane. Because the transverse and longitudinal currents on the ground plane are orthogonal, corresponding spatial field distributions are also orthogonal. In this case, when the antenna 1 and the antenna 2 operate simultaneously, even if a part or all of frequency bands overlap, isolation can be effectively ensured because mutual interference is small when orthogonal spatial electromagnetic fields generated through excitation of the ground plane perform radiation. It should be noted that in some implementations of this application, the currents excited by the antenna 1 and the antenna 2 may alternatively not be transverse or longitudinal. For example, the current excited by the antenna 1 may be in a bottom right direction, and the current excited by the antenna 2 may be in a bottom left direction, so that the two currents may also be orthogonal, to make the two antennas have the high-isolation characteristic.

The high-isolation antenna group may include at least two antennas that may form a distributed antenna structure. The distributed antenna structure and at least one other antenna can respectively excite orthogonal currents on the ground plane. An effect thereof is similar to the current distribution shown in FIG. 14, to obtain orthogonal spatial field structures and achieve high isolation.

The solution provided in the embodiments of this application can not only provide high isolation, but also provide good radiation performance for the antenna pair based on excellent radiation performance of the current loop antenna and/or the magnetic loop antenna.

It should be understood that the antenna can provide more effective radiation by exciting the ground plane during operation. Generally, when a position of the antenna matches a ground plane eigenmode, radiation by the ground plane can be more effectively excited.

In this example, antennas may be classified into an electric field antenna and a magnetic field antenna based on radiation characteristics of the antennas. The current loop antenna is a magnetic field antenna, and corresponds to a current distribution feature that matches the ground plane eigenmode. It should be understood that when the magnetic field antenna is placed at a position with a large current distribution of the ground plane eigenmode, a ground plane current can be better excited. A strong current is excited on the ground plane, and can correspondingly generate a strong magnetic field, so that radiation by the ground plane can provide good assistance for the radiation by the antenna. That is, good radiation by the ground plane may serve as a part of the radiation by the antenna, so that the antenna can achieve good radiation performance. In other words, arranging the current loop antenna at a position with a high current distribution of the ground plane eigenmode in a corresponding frequency band can more effectively excite the ground plane for radiation, thereby obtaining good radiation performance of the current loop antenna. Correspondingly, the magnetic loop antenna is an electric field antenna, and corresponds to an electric field distribution feature that matches the ground plane eigenmode. In other words, arranging the magnetic loop antenna at a position with a high electric field distribution of the ground plane eigenmode in a corresponding frequency band can more effectively excite the ground plane for radiation, thereby obtaining good radiation performance of the magnetic loop antenna.

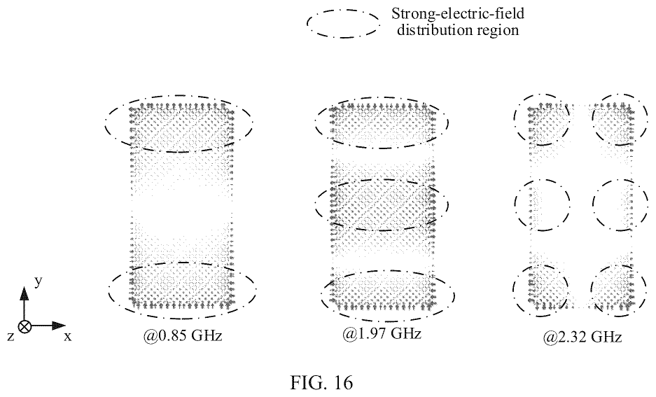

For example, FIG. 15 shows current distribution cases of the ground plane eigenmode in a low band (for example, at 0.85 GHz), a mid band (for example, at 1.97 GHz), and a high band (for example, at 2.32 GHz). It can be learned that the ground plane eigenmode corresponds to different current distributions at different frequencies. For example, at 0.85 GHz, strong currents are distributed at two ends of the ground plane in an x direction. At 1.97 GHz, strong current distributions converge to positive and negative y directions, to form four strong-current distribution regions shown in FIG. 15. At 2.32 GHz, strong current distributions further converge to the positive and negative y directions, to form two strong current regions shown in FIG. 15 at the top and bottom of the ground plane. For the magnetic field antenna, such as the current loop antenna, a region with a strong ground plane current at a corresponding frequency may be set to better excite the ground plane during operation of the antenna and achieve better radiation performance.

FIG. 16 shows electric field distribution cases of the ground plane eigenmode in a low band (for example, at 0.85 GHz), a mid band (for example, at 1.97 GHz), and a high band (for example, at 2.32 GHz). It can be learned that the ground plane eigenmode also corresponds to different electric field distributions at different frequencies. For example, at 0.85 GHz, strong electric fields are distributed at two ends of the ground plane in a y direction. At 1.97 GHz, strong electric fields are distributed at two ends of the ground plane in the y direction and in a middle region of the ground plane in the y direction. At 2.32 GHz, strong electric fields tend to be distributed at edges, and are distributed in four edge regions shown in FIG. 16. For the electric field antenna, such as the magnetic loop antenna, a region with a strong ground plane electric field at a corresponding frequency may be set to better excite the ground plane during operation of the antenna and achieve better radiation performance.

In the following examples, examples of a solution to arranging the high-isolation antenna pair provided in the embodiments of this application are described with reference to eigenmode matching characteristics corresponding to different antennas.

A high-isolation antenna solution in the parallel distribution is first described.

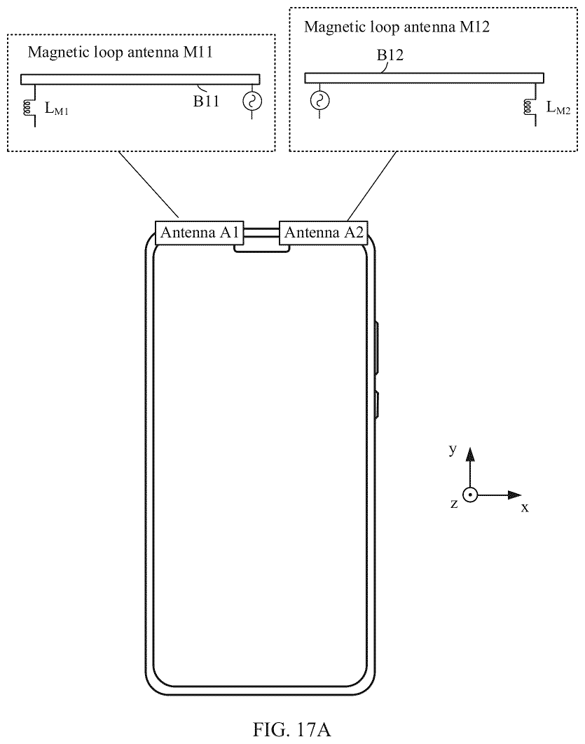

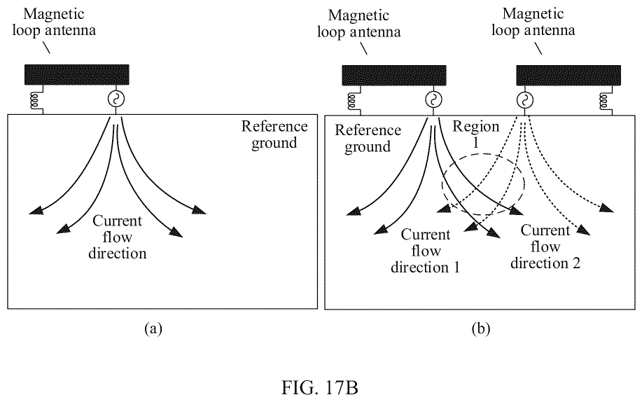

For example, FIG. 17A shows an example of an antenna pair with specific isolation and in series distribution. In this example, the antenna pair may include an antenna A1 and an antenna A2. The antenna A1 and the antenna A2 may include at least one current loop antenna and/or magnetic loop antenna. In this example, an example in which the antenna A1 is a magnetic loop antenna M11 and the antenna A2 is a magnetic loop antenna M12 is used. In some implementations, the magnetic loop antenna M11 may be the magnetic loop monopole antenna fed in the coupled manner shown in FIG. 10. For example, the magnetic loop antenna M11 may include a radiating element B11, an end of the radiating element B11 may be provided with a feed point, and the other end of the radiating element B11 may be grounded through an inductor L_{M1}. Similarly, the magnetic loop antenna M12 may include a radiating element B12, an end of the radiating element B12 may be provided with a feed point, and the other end of the radiating element B12 may be grounded through an inductor L_{M2}. In some embodiments, the magnetic loop antenna M11 and the magnetic loop antenna M12 may be arranged through left-right mirroring. For example, the feed point of the magnetic loop antenna M11 and the feed point of the magnetic loop antenna M12 may be respectively arranged at ends of the two antennas that are close to each other. Therefore, orthogonality of ground plane currents can be better excited to obtain better isolation.

With reference to descriptions of the ground plane eigenmode in FIG. 15 and FIG. 16, as an electric field antenna, the magnetic loop antenna may be arranged at an upper left or upper right corner of the electronic device (for example, a mobile phone) when operating in the mid and high bands, to excite the ground plane for better radiation, so that the magnetic loop antenna M11 can have good radiation performance.

It should be understood that directions of currents excited by the magnetic loop antenna on the ground plane during operation may be shown in (a) in FIG. 17B. It can be learned that in a ground plane area close to the antenna, a current direction is approximately vertically downward. Therefore, the magnetic loop antenna forms a high-isolation effect with the current loop antenna, the DM wire antenna, or the CM slot antenna that can excite the transverse current. At a position gradually away from an edge at which the antenna is located, a component of the current in a horizontal direction gradually increases. Therefore, two magnetic loop antennas distributed in series can also have high isolation. Refer to (b) in FIG. 17B. For example, magnetic loop antennas may be respectively arranged at left and right ends of a top edge of the electronic device, and flow directions of ground plane currents excited by the magnetic loop antennas may be a current flow direction 1 and a current flow direction 2 respectively. It can be learned that at a position close to an edge at which the antenna is located, there are more longitudinal components of the currents excited by the two antennas; at a position (for example, a region 1 shown in FIG. 17B) gradually away from the edge at which the antenna is located, as transverse components gradually increase, an angle of flow directions of some currents generated by the two antennas gradually approaches 90°. Therefore, spatial field distributions excited by the currents corresponding to the region are approximately orthogonal. In this way, the two antennas can obtain high isolation in a direction corresponding to the spatial field distributions.

It should be noted that the descriptions of FIG. 17B are provided by using an example in which the magnetic loop antenna is arranged close to an end of the edge of the electronic device. Because the position of the magnetic loop antenna is not at a center of the edge, the antenna is in an unbalanced state relative to the reference ground, and the current generated by the antenna may have both transverse and longitudinal components. In contrast, when the magnetic loop antenna is arranged at the center of the edge, a longitudinal component of the ground plane current excited by the magnetic loop antenna is much greater than a transverse component, so that the magnetic loop antenna can excite only a longitudinal current. It should be understood that for another antenna arranged at a horizontal edge and capable of generating a longitudinal current, when the antenna is arranged at a center of the edge, a direction of an excited ground plane current is single. This is similar to the descriptions of the magnetic loop antenna. When the antenna is arranged at a position close to an end of the edge, an excited ground plane current includes both transverse and longitudinal currents.

Using the composition shown in FIG. 17A as an example, the following verifies and describes the foregoing analysis of the high isolation through current simulation.

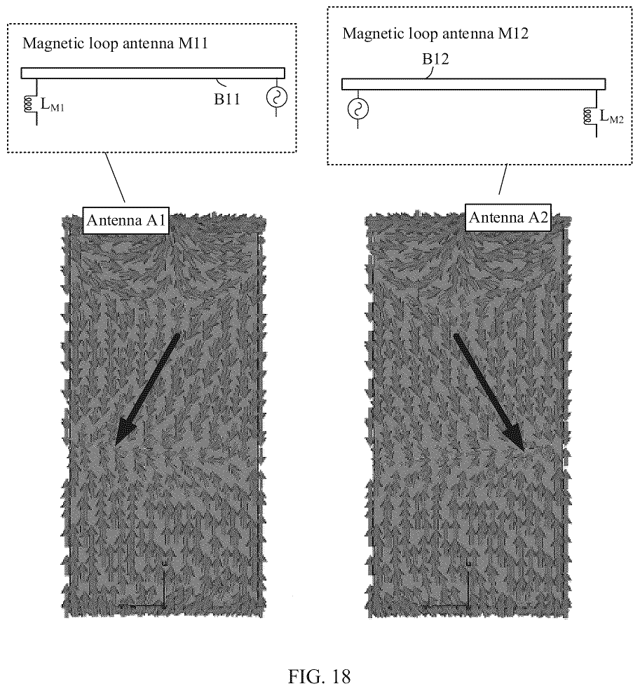

In this example, as shown in FIG. 18, at a current moment, because two magnetic loop antennas are not arranged at a center of an edge at which the antennas are located, excited currents include both transverse and longitudinal components. When operating, an antenna A1 (namely, a magnetic loop antenna M11) may excite a current on a mobile phone ground plane in a bottom left direction. When operating, an antenna A2 (namely, a magnetic loop antenna M12) may excite a current on the mobile phone ground plane in a bottom right direction. It can be learned that although the ground plane currents respectively excited by the two magnetic loop antennas are not completely transverse or longitudinal, the ground plane currents are still partially orthogonal. Therefore, an antenna pair with the composition shown in FIG. 17A may obtain orthogonal spatial field distributions by exciting the partially orthogonal ground plane currents.

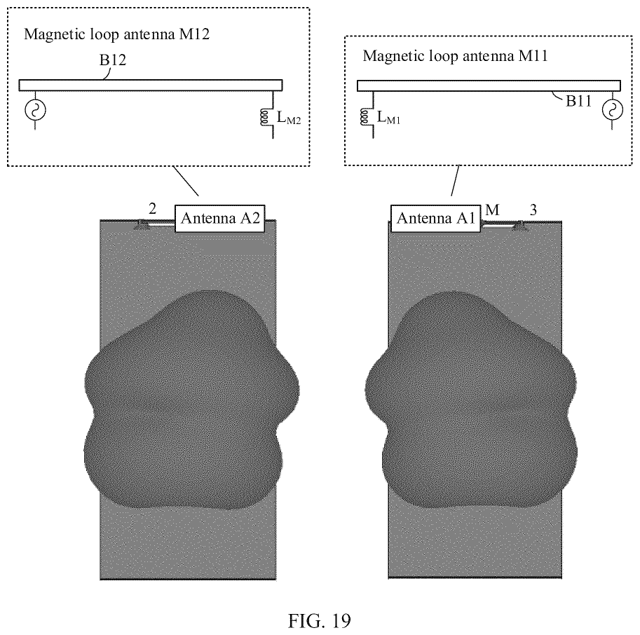

With reference to a far-field directivity pattern shown in FIG. 19, it can be learned that at a same moment, a ground plane current in a bottom left direction excited by an antenna A1 may generate a spatial field distribution in a bottom right direction. Correspondingly, a ground plane current in a bottom right direction excited by an antenna A2 may generate a spatial field distribution in a bottom left direction. That is, the two antennas may transmit signals respectively through orthogonal spatial field distributions in an excitation process. Because of an orthogonal relationship of the spatial field distributions, the two antennas may have high isolation. In addition, the antenna pair in the series distribution provided in the embodiments of this application can provide good radiation performance because the current loop antennas and/or the magnetic loop antenna is used.

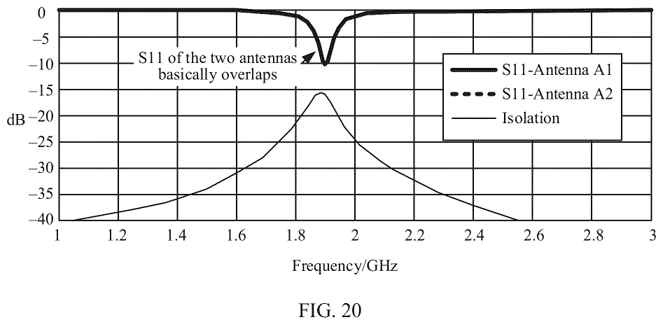

For example, refer to S parameter simulation shown in FIG. 20. In a current scenario, return loss of both the antenna A1 and the antenna A2 reaches −10 dB. Therefore, the two antennas have good radiation performance. Through simulation, it can be learned that S12 that identifies the isolation between the two antennas is below −15 dB. Therefore, the isolation between the two antennas is good and can be applied to antenna arrangement of the electronic device. If the ground plane currents excited by the two antennas are completely orthogonal, the isolation is further improved.

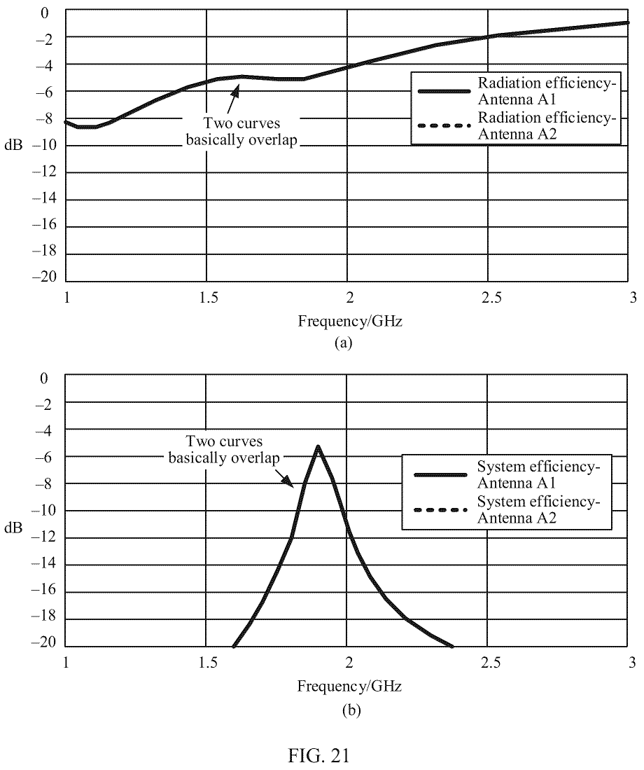

Refer to FIG. 21. FIG. 21 shows efficiency comparison of the two antennas in the current scenario. As shown in (a) in FIG. 21, from the perspective of radiation efficiency, radiation efficiency of both the antenna A1 and the antenna A2 exceeds −5 dB after 1.5 GHz. Because the two antennas are arranged in a mirrored manner, radiation performance of the two antennas is similar, and radiation efficiency curves of the two antennas basically overlap. In addition, as shown in (b) in FIG. 21, from the perspective of system efficiency, peak efficiency of both the antenna A1 and the antenna A2 exceeds −6 dB, and bandwidth can effectively cover at least one operating frequency band.

The foregoing descriptions are provided by using an example in which the antenna pair includes two magnetic loop antennas. The current loop antenna and/or the magnetic loop antenna may be fed in a coupled manner or directly. In some other embodiments of this application, the antenna pair in the series distribution may further include other antennas capable of exciting transverse and longitudinal currents of the ground plane.

For example, in some embodiments, the antenna pair in the series distribution may include one current loop antenna and either of the CM wire antenna and the DM slot antenna. The current loop antenna can excite a current on the ground plane and parallel to an edge at which the current loop antenna is located. Correspondingly, the CM wire antenna or the DM slot antenna can excite a current on the ground plane and perpendicular (or approximately perpendicular) to the edge at which the current loop antenna is located. This achieves the high-isolation characteristic.

In some other embodiments, the antenna pair in the series distribution may include one magnetic loop antenna and either of the DM wire antenna and the CM slot antenna. The magnetic loop antenna can excite a current on the ground plane and perpendicular (or approximately perpendicular) to an edge at which the magnetic loop antenna is located. Correspondingly, the DM wire antenna or the CM slot antenna can excite a current on the ground plane and parallel (or approximately parallel) to the edge at which the magnetic loop antenna is located. This achieves the high-isolation characteristic.

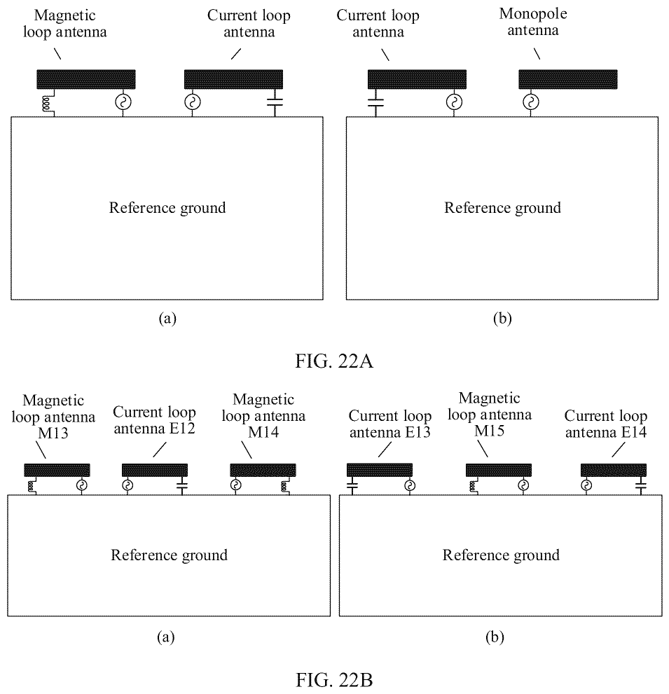

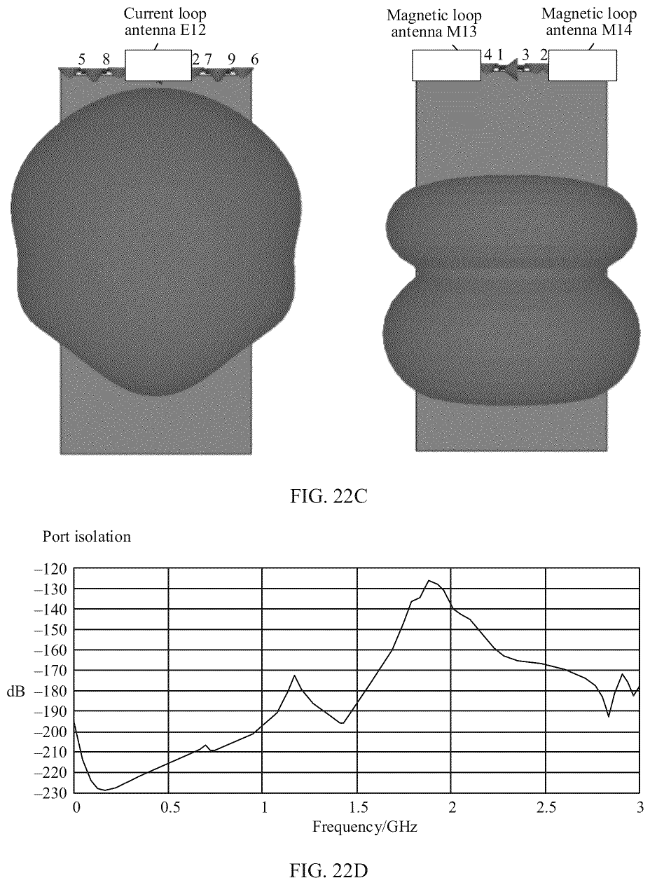

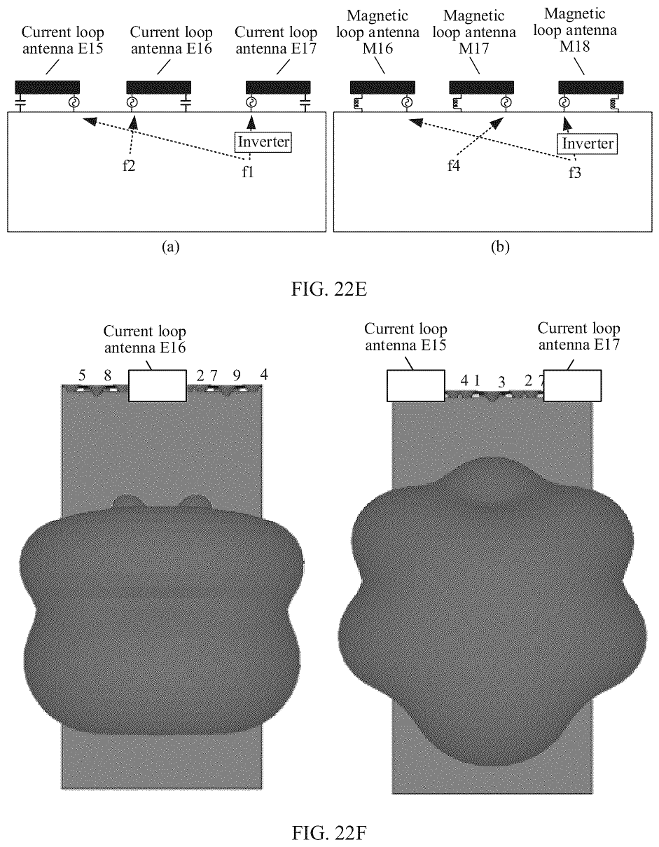

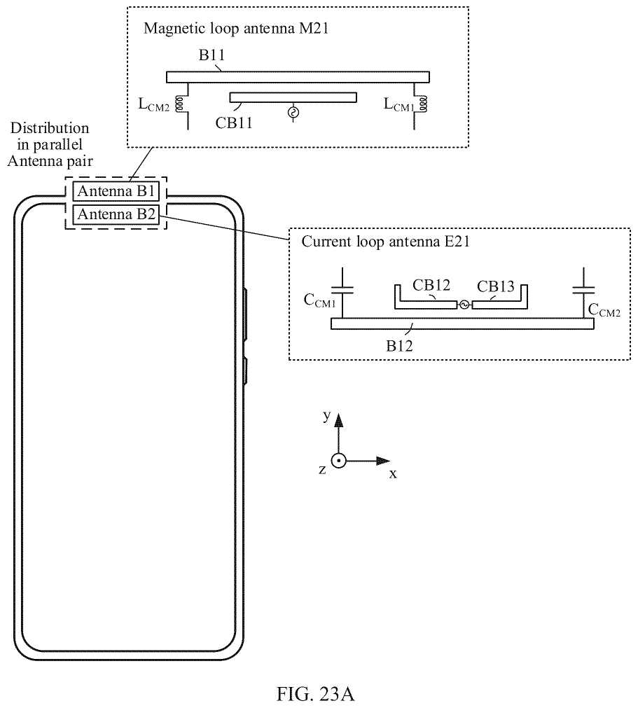

For example, (a) in FIG. 22A shows another antenna pair that achieves the high-isolation characteristic. A current loop antenna and a magnetic loop antenna that are fed directly and distributed in series may be arranged in an electronic device. Ground plane currents respectively excited by the current loop antenna and the magnetic loop antenna can also be partially orthogonal, thereby obtaining high isolation. As shown in (b) in FIG. 22A, using an example in which the CM wire antenna is a monopole antenna, one current loop antenna fed directly and one monopole antenna that are distributed in series may be arranged in the electronic device.

Ground plane current excitation by another antenna form (such as the CM wire antenna) that can excite a longitudinal current is similar to that of the magnetic loop antenna, the magnetic loop antenna can also achieve the high-isolation effect in a specific direction with antenna forms including the CM wire antenna and the DM slot antenna. The high-isolation antenna form in the series distribution should also fall within the protection scope of the embodiments of this application.

It should be noted that in the foregoing examples, descriptions are provided by using an example in which a high-isolation antenna pair includes two antennas. In some other implementations of this application, more antennas may be used to achieve the high-isolation effect.

For example, a high-isolation antenna group may include three or more antennas. Three antennas are used as an example. Two of the three antennas may be equivalent to a distributed antenna structure. In this way, the distributed antenna structure and the remaining antenna can achieve the high-isolation effect in the series distribution by exciting orthogonal currents on the ground plane. In this application, an antenna group with the high-isolation characteristic including three or more antennas may be referred to as a high-isolation antenna group.

In an example, FIG. 22B shows several examples of the high-isolation antenna group including three antennas. As shown in (a) in FIG. 22B, the three antennas of the high-isolation antenna group in this example may include two magnetic loop antennas: a magnetic loop antenna M13 and a magnetic loop antenna M14, and include one current loop antenna E12. The magnetic loop antenna M13 and the magnetic loop antenna M14 are arranged at a same edge of an electronic device, and may be at any edge of the electronic device. The current loop antenna E12 may be arranged between the magnetic loop antenna M13 and the magnetic loop antenna M14.

During feeding, the two magnetic loop antennas (for example, the magnetic loop antenna M13 and the magnetic loop antenna M14) may be symmetrically fed (of an equal amplitude and a same phase) to form a single-port distributed antenna structure 1. In other words, feed signals fed into the magnetic loop antenna M13 and the magnetic loop antenna M14 are of the equal amplitude and the same phase. In this way, when operating, the two magnetic loop antennas form the distributed antenna structure 1. During the symmetrical feeding of the distributed antenna structure 1, as shown in FIG. 18, ground plane currents generated by the two magnetic loop antennas are respectively in a bottom left direction and a bottom right direction. After the two ground plane currents are combined, transverse currents cancel each other out, and longitudinal currents mainly exist. Ground plane currents excited by the current loop antenna E12 are mainly transverse currents, as shown in FIG. 5. Therefore, the ground plane current generated by the distributed antenna structure 1 and the ground plane current generated by the current loop antenna E12 are well orthogonal, so that the distributed antenna structure 1 and the current loop antenna E12 form a high-isolation antenna pair.

FIG. 22C shows an example of a directivity pattern of the high-isolation antenna group with the composition shown in (a) in FIG. 22B. FIG. 22D is a schematic diagram of port isolation of the high-isolation antenna group with the composition shown in (a) in FIG. 22B. The distributed antenna structure 1 may correspond to one of dual ports, and the current loop antenna E12 may correspond to the other of the dual ports. As shown in FIG. 22D, the isolation is extremely good, and even a highest point is below −120 dB. This fully proves the high-isolation characteristic of the high-isolation antenna group with the composition shown in (a) in FIG. 22B. In addition, because the antennas included in the high-isolation antenna group are the magnetic loop antennas and the current loop antenna, with reference to the foregoing descriptions of the current loop antenna and the magnetic loop antenna, the high-isolation antenna group also has a good radiation characteristic. For a specific case thereof, refer to the foregoing example. Details are not described herein again.

Still refer to FIG. 22B. As shown in (b) in FIG. 22B, the three antennas of the high-isolation antenna group in this example may include two current loop antennas: a current loop antenna E13 and a current loop antenna E14, and include a magnetic loop antenna M15. The current loop antenna E13 and the current loop antenna E14 are arranged at a same edge of an electronic device, and may be at any edge of the electronic device. The magnetic loop antenna M15 is arranged between the current loop antenna E13 and the current loop antenna E14.

During feeding, the two current loop antennas (for example, the current loop antenna E13 and the current loop antenna E14) may be symmetrically fed (of an equal amplitude and a same phase) to form a single-port distributed antenna structure 2. This is similar to the foregoing descriptions in (a) in FIG. 22B. In other words, feed signals fed into the current loop antenna E13 and the current loop antenna E14 may be of the equal amplitude and the same phase. In this way, when operating, the two current loop antennas may form a distributed antenna structure 2. The distributed antenna structure 2 may form a high-isolation antenna pair with the magnetic loop antenna M15. This is because: A transverse ground plane current excited by the distributed antenna structure 2 including the two current loop antennas is well orthogonal to a longitudinal ground plane current excited by the magnetic loop antenna M15.

With reference to the foregoing descriptions of the high-isolation and good-radiation characteristics in (a) in FIG. 22B, the high-isolation antenna group with the composition shown in (b) in FIG. 22B can also have high-isolation and good-radiation characteristics.

As can be learned, in the examples shown in FIG. 22B to FIG. 22D, descriptions are provided by using an example in which the antennas in the high-isolation antenna group are symmetrically fed to obtain two high-isolation operating modes.

In some other implementations of this application, the high-isolation antenna group may alternatively include antennas of a same type, and the antennas of the same type may be divided into two groups based on a feeding difference.

For example, with reference to (a) in FIG. 22E, an example in which the high-isolation antenna group includes three current loop antennas is used. The three current loop antennas (current loop antennas E15, E16, and E17) may be distributed in series at an edge of an electronic device. Current loop antennas at two ends may form a distributed antenna pair 3. The current loop antenna E15 and the current loop antenna E17 are asymmetrically fed (of an equal amplitude and opposite phases), to form a single-port distributed antenna structure 3. The formed single-port structure 3 and the current loop antenna E16 located in the middle form a dual-port antenna structure. To be specific, when f1 is directly fed into the current loop antenna E15, a feed signal (for example, obtained through an inverter) of a same amplitude and an opposite phase with f1 may be fed into the current loop antenna E17, thereby achieving asymmetrical feeding of the current loop antenna E15 and the current loop antenna E17.

In this way, the distributed antenna pair 3 and the current loop antenna E16 may respectively excite orthogonal currents on the ground plane, to achieve a high-isolation characteristic.

For example, FIG. 22F is a schematic diagram of a directivity pattern of the high-isolation antenna group with the composition shown in (a) in FIG. 22E. It can be learned that the current loop antenna E16 located at the middle position my form a transverse spatial field distribution under the excitation of f1, and the corresponding distributed antenna pair 3 including the current loop antenna E15 and the current loop antenna E17 located at two ends may form a longitudinal spatial field distribution under the asymmetrical excitation of f2. In this way, two orthogonal spatial field distributions can be obtained, and therefore the high-isolation characteristic is achieved.

Still with reference to FIG. 22E, an example in which the high-isolation antenna group includes three magnetic loop antennas (as shown in (b) in FIG. 22E) is used. The magnetic loop antennas (such as a magnetic loop antenna M16 and a magnetic loop antenna M18) are asymmetrically fed (of an equal amplitude and opposite phases), to form a single-port distributed antenna structure 4. The formed distributed antenna structure 4 and a magnetic loop antenna M17 located in the middle form a dual-port antenna structure. To be specific, when f3 is directly fed into the magnetic loop antenna M16, a feed signal (for example, obtained through an inverter) of a same amplitude and an opposite phase with f3 may be fed into the magnetic loop antenna M18, thereby achieving asymmetrical feeding of the magnetic loop antenna M16 and the magnetic loop antenna M18.

In this way, a transverse ground plane current distribution excited by the distributed antenna pair 4 and a longitudinal ground plane current excited by the magnetic loop antenna M17 form orthogonal currents, thereby obtaining the high-isolation characteristic.

With reference to the foregoing descriptions, because the two examples of the high-isolation antenna group shown in FIG. 22E include the current loop antennas or the magnetic loop antennas, good radiation performance can be provided while the high-isolation characteristic is achieved.

In addition, it should be noted that, the composition of the high-isolation antenna group shown in FIG. 22B to FIG. 22E may be any composition different from the current loop antenna or the magnetic loop antenna shown in the foregoing examples, and a feeding manner of the composition may be the direct feeding or the coupled feeding in the foregoing examples. An effect that the composition can achieve is similar to the effect in the foregoing descriptions, and details are not described herein again.

Based on the foregoing descriptions, it can be learned that in the series distribution provided in this example, at least one current loop antenna and/or magnetic loop antenna may be arranged in the antenna pair, to obtain both good radiation performance and high isolation, thereby reducing mutual impact between the antennas in the antenna pair and improving overall radiation performance.

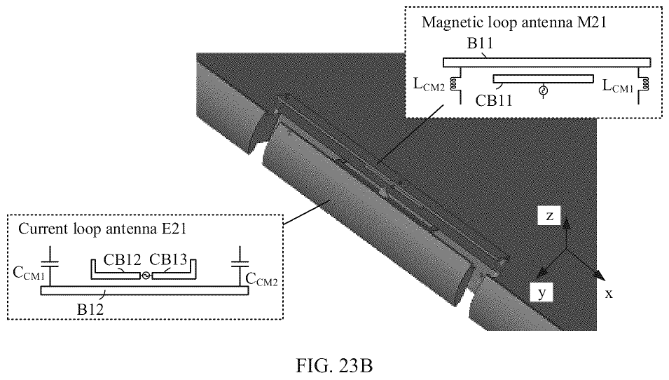

With reference to the accompanying drawings, the following describes the high-isolation antenna pair solution in the distribution in parallel provided in the embodiments of this application. An example in which the antenna pair includes two antennas (for example, an antenna B1 and an antenna B2), the antenna B1 is a magnetic loop antenna M21, and the antenna B2 is a current loop antenna E21 is used. In some embodiments, as shown in FIG. 23A, the magnetic loop antenna M21 may be a magnetic loop antenna fed in a coupled manner, and the current loop antenna E21 may be a current loop antenna fed in the coupled manner.

As shown in FIG. 23A, axial projections of the antenna B2 and the antenna B1 on a Y axis may partially or completely overlap. The antenna B1 may be the magnetic loop antenna shown in FIG. 23A. The magnetic loop antenna M21 may have the structural composition shown in FIG. 10. For example, the antenna may include a radiating branch B11, and two ends of B11 may be respectively provided with grounded inductors. As shown in FIG. 23A, the two ends of B11 may be respectively provided with grounded inductors L_{CM1} and L_{CM2}. During coupled feeding, the magnetic loop antenna M21 may further include a feeding branch CB11 between the radiating branch and a reference ground. It should be noted that in some other embodiments, the magnetic loop antenna M21 may alternatively be of another structure. For details, refer to the foregoing relevant descriptions of the magnetic loop antenna, and the details are not described herein again.

In addition, the antenna B2 may be the current loop antenna E21 shown in FIG. 23A. The current loop antenna E21 may have the structural composition shown in FIG. 7. For example, the antenna may include a radiating branch B12, and two ends of B12 may be respectively provided with grounded capacitors. As shown in FIG. 23A, the two ends of B12 may be respectively provided with grounded capacitors Ccs and C_{CM2}. During coupled feeding, the current loop antenna E21 may further include feeding branches CB12 and CB13 between the radiating branch and the reference ground. It should be noted that in some other embodiments, the current loop antenna E21 may alternatively be of another structure. For details, refer to the foregoing relevant descriptions of the current loop antenna, and the details are not described herein again.

In a possible implementation, FIG. 23B is a model view of an antenna pair in distribution in parallel and with the topological structure shown in FIG. 23A. As can be learned, in this example, the current loop antenna E21 may be arranged at the top of the electronic device. A radiating element of the current loop antenna E21 may be located on a zox plane. The magnetic loop antenna M21 may also be located at the top of the electronic device, and a radiating element of the magnetic loop antenna M21 may be arranged on an xoy plane parallel to the electronic device. That is, in the distribution in parallel, the planes on which the radiating elements of the two antennas are located are orthogonal. It should be understood that another antenna pair in the distribution in parallel may also be implemented in a corresponding product by respectively arranging radiating elements on two orthogonal planes.

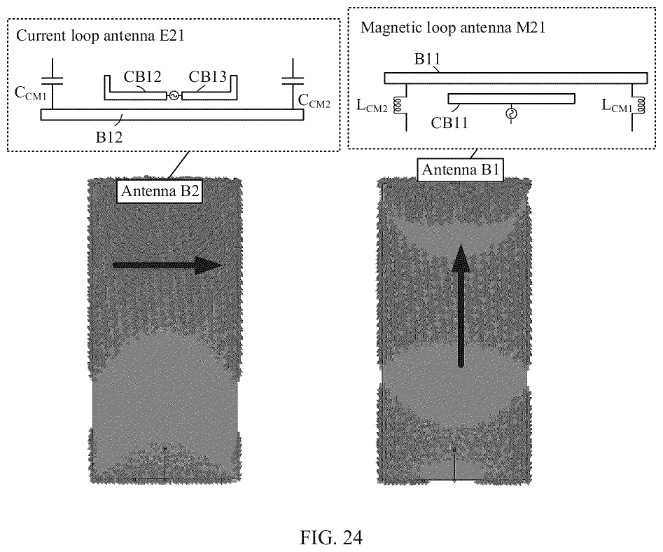

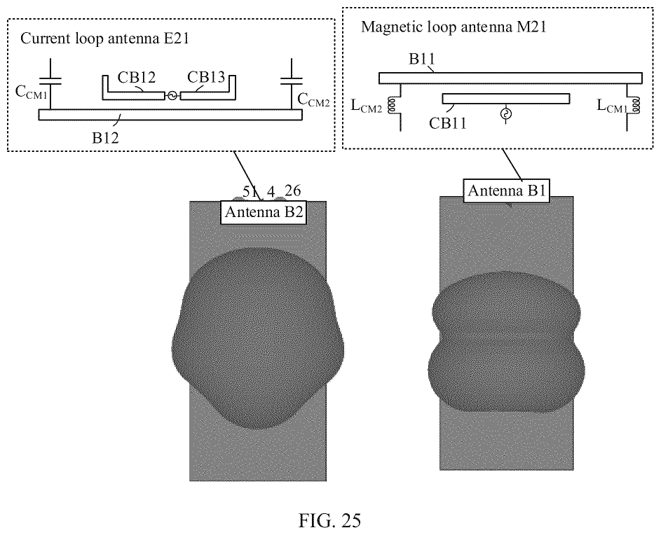

The antenna pair in the distribution in parallel also has high isolation. For example, in this example, the antenna B1 may excite a longitudinal current on the ground plane, and the antenna B2 may excite a transverse current on the ground plane. This can be verified with reference to ground plane current simulation shown in FIG. 24. As shown in FIG. 24, in a current scenario, the ground plane current excited by the antenna B1 is a longitudinal current upward in a Y-axis direction. Correspondingly, the ground plane current excited by the antenna B2 is a transverse current rightward in an X-axis direction. That is, the ground plane currents excited by the antenna B1 and the antenna B2 are orthogonal. Therefore, the antenna B1 and the antenna B2 provided in this example have high isolation. Orthogonality of operating statuses of the ground plane excited during the operation of the antenna B1 and the antenna B2 can also be proved with reference to a far-field directivity pattern shown in FIG. 25.

Based on the foregoing descriptions, it should be understood that the antenna pair including the antenna B1 and the antenna B2 distributed in parallel may have high isolation because of the orthogonality of the excited ground plane. In this example, the antenna pair including the antenna B1 and the antenna B2 may include one current loop antenna and one magnetic loop antenna.

Because of good radiation characteristics of the current loop antenna and the magnetic loop antenna, even in the scenario of distribution in parallel, the antenna pair can provide good radiation performance.

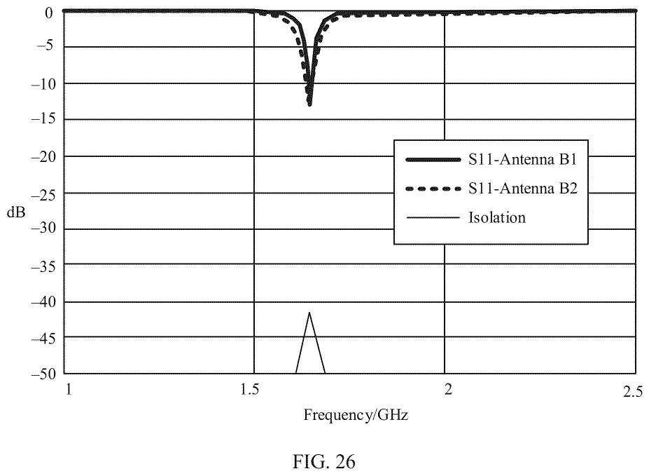

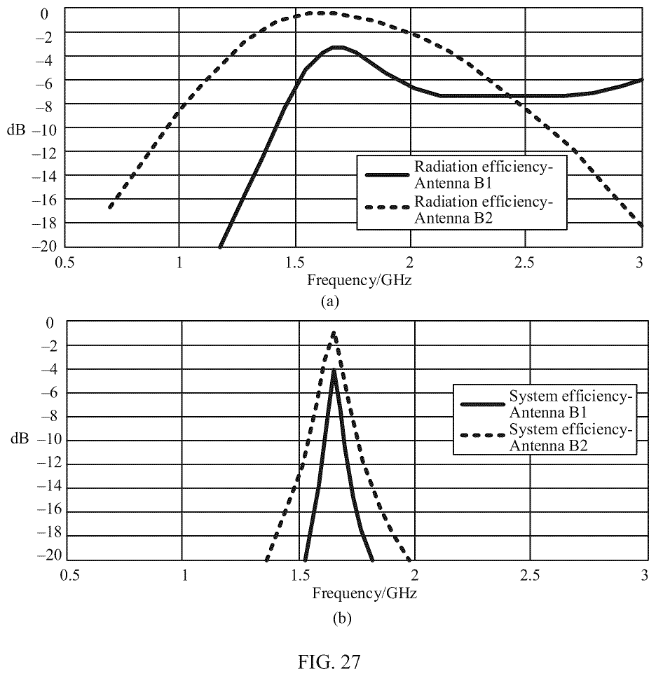

For example, FIG. 26 is a schematic diagram of S parameter simulation. It can be learned that deepest points of S11 of both the antenna B1 and the antenna B2 exceed −10 dB, and correspondingly, a worst point of isolation is approximately −42 dB. This can meet isolation requirements of the electronic device on different antennas. FIG. 27 is a schematic diagram of efficiency simulation of the antenna pair in the distribution in parallel. As shown in (a) in FIG. 27, from the perspective of radiation efficiency, a peak of radiation efficiency of the current loop antenna has exceeded −1 dB, and correspondingly, radiation efficiency of the magnetic loop antenna also exceeds −4 dB. As shown in (b) in FIG. 27, from the perspective of system efficiency, a peak of system efficiency of the current loop antenna exceeds −1 dB, and correspondingly, system efficiency of the magnetic loop antenna also exceeds −4 dB.

That is, the antenna pair in the distribution in parallel provided in this example can provide good radiation performance (for example, including the radiation efficiency and/or the system efficiency) while having high isolation.

The foregoing descriptions use an example in which the antenna pair in the distribution in parallel is arranged at a top middle position of the electronic device. With reference to the foregoing distribution of the ground plane eigenmode, radiation of the current loop antenna can be well excited at the top middle position. Therefore, in the efficiency illustration shown in FIG. 26 and FIG. 27, the efficiency of the current loop antenna is better, and the efficiency of the magnetic loop antenna is worse. Therefore, this position is suitable for a scenario with a high performance requirement on the current loop antenna.

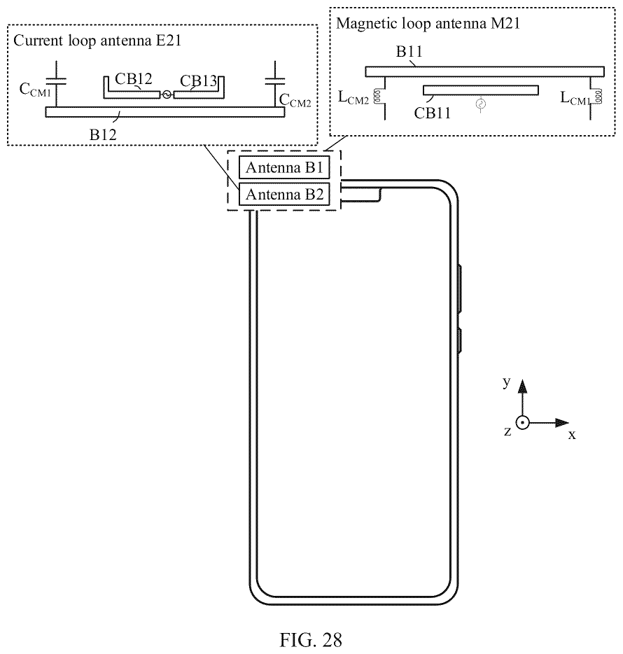

In some other implementations, the position of the antenna pair may be moved to appropriately adjust excitation of the ground plane by the antennas in the antenna pair, to flexibly adjust radiation performance of the antennas. For example, with reference to FIG. 28, an example in which the antenna pair in the distribution in parallel is arranged at an upper left corner of the electronic device is used. It can be understood that at this position, the magnetic loop antenna can better excite the ground plane eigenmode, and therefore can have good radiation performance.

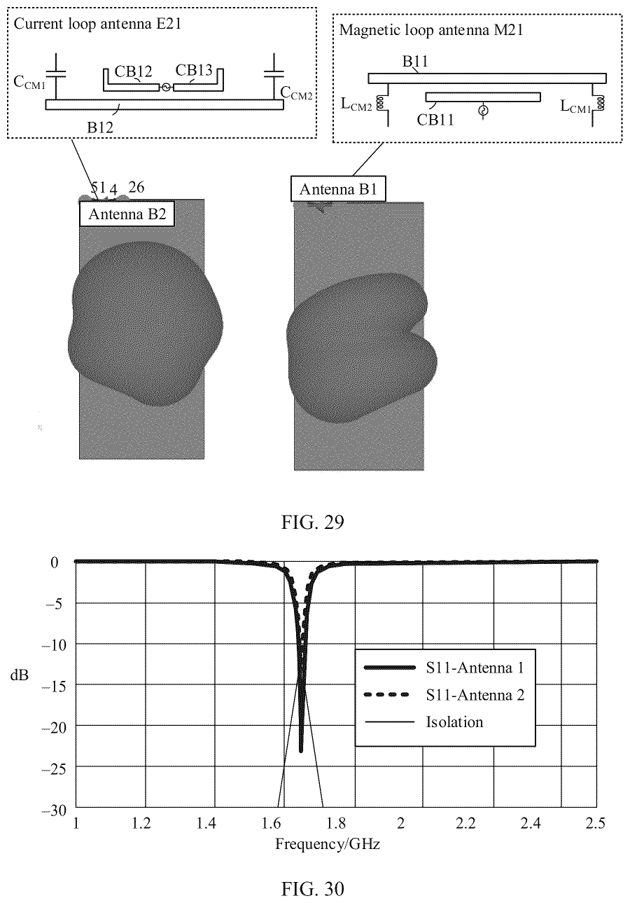

FIG. 29 is a schematic diagram of a far-field directivity pattern of each antenna when the antenna pair with the arrangement shown in FIG. 28 operates. FIG. 30 is a schematic diagram of S parameter simulation. As shown in FIG. 30, the magnetic loop antenna M21 can be well excited at this position, and a deepest point of S11 has exceeded −20 dB, and is significantly improved compared with that when the antenna pair is arranged at the top middle position. Correspondingly, because performance of the magnetic loop antenna M21 is significantly improved, isolation in a corresponding frequency band correspondingly deteriorates. For example, a worst point of S12 has approached −15 dB. A reason for the isolation deterioration is as follows: When the antenna pair in parallel is moved to the corner of the electronic device, a ground plane current excited by the magnetic loop antenna M21 generates a lateral component, namely, a transverse component. Consequently, orthogonality is affected, and isolation is further affected. However, even though the isolation deteriorates, the isolation approaches −15 dB. Therefore, this solution can be applied to the electronic device. Because performance of the magnetic loop antenna M21 is improved, better radiation performance can be provided for a scenario in which an isolation requirement is not very strict.

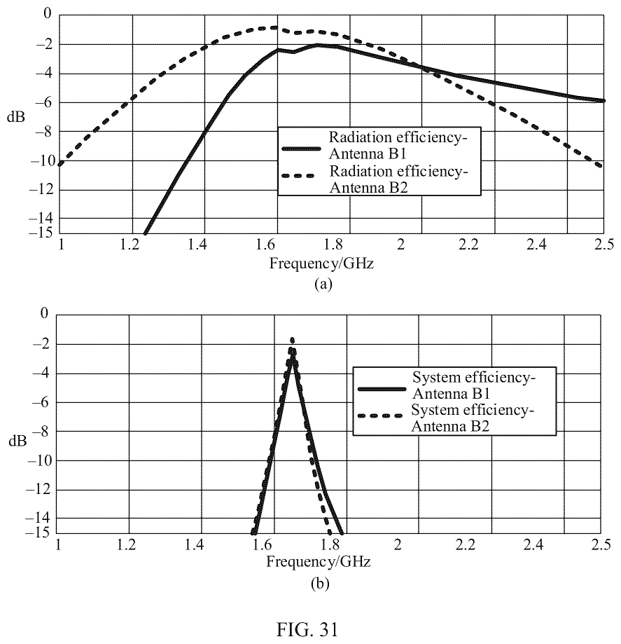

With reference to illustration of efficiency simulation shown in FIG. 31, it can be learned that as shown in (a) in FIG. 31, the radiation efficiency of the magnetic loop antenna M21 increases from about −4 dB shown in FIG. 27 to about −2 dB, and therefore is significantly improved. Correspondingly, the radiation efficiency of the current loop antenna E21 is also maintained at a peak of about −1 dB. As shown in (b) in FIG. 31, the system efficiency of the magnetic loop antenna M21 is improved to about −2 dB, and the peak of the system efficiency of the current loop antenna E21 exceeds −2 dB.

Therefore, through the foregoing simulation verification, the antenna pair in the distribution in parallel is moved to the upper left corner of the electronic device, to significantly improve the radiation performance of the magnetic loop antenna M21, and ensure that the radiation performance of the current loop antenna E21 is not greatly affected.

The foregoing descriptions of the high-isolation antenna pair in the distribution in parallel use the example in which the antenna pair includes the current loop antenna fed in the coupled manner and the magnetic loop antenna fed in the coupled manner. In some other embodiments of this application, the antenna pair may alternatively include a current loop antenna fed directly and/or a magnetic loop antenna fed directly. In some other embodiments of this application, the antenna pair may alternatively include another existing antenna, for example, the CM antenna and/or the DM antenna in the foregoing examples.

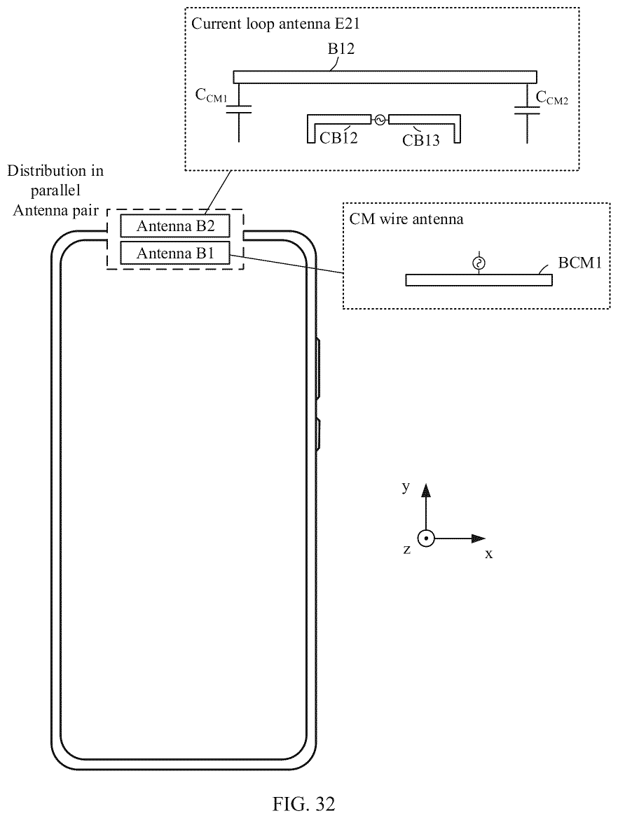

For example, FIG. 32 is a schematic diagram of an antenna pair in distribution in parallel. In this example, the antenna pair may include the current loop antenna E21 (for example, the antenna B2) fed in the coupled manner shown in FIG. 7 and a CM wire antenna (for example, the antenna B1). The antenna B1 and the antenna B2 may be distributed in parallel at a top edge of an electronic device. In other words, projections of the antenna B1 and the antenna B2 in a Y-axis direction at least partially or completely overlap.

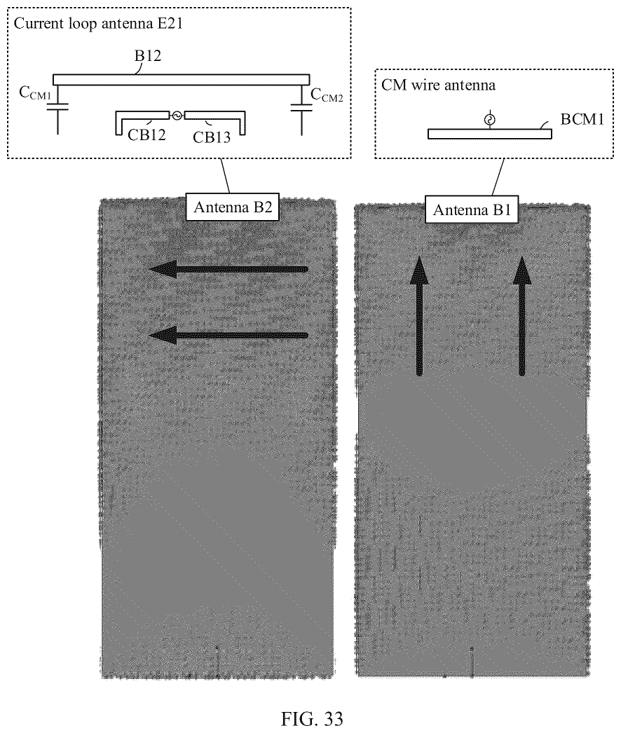

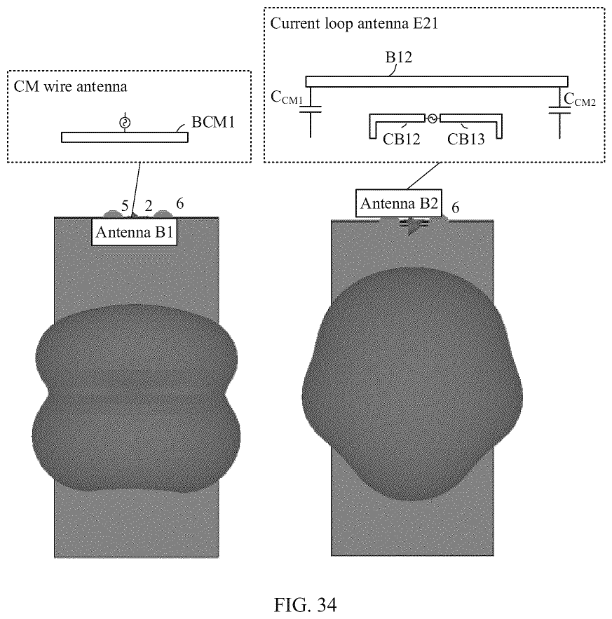

When the antenna pair with the composition shown in FIG. 32 operates, as shown in FIG. 33, the antenna B1 (namely, the CM wire antenna) can excite a longitudinal current on a ground plane, and correspondingly, the antenna B2 (namely, the current loop antenna E21) can excite a transverse current on the ground plane. In other words, the antenna B1 and the antenna B2 can excite orthogonal currents on the ground plane. FIG. 34 is a schematic diagram of a far-field directivity pattern of each antenna in this example.

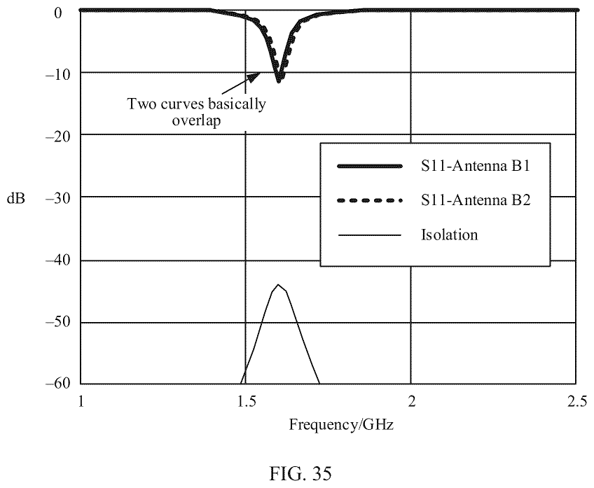

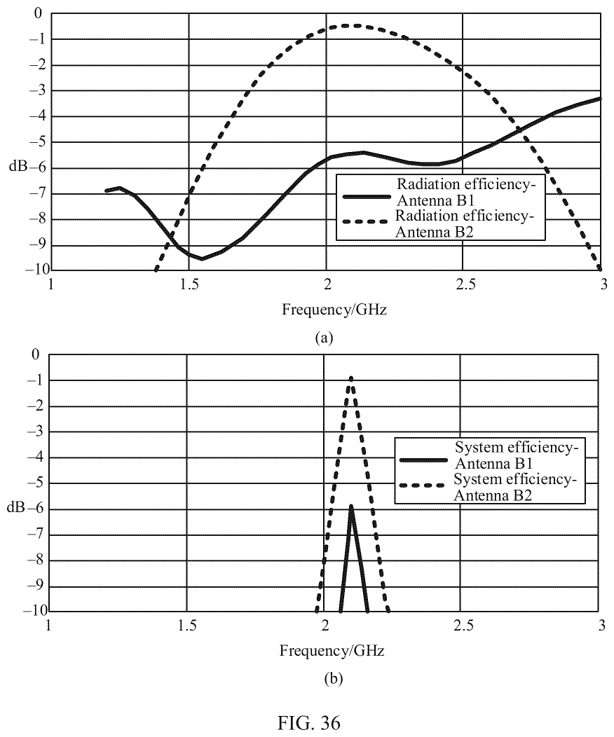

The following provides descriptions by using S parameter simulation and efficiency simulation. As shown in FIG. 35, when operating frequency bands of the antenna B1 and the antenna B2 basically overlap, S11 basically overlaps around 1.6 GHz. A deepest point of a curve exceeds −10 dB. Isolation identified by S12 is below −40 dB in the entire operating band. Therefore, high isolation is achieved. As shown in (a) in FIG. 36, in terms of radiation efficiency, the current loop antenna E21 definitely provides better radiation performance. In addition, the existing CM wire antenna can also provide radiation efficiency greater than −6 dB. Therefore, radiation capabilities that the two antennas can provide can meet bandwidth coverage during actual operation. As shown in (b) in FIG. 36, from the perspective of system efficiency, under current environment matching, peak efficiency of the current loop antenna E21 (namely, the antenna B2) has exceeded −1 dB, and correspondingly, peak efficiency of the existing CM antenna also exceeds −6 dB.

This proves that the antenna pair in the distribution in parallel and with the composition of the current loop antenna E21 and the existing antenna (for example, the CM wire antenna) shown in FIG. 32 can provide good radiation performance while having high isolation.

The following continues to use an example to describe an antenna pair including the current loop/magnetic loop antenna and an existing antenna in a scenario of distribution in parallel.

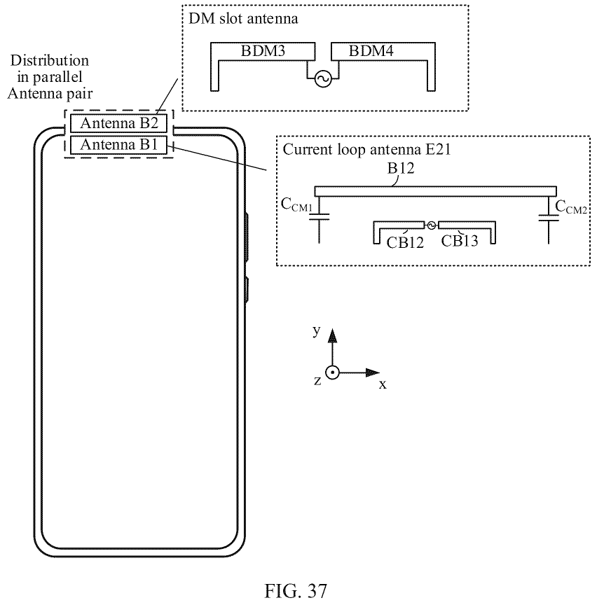

Refer to FIG. 37. In this example, the antenna B1 may be a current loop antenna E21. For example, the current loop antenna E21 may have the composition shown in FIG. 7. The antenna B2 may be a DM slot antenna. Similarly, the antenna B2 (namely, the CM slot antenna) can excite a longitudinal current on a ground plane, and correspondingly, the antenna B1 (namely, the current loop antenna E21) can excite a transverse current on the ground plane. In other words, the antenna B1 and the antenna B2 can excite orthogonal currents on the ground plane, and have high isolation.

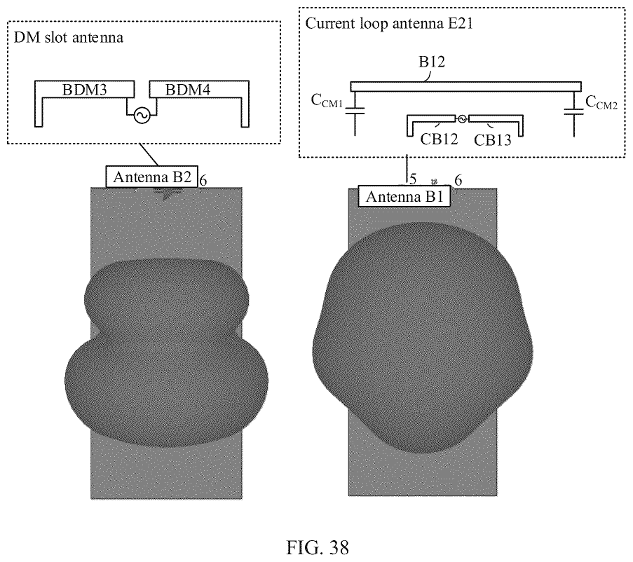

When the antenna pair with the composition shown in FIG. 37 operates, FIG. 38 is a schematic diagram of a far-field directivity pattern of each antenna in this example.

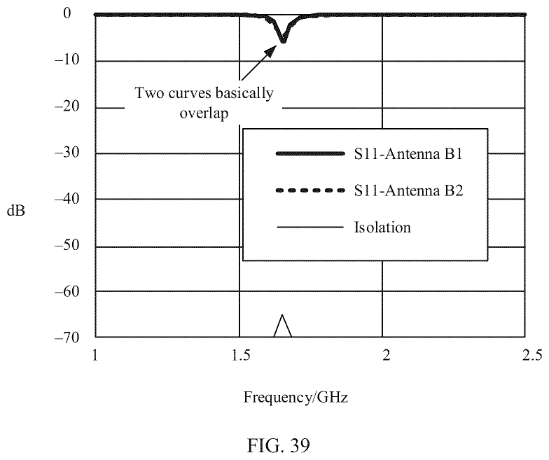

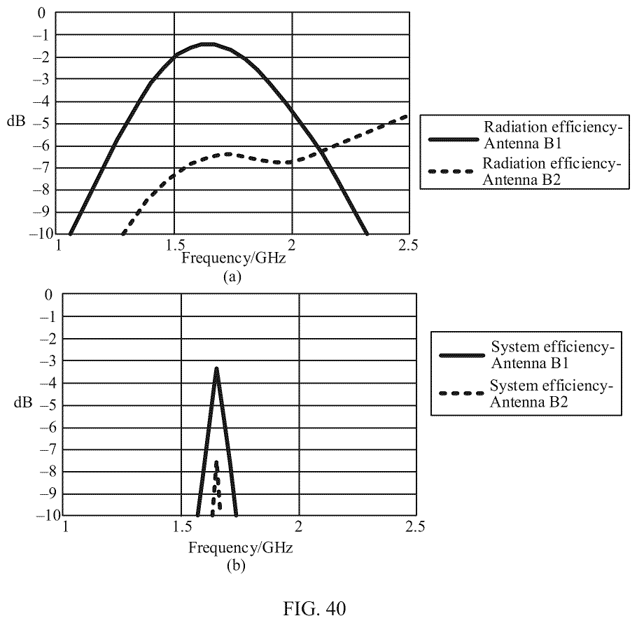

The following provides descriptions by using S parameter simulation and efficiency simulation. As shown in FIG. 39, when operating frequency bands of the antenna B1 and the antenna B2 basically overlap, S11 basically overlaps around 1.6 GHz. Isolation identified by S12 is below −60 dB in the entire operating band. Therefore, high isolation is achieved. As shown in (a) in FIG. 40, in terms of radiation efficiency, the current loop antenna E21 definitely provides better radiation performance. In addition, the existing DM slot antenna can also provide radiation efficiency greater than −7 dB. Therefore, radiation capabilities that the two antennas can provide can meet bandwidth coverage during actual operation. As shown in (b) in FIG. 40, from the perspective of system efficiency, under current environment matching, peak efficiency of the current loop antenna E21 (namely, the antenna B1) has exceeded −4 dB, and correspondingly, peak efficiency of the existing DM slot antenna also exceeds −8 dB.

This proves that the antenna pair in the distribution in parallel and with the composition of the current loop antenna E21 and the existing antenna (for example, the DM slot antenna) shown in FIG. 37 can provide good radiation performance while having high isolation.

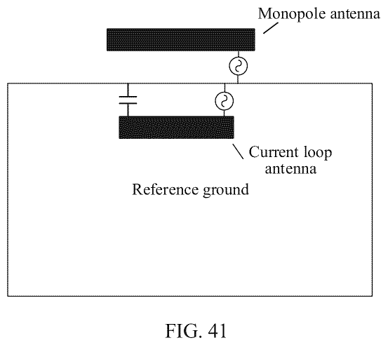

It may be understood that high-isolation antenna pairs including the existing antenna may further include an antenna pair including the current loop antenna and the CM wire antenna or the DM slot antenna. For example, as shown in FIG. 41, the current loop antenna and a monopole antenna may be distributed in parallel to form a high-isolation antenna pair. Orthogonality of ground plane currents that can be excited by the high-isolation antenna pair is similar to the orthogonality in the series distribution in the foregoing descriptions. Therefore, the high-isolation antenna pair can also have the high-isolation characteristic. In addition, through the series distribution or the distribution in parallel, an antenna pair including the magnetic loop antenna and the DM wire antenna or the CM slot antenna can also generate orthogonal ground plane currents in some directions, thereby providing high isolation. With reference to the high-isolation antenna pair including the CM wire antenna and the current loop antenna shown in FIG. 32, the antenna pair shown in FIG. 41 may also be understood as a miniaturized design of the high-isolation antenna pair shown in FIG. 32. For example, the antenna pair with the structure shown in FIG. 41 is mirrored left to right, and spliced with the antenna with the combination shown in FIG. 41 to obtain a high-isolation antenna pair with a composition similar to that shown in FIG. 32. In other words, when the high-isolation antenna pair shown in FIG. 32 can provide high isolation and good radiation performance, the miniaturized design, for example, the antenna pair with the composition shown in FIG. 41, of the high-isolation antenna pair can also provide high isolation and good radiation performance.

Based on the descriptions in FIG. 17A to FIG. 41, it can be understood that in the position relationships of the parallel distribution including the series distribution and the distribution in parallel, the high-isolation antenna pair including at least two antennas can achieve the high-isolation characteristic by exciting the orthogonal currents on the ground plane (or locally exciting the orthogonal currents). Similarly, the high-isolation characteristic can also be achieved through the opposite arrangement of two antennas.

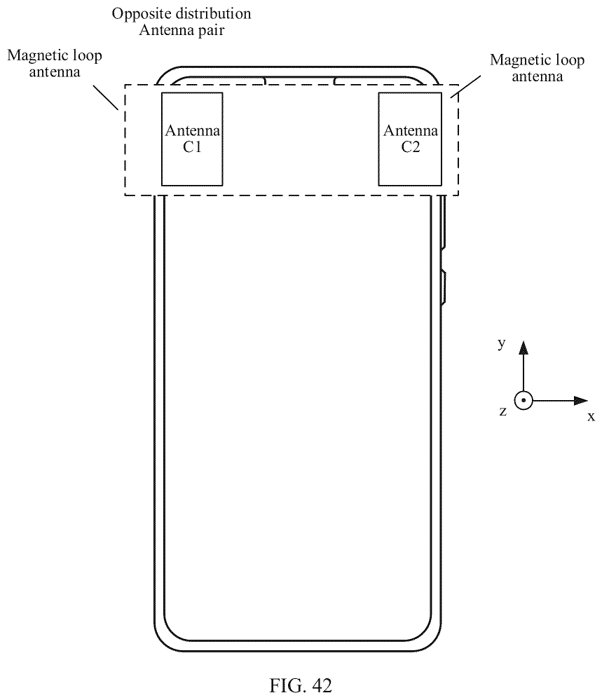

For example, as shown in FIG. 42, a high-isolation antenna pair including two antennas is used as an example. The two antennas may be an antenna C1 and an antenna C2 shown in FIG. 42. The antenna C1 and the antenna C2 may be arranged at two edges of an electronic device that do not intersect. For example, the antenna C1 and the antenna C2 may be arranged at two opposite edges of a mobile phone. The antenna C1 and the antenna C2 may alternatively be respectively arranged at a top edge and a bottom edge of the mobile phone. In addition, projections of the antenna C1 and the antenna C2 at the edges at which the antennas are arranged may partially or completely overlap. For example, if the antenna C1 and the antenna C2 are arranged at two opposite side edges, projections at either of the two opposite side edges partially or completely overlap. Alternatively, the projections may be staggered, in other words, the projections do not overlap. As shown in FIG. 42, both the antenna C1 and the antenna C2 may be set as magnetic loop antennas.

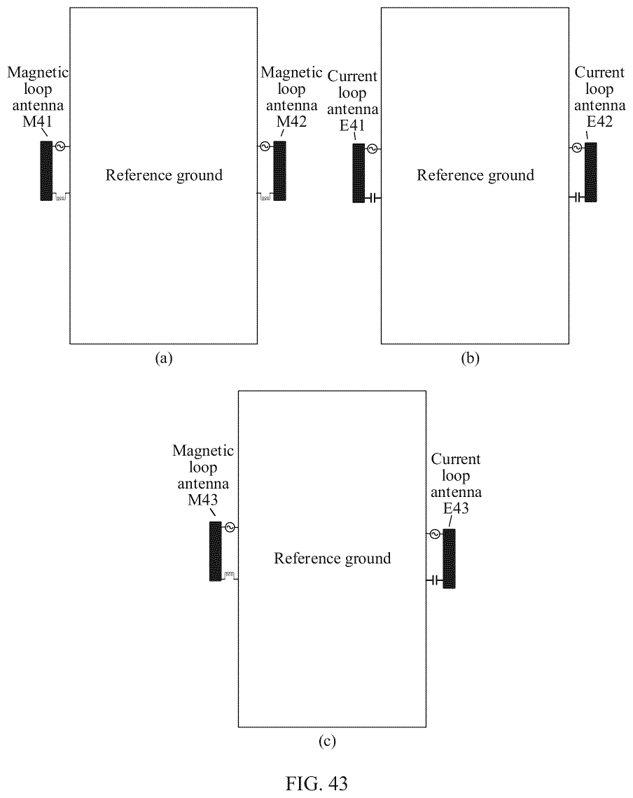

It should be noted that in different implementations, specific implementations of the antenna C1 and the antenna C2 may vary. In an example, FIG. 43 shows several specific examples of the high-isolation antenna pair in the opposite arrangement according to an embodiment of this application.

As shown in (a) in FIG. 43, the high-isolation antenna pair in this example may include a magnetic loop antenna M41 and a magnetic loop antenna M42. The magnetic loop antenna M41 and the magnetic loop antenna M42 may be oppositely arranged at two edges of the electronic device that are not adjacent to each other. For example, as shown in (a) in FIG. 43, the magnetic loop antenna M41 and the magnetic loop antenna M42 may be arranged at two long edges (namely, left and right edges) of the electronic device. In different implementations, the magnetic loop antenna M41 and the magnetic loop antenna M42 may be located at different positions of the long edges. For example, as shown in (a) in FIG. 43, the magnetic loop antenna M41 and the magnetic loop antenna M42 may be oppositely arranged in the middle of the long edges. Therefore, during operation, the magnetic loop antenna M41 and the magnetic loop antenna M42 may respectively excite orthogonal currents on a ground plane, thereby obtaining orthogonal spatial field distributions and achieving a high-isolation characteristic.

As shown in (b) in FIG. 43, the high-isolation antenna pair in this example may include a current loop antenna E41 and a current loop antenna E42. This is similar to the mechanism shown in (a) in FIG. 43. The current loop antenna E41 and the current loop antenna E42 may be oppositely arranged at two edges of an electronic device that are not adjacent to each other. For example, as shown in (b) in FIG. 43, the current loop antenna E41 and the current loop antenna E42 may be arranged at two long edges (namely, left and right edges) of the electronic device. In different implementations, the current loop antenna E41 and the current loop antenna E42 may be located at different positions of the long edges. For example, as shown in (b) of FIG. 43, the current loop antenna E41 and the current loop antenna E42 may be oppositely arranged in the middle of the long edges. Therefore, during operation, the current loop antenna E41 and the current loop antenna E42 may respectively excite local and orthogonal currents on a ground plane, thereby obtaining orthogonal spatial field distributions and achieving a high-isolation characteristic.

In addition, as shown in (c) in FIG. 43, the high-isolation antenna pair in this example may include a current loop antenna E43 and a magnetic loop antenna M43. The current loop antenna E43 and the magnetic loop antenna M43 may be oppositely arranged at two edges of an electronic device that are not adjacent to each other. For example, as shown in (c) in FIG. 43, the current loop antenna E43 and the magnetic loop antenna M43 may be arranged at two long edges (namely, left and right edges) of the electronic device. In different implementations, the current loop antenna E43 and the magnetic loop antenna M43 may be located at different positions of the long edges. For example, as shown in (c) of FIG. 43, the current loop antenna E43 and the magnetic loop antenna M43 may be oppositely arranged in the middle of the long edges. Therefore, during operation, the current loop antenna E43 and the magnetic loop antenna M43 may respectively excite orthogonal currents on a ground plane, thereby obtaining orthogonal spatial field distributions and achieving a high-isolation characteristic.

In addition, in the example shown in FIG. 43, descriptions are provided by using an example in which feeding is implemented in a direct feeding manner. In another implementation of this application, in the opposite position relationship (for example, the opposite arrangement) of the high-isolation antenna pair shown in FIG. 43, at least one antenna in an antenna pair with a same antenna type may alternatively be fed in a coupled manner.

For example, based on (c) in FIG. 43, the following uses an example to describe the high-isolation antenna pair in the opposite arrangement that is fed in the coupled manner.

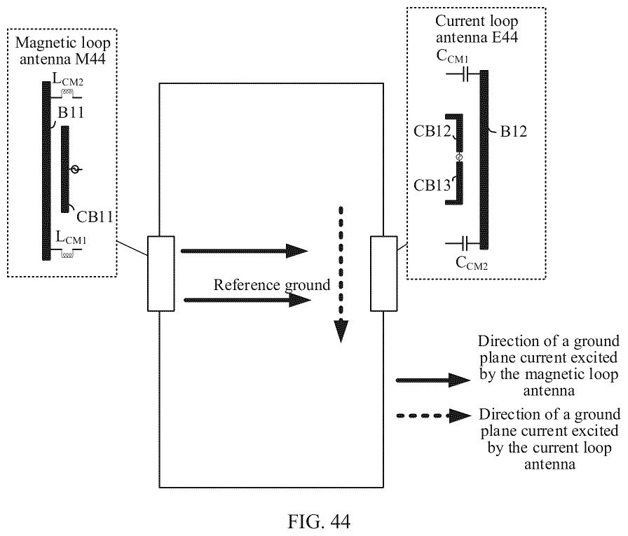

As shown in FIG. 44, in this example, the antenna pair may include a current loop antenna E44 fed in a coupled manner and a magnetic loop antenna M44 arranged opposite to the current loop antenna E44. In some implementations, the current loop antenna E44 may have the composition shown in FIG. 7, and the magnetic loop antenna M44 may have the composition shown in FIG. 10.

It should be understood that the coupled feeding illustrated in FIG. 44 is based on (c) in FIG. 43, and the antennas in (a) or (b) in FIG. 43 may also include at least one antenna that is fed in the coupled manner. Details are not described herein again.

As shown in FIG. 44, based on the foregoing analysis, when the magnetic loop antenna M44 is arranged at a center of the left long edge, in a ground plane current that can be excited by the magnetic loop antenna M44, a transverse current component is much greater than a longitudinal current component, thereby achieving an effect of the transverse current shown in FIG. 44. Correspondingly, the current loop antenna E44 can excite a longitudinal current on the ground plane, and the ground plane currents excited by the magnetic loop antenna M44 and the current loop antenna E44 are orthogonal. This achieves the high-isolation effect.

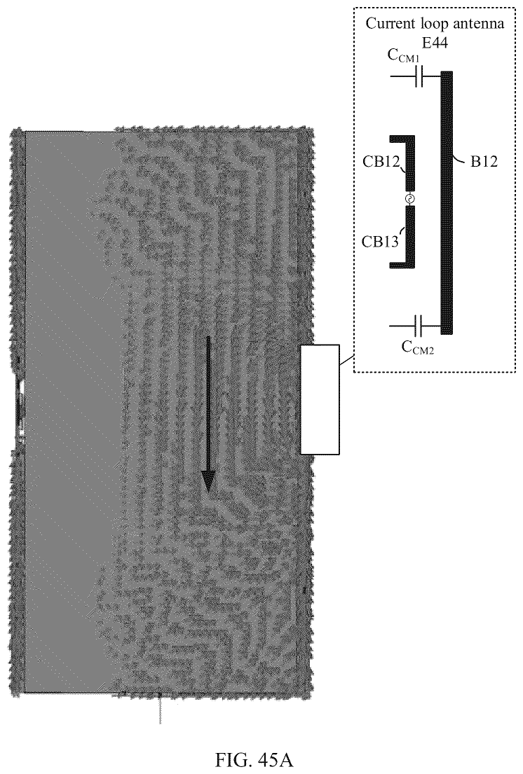

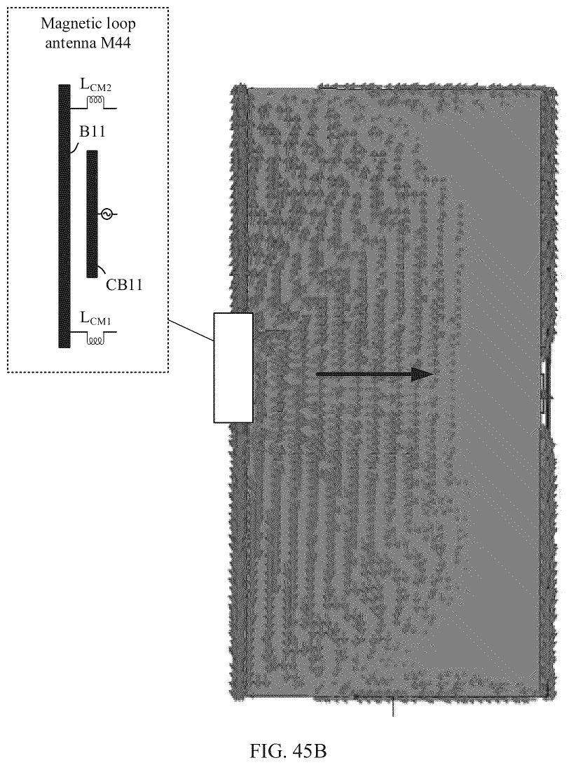

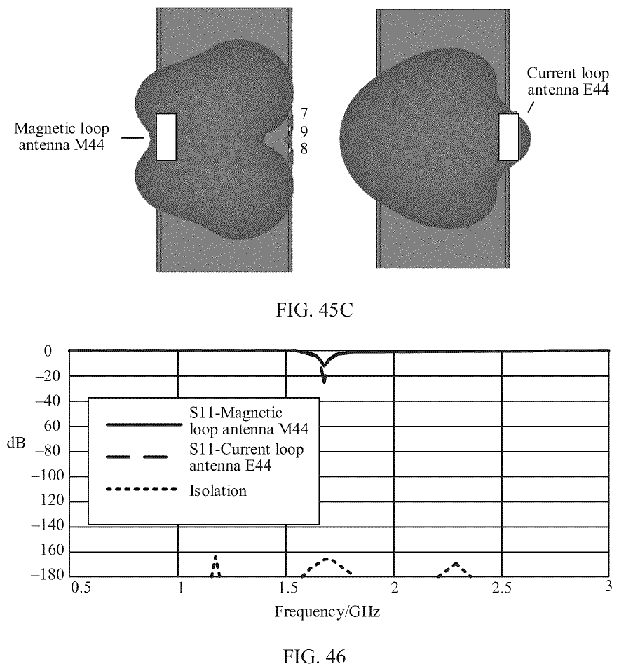

To more clearly describe the effect of the antenna solution provided in the embodiments of this application, with reference to FIG. 45A to FIG. 46, the following uses an example in which the high-isolation antenna pair in the opposite arrangement has the structure shown in FIG. 44 to describe an operating mechanism and an effect of the high-isolation antenna pair.

For example, FIG. 45A shows excitation of the ground plane current that is performed when the current loop antenna E44 operates. Through comparison with the theoretical analysis shown in FIG. 44, results are completely consistent. It can be learned that the current loop antenna E44 can excite the longitudinal current at the center of the ground plane. FIG. 45B shows excitation of the ground plane current that is performed when the magnetic loop antenna M44 operates. It can be learned that the magnetic loop antenna M44 can excite the transverse current at the center of the ground plane. Therefore, at the center of the ground plane, two orthogonal currents can be separately obtained, so that the current loop antenna E44 and the magnetic loop antenna M44 can excite orthogonal currents to achieve the high-isolation effect.

A far-field directivity pattern of the antenna group with the structure shown in FIG. 44 is shown in FIG. 45C. FIG. 46 shows a result of S parameter simulation. It can be learned that dual-port isolation of the two antennas has reached below −160 dB. Therefore, the isolation meets a high-isolation requirement. In addition, S11 indicates that deepest points of the two antennas also approach or reach −20 dB, and bandwidth is sufficient to cover at least one operating frequency band. Therefore, the antenna group with the structure shown in FIG. 44 can provide both good radiation performance and high isolation.

In addition, the examples shown in (a) and (b) in FIG. 43 provide a case in which the antenna pair including the same type of antennas can also provide high isolation. A reason is as follows: A distance between the two antennas is farther than that in the series distribution or the distribution in parallel, so that the high isolation can be achieved because of the farther distance. The isolation in the two examples can reach approximately −20 dB.

It should be noted that similar to the foregoing descriptions of the solutions of the series distribution and distribution in parallel, the solution of the opposite distribution may alternatively enable the current loop antenna and magnetic loop antenna to be of a structure different from those in the foregoing examples and fed in the coupled manner, which is different from the direct feeding. An effect that the solution of the opposite distribution can achieve is similar, and details are not described herein again.

Therefore, based on the foregoing solution descriptions in FIG. 17A to FIG. 46, it can be understood that in the parallel distribution including the series distribution, the distribution in parallel, and the opposite distribution, high isolation can be achieved because the orthogonal currents on the ground plane can be excited. In addition, because the current loop antenna and/or the magnetic loop antenna is used, the antenna solution also achieves good radiation performance.

In the following descriptions, with reference to the accompanying drawings, examples are used to describe achievement of a high-isolation characteristic of an antenna pair (antenna group) with the strong-coupling antenna composition listed in Table 1 in the orthogonal distribution case.

In this example, a high-isolation antenna pair including at least two antennas whose positions are orthogonal may be arranged on an electronic device to achieve the high isolation. The orthogonal positions may be: the two antennas are respectively arranged at two adjacent edges of the electronic device. Using an example in which the electronic device is a mobile phone, one antenna may be arranged at a short edge of the mobile phone, and the other antenna may be arranged at any long edge of the mobile phone adjacent to the short edge.

In a possible implementation, with reference to the descriptions in Table 1, the high-isolation antenna pair in the orthogonal distribution may include any of the following combinations:
one antenna is the current loop antenna, and the other antenna is the current loop antenna, the DM wire antenna, or the CM slot antenna; or one antenna is the magnetic loop antenna, and the other antenna is the magnetic loop antenna, the CM wire antenna, or the DM slot antenna.

During operation, the two antennas may respectively excite orthogonal currents on a ground plane, thereby obtaining orthogonal spatial field distributions and achieving the high-isolation characteristic. In addition, the high-isolation antenna pair can provide good radiation characteristic because the current loop antennas and/or the magnetic loop antenna is used.

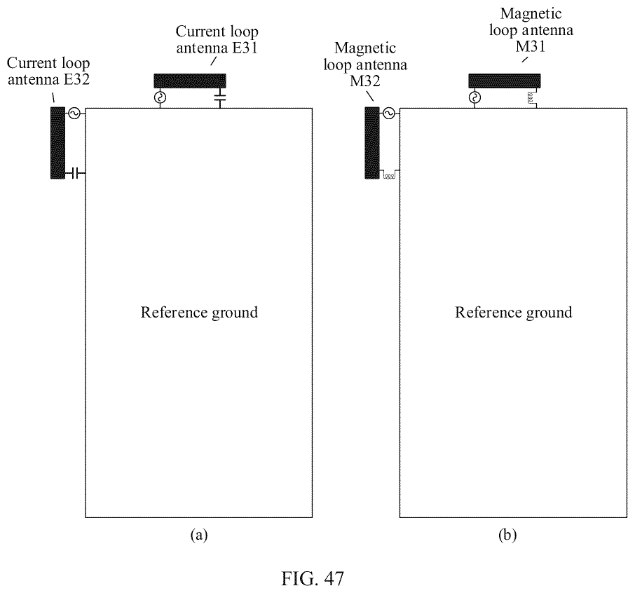

For example, in some embodiments, the high-isolation antenna pair may include two current loop antennas. For example, as shown in (a) in FIG. 47, an example in which the two current loop antennas are a current loop antenna E31 and a current loop antenna E32 is used. In this example, the current loop antenna E31 and current loop antenna E32 may be current loop monopole antennas. In some other examples, the current loop antenna E21 and/or the current loop antenna E32 may alternatively be other forms of current loop antennas. It should be understood that in different implementations, the current loop antennas may have different feeding manners such as direct feeding or coupled feeding.

In the example of (a) in FIG. 47, the current loop antenna E31 and the current loop antenna E32 may be located at two adjacent edges of an electronic device (for example, a mobile phone). For example, the current loop antenna E31 is arranged at a short edge at the top of the mobile phone, and the current loop antenna E32 is arranged at a left long edge of the mobile phone. The current loop antenna E32 may be arranged at two ends of the left long edge, for example, at the top or bottom of the left long edge.

In this way, when the high-isolation antenna pair including the current loop antenna E31 and the current loop antenna E32 operates, the current loop antenna E31 can excite a transverse current at a short edge of a ground plane, and correspondingly, the current loop antenna E32 can excite a longitudinal current at a long edge of the ground plane, thereby exciting orthogonal currents on the ground plane, obtaining orthogonal spatial field distributions in a far field, and therefore achieving a high-isolation effect.

Similar to (a) in FIG. 47, (b) in FIG. 47 uses an example in which the magnetic loop antenna is a magnetic loop monopole antenna that is fed directly. In some other embodiments of this application, the magnetic loop antenna M31 and/or the magnetic loop antenna M32 may alternatively be any other magnetic loop antenna in the foregoing descriptions. A feeding manner of the magnetic loop antenna M31 and/or the magnetic loop antenna M32 is not limited to the direct feeding, but may alternatively be the coupled feeding.

As described in the foregoing examples, an example in which the current loop antenna E32/the magnetic loop antenna M32 is arranged at the top of the left long edge is used for description. It can be understood that when the high-isolation antenna pair operates near the mid band (at 2 GHz), large current points corresponding to the ground plane are located at two ends of the side edge, and a ground plane current at the center of the side edge is small. Therefore, for the current loop antenna that is a magnetic field antenna, good performance can be achieved when the current loop antenna E32 is arranged at the two ends of the long edge. For example, in some other embodiments, the current loop antenna E32 may alternatively be arranged at the bottom of the long edge of the electronic device, and the longitudinal current at the long edge can also be excited, thereby achieving high isolation from the current loop antenna E31. Similarly, the current loop antenna E32 may alternatively be arranged at a large current position corresponding to a right long edge of the mobile phone, thereby achieving good radiation performance and high isolation from the current loop antenna E31.

The following uses an example in which the high-isolation antenna pair in the orthogonal distribution has the composition in (b) in FIG. 47 to describe performance of the high-isolation antenna pair.

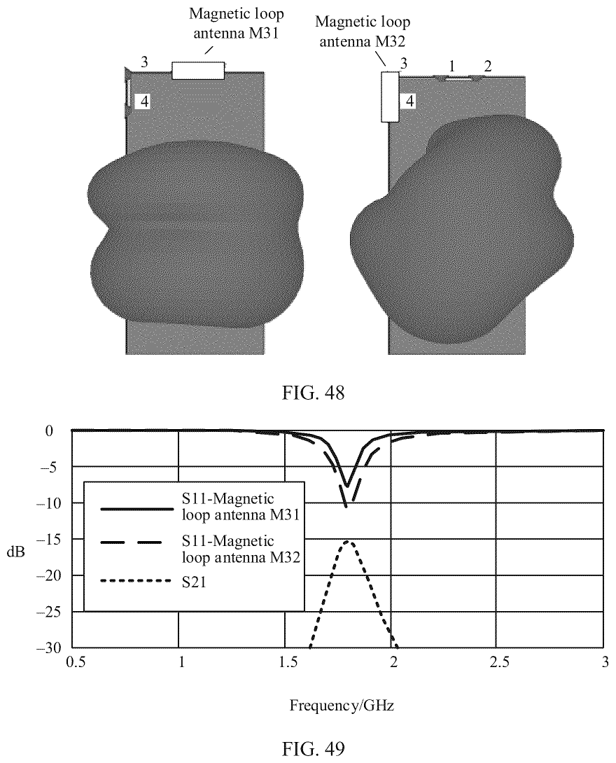

For example, as shown in FIG. 48, spatial field distributions generated by the high-isolation antenna pair in the orthogonal distribution and with the composition in (b) in FIG. 47 are approximately orthogonal. It can be understood that the magnetic loop antenna M31 can excite a longitudinal current on the ground plane. Correspondingly, the magnetic loop antenna M32 can excite a transverse current on the ground plane. However, in this example, to consider performance of the magnetic loop antenna, the magnetic loop antenna M32 is not arranged at a middle position at the side edge of the electronic device. Therefore, the excited transverse current on the ground plane is not absolutely parallel to a horizontal direction. However, because an angle between spatial fields generated by the two antennas is close to 90 degrees, the high-isolation effect can also be achieved.

For example, with reference to an S parameter simulation effect in FIG. 49, it can be learned that deepest points of S11 of the two antennas exceed −5 dB, and bandwidth is sufficient to cover one operating frequency band. Correspondingly, a worst point of S21 is close to −15 dB. The isolation can also meet a requirement (that a worst value is −10 dB) on isolation between the two antennas in the electronic device. Therefore, it can be proved that the two magnetic loop antennas shown in (b) in FIG. 47 can form a high-isolation antenna pair with good radiation performance.

In the foregoing descriptions of the orthogonal distribution, the example in which the antenna arranged at the side edge is located at two ends (for example, the top or bottom of the side edge of the mobile phone) is used. In some other embodiments of this application, the antenna at the side edge may alternatively be arranged at the center of the side edge.

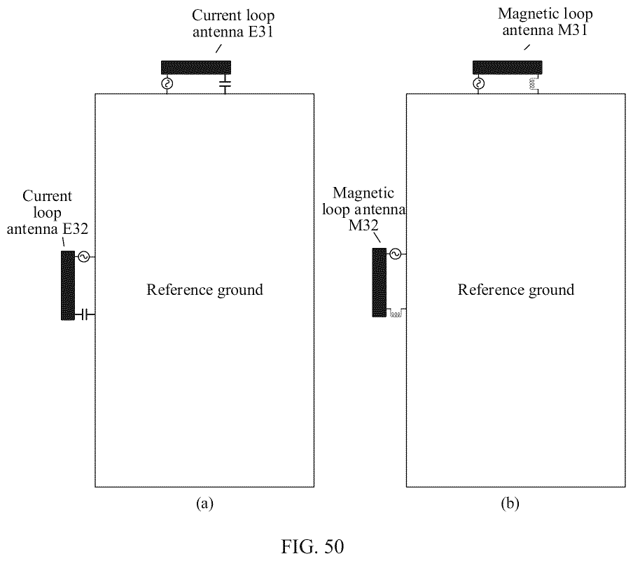

For example, refer to FIG. 50. As shown in (a) in FIG. 46, when the high-isolation antenna pair includes two current loop antennas, the current loop antenna E32 arranged at the side edge may be arranged at the center position (or close to the center position) of the side edge. Similarly, as shown in (b) in FIG. 50, when the high-isolation antenna pair includes two magnetic loop antennas, the magnetic loop antenna M32 arranged at the side edge may be arranged at a center position (or close to the center position) of the side edge.

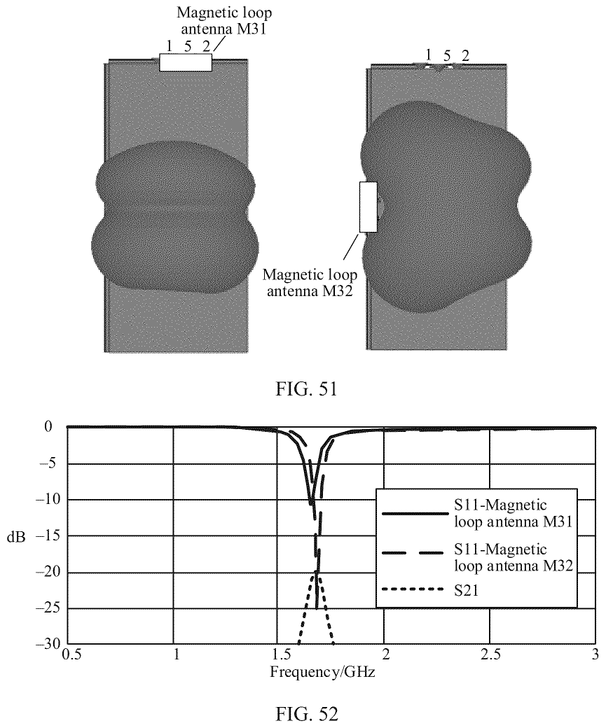

FIG. 51 is a schematic diagram of directivity pattern simulation of the high-isolation antenna pair shown in (b) in FIG. 50 in the orthogonal distribution that includes two magnetic loop antennas. It can be learned that the magnetic loop antenna M31 arranged at a top center can still generate a transverse spatial field distribution. Correspondingly, the magnetic loop antenna M32 arranged in the middle of the side edge can excite approximately longitudinal spatial field distributions in upper and lower areas of the electronic device respectively. This enables the magnetic loop antenna M31 and the magnetic loop antenna M32 to excite orthogonal spatial field distributions and achieve the high-isolation characteristic. In addition, because of the good radiation characteristics of the magnetic loop antenna M31 and the magnetic loop antenna M32, the high-isolation antenna pair having the composition shown in (b) in FIG. 50 has good radiation performance. This is similar to the foregoing descriptions.

FIG. 52 is a schematic diagram of S parameter simulation of the high-isolation antenna pair shown in (b) in FIG. 50 in the orthogonal distribution that includes two magnetic loop antennas. It can be learned that after the magnetic loop antenna M32 is moved to the center position at the side edge, S11 is significantly improved, with a deepest point exceeding −20 dB. In addition, because orthogonality of the directivity pattern is enhanced, dual-port isolation is also improved, and a worst point reaches about −20 dB.

The high-isolation antenna pair having the composition shown in (a) in FIG. 50 can also achieve a similar high-isolation characteristic and good radiation performance. This is similar to (b) in FIG. 50.

In an actual application process of the orthogonal high-isolation antenna pair, the position of the current loop antenna/magnetic loop antenna at the side edge may be flexibly set according to a specific environmental requirement, thereby achieving the high-isolation characteristic.

The foregoing descriptions of the high-isolation antenna solution in the orthogonal distribution are provided by using an example in which the antenna solution includes one antenna pair that includes two antennas. In some other embodiments of this application, the high-isolation antenna solution in the orthogonal distribution may alternatively include more antennas. For example, the high-isolation antenna solution in the orthogonal distribution may be provided with a high-isolation antenna group including three or more antennas. The high-isolation antenna group may include a distributed antenna structure including two or more antennas. The distributed antenna structure may achieve a high-isolation effect with another antenna in the high-isolation antenna group.

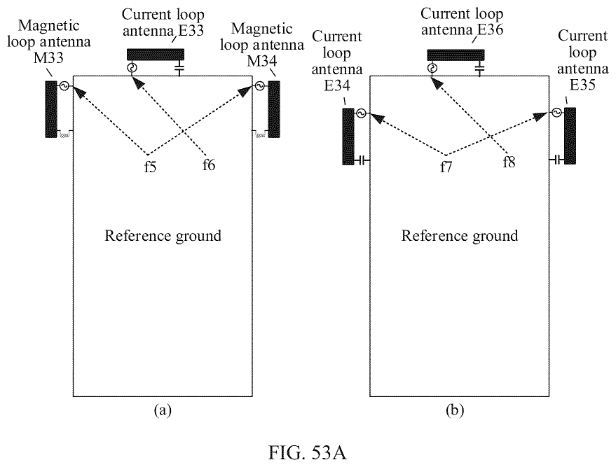

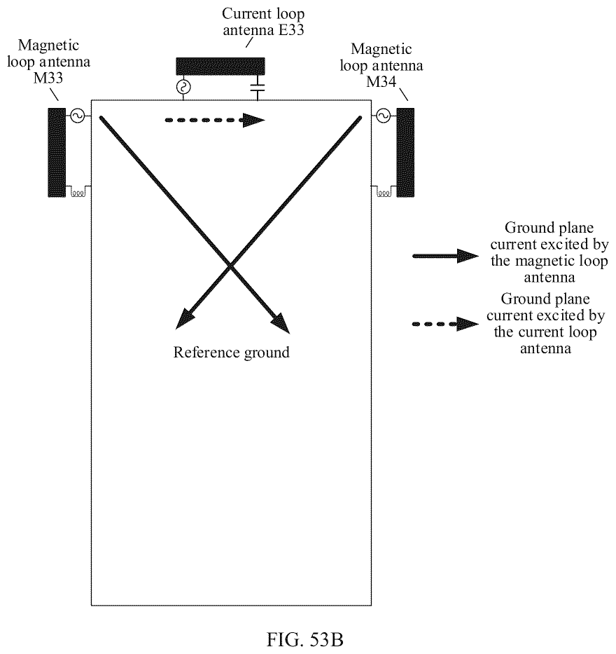

For example, FIG. 53A is a schematic diagram of some high-isolation antenna groups in orthogonal distribution according to an embodiment of this application.

As shown in (a) in FIG. 53A, the high-isolation antenna group in this example may include three antennas. The three antennas are respectively a current loop antenna E33 arranged in the middle of the top, a magnetic loop antenna M33 arranged at a left long edge (for example, at an upper end of the left side), and a magnetic loop antenna M34 arranged at a right long edge (for example, at an upper end of the right side). The two magnetic loop antennas (for example, the magnetic loop antenna M33 and the magnetic loop antenna M34) are symmetrically fed (of an equal amplitude and a same phase) to form a single-port distributed antenna structure 5. The distributed antenna structure 5 and the current loop antenna E33 located in the middle form a dual-port antenna structure. For example, the magnetic loop antenna M33 is fed by using a feed signal f5. In addition, the magnetic loop antenna M34 may also be fed by using the feed signal f5. This implements the symmetrical feeding of the magnetic loop antenna M33 and the magnetic loop antenna M34. In addition, the current loop antenna E33 may also be fed by using a feed signal f6. In this way, the distributed antenna structure 5 can achieve a high-isolation effect with the current loop antenna E33.

In some other embodiments, as shown in (b) in FIG. 53A, the high-isolation antenna group in this example may include three antennas. The three antennas are respectively a current loop antenna E36 arranged in the middle of the top, a current loop antenna E34 arranged at a left long edge (for example, at an upper end of the left side), and a current loop antenna E35 arranged at a right long edge (for example, at an upper end of the right side). The two current loop antennas (such as the current loop antenna E34 and the current loop antenna E35) are symmetrically fed (of an equal amplitude and a same phase) to form a single-port distributed antenna structure 6. The distributed antenna structure 6 and the current loop antenna E36 located in the middle form a dual-port antenna structure. For example, the current loop antenna E34 is fed by using a feed signal f7. In addition, the current loop antenna E35 may also be fed by using the feed signal f7. This implements the symmetrical feeding of the current loop antenna E34 and the current loop antenna E35. In addition, the current loop antenna E36 may also be fed by using a feed signal f8. In this way, the distributed antenna structure 6 can achieve a high-isolation effect with the current loop antenna E36.

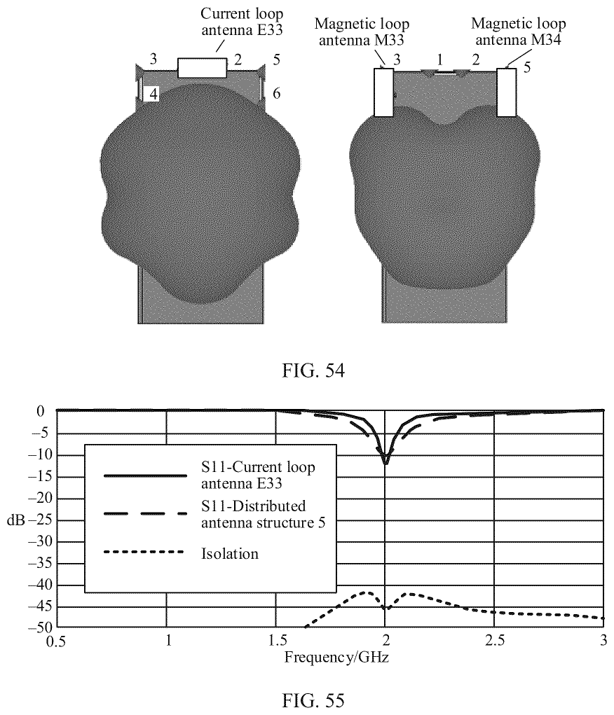

Using the structure illustrated in (a) in FIG. 53A as an example, with reference to FIG. 54 and FIG. 55, a high-isolation characteristic and good radiation performance of the structure are described by using far-field directivity pattern simulation and S parameter simulation.

FIG. 53B is a schematic diagram of currents of the antenna group with the structural composition shown in (a) in FIG. 53A. Based on the foregoing analysis, when the magnetic loop antenna is arranged at the end of the edge at which the magnetic loop antenna is located, the transverse and longitudinal components of the ground plane current excited by the magnetic loop antenna are both significant. As shown in FIG. 53B, the magnetic loop antenna M33 can excite a current in a lower right direction, and the magnetic loop antenna M34 can excite a current in a lower left direction. In this case, when the magnetic loop antenna M33 and the magnetic loop antenna M34 simultaneously operate for symmetrical feeding, horizontal components of the ground plane currents excited by the magnetic loop antenna M33 and the magnetic loop antenna M34 are in opposite directions and therefore cancel each other out. Vertical components are in a same direction and therefore may be superimposed. In this way, when simultaneously operating, the magnetic loop antenna M33 and the magnetic loop antenna M34 can jointly excite a longitudinal current on the ground plane. The longitudinal current has a good orthogonal effect with a transverse current excited by the current loop antenna E33. This provides a high-isolation effect.

FIG. 54 shows a far-field directivity pattern distribution of the antenna solution with the structure illustrated in (a) in FIG. 53A during operation.

FIG. 55 is a schematic diagram of S parameter simulation of the antenna solution with the structure illustrated in (a) in FIG. 53A during operation. It can be learned that deepest points of S11 of the current loop antenna E33 and the distributed antenna structure 5 including the magnetic loop antenna M33 and the magnetic loop antenna M34 both exceed −10 dB, and bandwidth of the current loop antenna E33 and the distributed antenna structure 5 is also sufficient to cover at least one operating frequency band. Correspondingly, from the perspective of isolation, a worst point of the isolation between the two antenna structures is also below −40 dB. Therefore, high isolation is achieved.

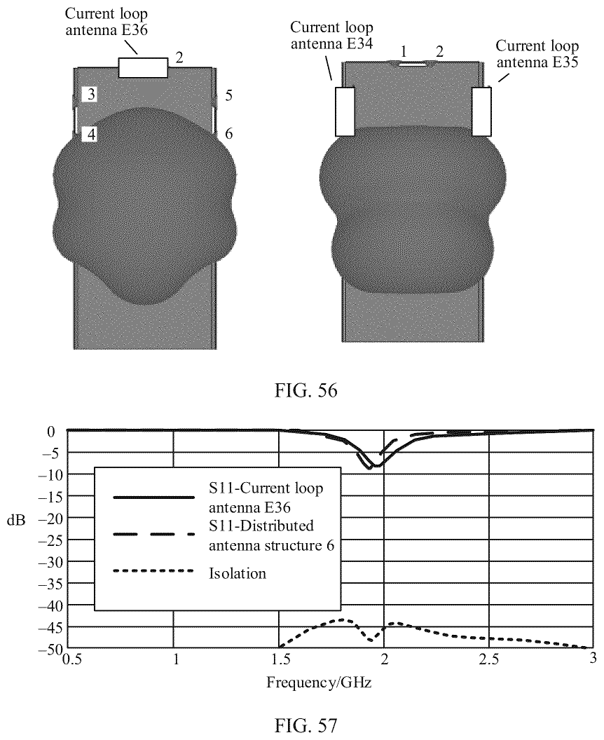

Using the structure illustrated in (b) in FIG. 53A as an example, with reference to FIG. 56 and FIG. 57, a high-isolation characteristic and good radiation performance of the structure are described by using far-field directivity pattern simulation and S parameter simulation.

FIG. 56 shows a far-field directivity pattern distribution of the antenna solution with the structure illustrated in (b) in FIG. 53A during operation.

FIG. 57 is a schematic diagram of S parameter simulation of the antenna solution with the structure illustrated in (b) in FIG. 53A during operation. It can be learned that deepest points of S11 of the current loop antenna E36 and the distributed antenna structure 6 are both close to −10 dB, and bandwidth of the current loop antenna E36 and the distributed antenna structure 6 is also sufficient to cover at least one operating frequency band. Correspondingly, from the perspective of isolation, a worst point of the isolation between the two antenna structures is also below −40 dB. Therefore, high isolation is achieved.

The high-isolation antenna groups including multiple orthogonally distributed antennas in FIG. 53A to FIG. 57 are all symmetrically fed. In other words, the multiple antennas in the high-isolation antenna group may be fed simultaneously with an equal amplitude and a same phase.

An embodiment of this application further provides another high-isolation antenna group including multiple orthogonally distributed antennas. Different antennas (distributed antenna structures) in the high-isolation antenna group may be asymmetrically fed to achieve a high-isolation characteristic.

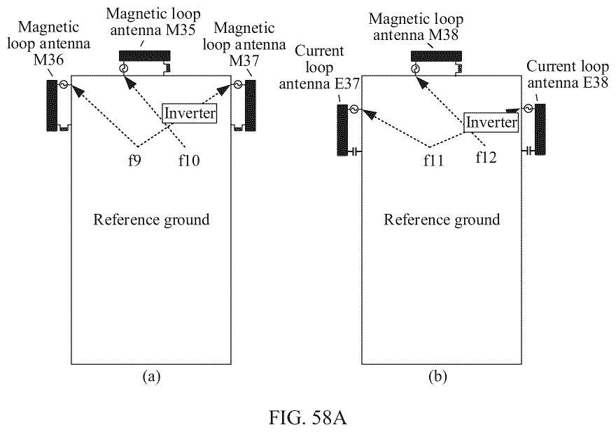

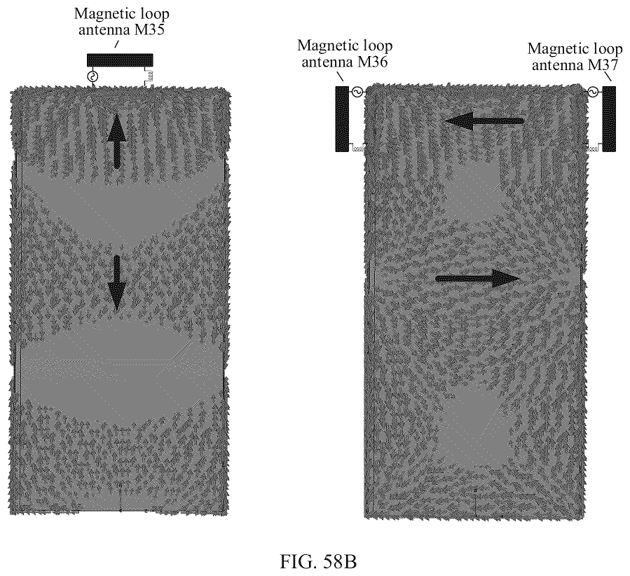

For example, FIG. 58A is a schematic composition diagram of two high-isolation antenna groups according to an embodiment of this application. The two high-isolation antenna groups may separately achieve the high-isolation characteristic through asymmetrical feeding.

As shown in (a) in FIG. 58A, the high-isolation antenna group may include three antennas, for example, a magnetic loop antenna M35 arranged at a center of a short edge of an electronic device and a magnetic loop antenna M36 and a magnetic loop antenna M37 each arranged at either of two ends of a long edge of the electronic device (for example, at the top of the long edge), where the magnetic loop antenna M36 and the magnetic loop antenna M37 are arranged at same ends of the long edges. During operation, the magnetic loop antenna M36 and the magnetic loop antenna M37 are asymmetrically fed (of an equal amplitude and opposite phases), to form a single-port distributed antenna structure 7. The formed single-port structure 7 forms a dual-port antenna structure with the current loop antenna M35 located in the middle. The distributed structure 7 and the magnetic loop antenna M35 can achieve a high-isolation effect. For example, the magnetic loop antenna M36 may be fed by using a feed signal f9, and the magnetic loop antenna M37 may be fed by using a signal (for example, obtained through an inverter) of an equal amplitude and an opposite phase with the feed signal f9, thereby achieving asymmetrical feeding of the magnetic loop antenna M36 and the magnetic loop antenna M37. In addition, the magnetic loop antenna M35 may also be fed by using a feed signal f10.

As shown in (b) in FIG. 58A, the high-isolation antenna group may include three antennas, for example, a magnetic loop antenna M38 arranged at a center of a short edge of an electronic device and a current loop antenna E37 and a current loop antenna E38 each arranged at either of two ends of a long edge of the electronic device (for example, at the top of the long edge), where the current loop antenna E37 and the current loop antenna E38 are arranged at same ends of the long edges. During operation, the current loop antenna E37 and the current loop antenna E38 are asymmetrically fed (of an equal amplitude and opposite phases), to form a single-port distributed antenna structure 8. The formed single-port structure 8 and the magnetic loop antenna M38 located in the middle form a dual-port antenna structure. The distributed structure 8 and the magnetic loop antenna M38 can achieve a high-isolation effect. For example, the current loop antenna E37 may be fed by using a feed signal f11, and the current loop antenna E38 may be fed by using a signal (for example, obtained through an inverter) of an equal amplitude and an opposite phase with the feed signal f11, thereby achieving the asymmetrical feeding of the current loop antenna E37 and the current loop antenna E38. In addition, the magnetic loop antenna M38 may also be fed by using a feed signal f12.

The following describes the effects of the foregoing solutions with reference to examples of directivity pattern simulation and S parameter simulation.

For example, FIG. 58B is a schematic diagram of current simulation of the high-isolation antenna group with the composition shown in (a) in FIG. 58A. It can be learned that the distributed antenna structure including the magnetic loop antenna M36 and the magnetic loop antenna M37 that are asymmetrically fed can obtain a transverse current distribution. Correspondingly, the magnetic loop antenna M35 arranged in the middle of the short edge can excite a longitudinal current on a ground plane. In this way, two orthogonal current distributions are excited to achieve the high-isolation characteristic.

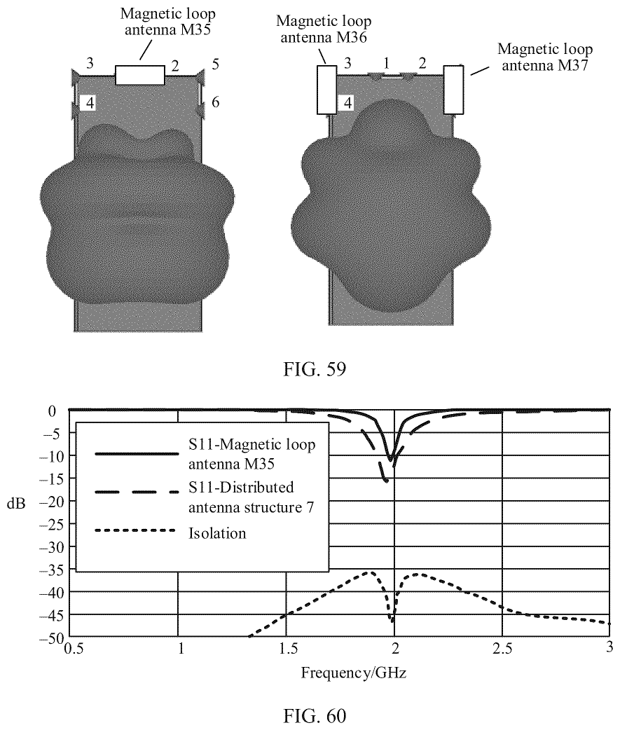

FIG. 59 and FIG. 60 each show an example of performance simulation of the high-isolation antenna group with the composition shown in (a) in FIG. 58A. FIG. 59 is a schematic diagram of a far-field directivity pattern. With reference to the S parameter simulation illustrated in FIG. 60, a worst value of isolation is below −35 dB. Therefore, a high-isolation requirement can be met. In addition, in terms of S11, deepest points of S11 of the magnetic loop antenna M35 and the distributed antenna structure 7 both exceed −10 dB, and bandwidth is also sufficient to meet a coverage requirement of at least one operating frequency band. Therefore, the high-isolation antenna group with the structure shown in (a) in FIG. 58A can provide good radiation performance and high isolation.

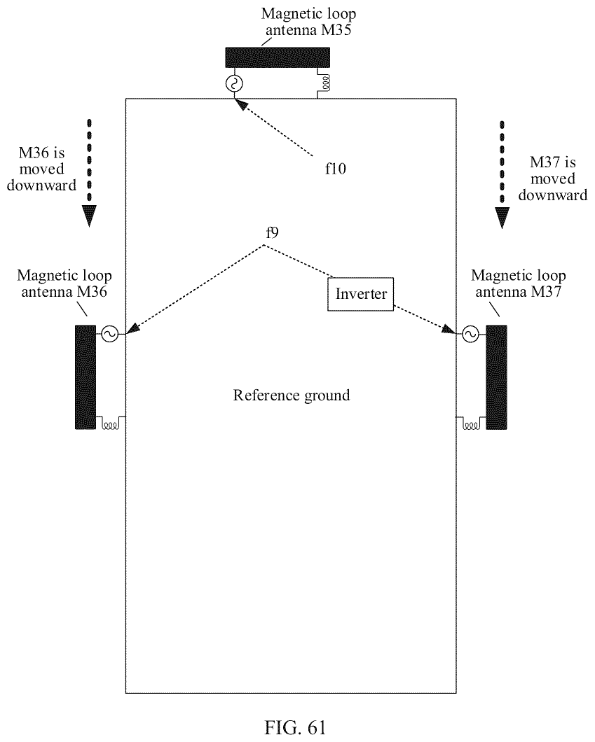

It should be noted that the example in (a) in FIG. 58A is described by using an example in which the magnetic loop antenna at the side edge is at one of two ends of the side edge. In some other embodiments of this application, when the magnetic loop antenna is arranged at the side edge, the magnetic loop antenna may alternatively be arranged at a position other than the one of two ends. For example, the magnetic loop antenna may be arranged near the center of the long side edge. For example, with reference to FIG. 61, an example in which the high-isolation antenna group includes a magnetic loop antenna M35 arranged at a center of a short edge of the electronic device and a magnetic loop antenna M36 and a magnetic loop antenna M37 arranged near centers of long edges of the electronic device is used. That is, in comparison with the example of (a) in FIG. 58A, in this example, the position of the magnetic loop antenna arranged at the left side edge and/or the right side edge may be moved downward to a position near the center of the long edge.

During operation, feed signals fed into the magnetic loop antenna M36 and the magnetic loop antenna M37 may be asymmetrical feed signals. For example, the magnetic loop antenna M36 is fed by using a feed signal f9, and the magnetic loop antenna M37 may be fed by using a signal (for example, obtained through an inverter) of an equal amplitude and an opposite phase with the feed signal 19, and the magnetic loop antenna M35 may also be fed by using a feed signal f10, to achieve the high-isolation characteristic of operating modes of the magnetic loop antenna M35 and the distributed antennas including the magnetic loop antenna M36 and the magnetic loop antenna M37.

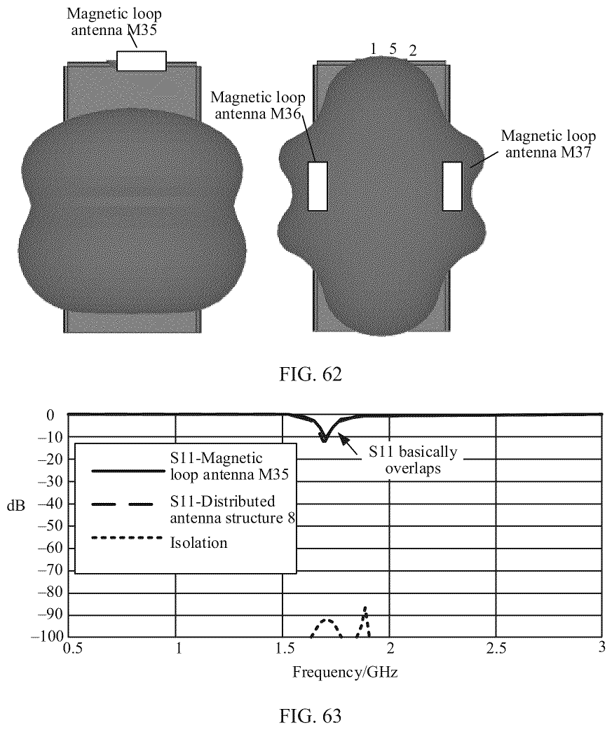

For example, FIG. 62 shows a far-field directivity pattern of the high-isolation antenna group with the structure shown in FIG. 61 during operation. With reference to S parameter simulation illustrated in FIG. 63, a worst value of the isolation between the magnetic loop antenna M35 and the distributed antenna structure 8 exceeds −80 dB, thereby meeting a requirement for the high-isolation characteristic. In addition, for a simulation result of S11, it can be learned that deepest points of the magnetic loop antenna M35 and the distributed antenna structure 8 have exceeded −10 dB, and bandwidth is sufficient to cover at least one operating frequency band.

That is, the distributed high-isolation antenna group provided in this embodiment of this application can obtain the high-isolation characteristic regardless of whether the magnetic loop antenna at the side edge is arranged at the end or the center position. It should be understood that the foregoing conclusion is still applicable to the high-isolation antenna group shown in (b) of FIG. 58A that includes two current loop antennas and one magnetic loop antenna With reference to the accompanying drawings, the following describes an operating status of the high-isolation antenna group with the structure shown in (b) in FIG. 58A.

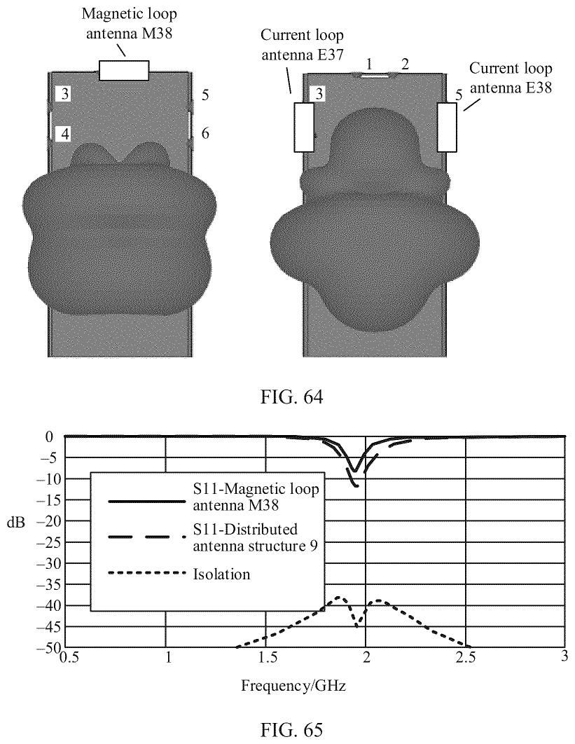

For example, FIG. 64 and FIG. 65 each show an example of performance simulation of the high-isolation antenna group with the structure shown in (b) in FIG. 58A. FIG. 64 is a schematic diagram of a far-field directivity pattern. With reference to S parameter simulation illustrated in FIG. 65, a worst value of isolation is below −35 dB. Therefore, a high-isolation requirement can be met. In addition, in terms of S11, deepest points of S11 of the magnetic loop antenna M38 and the distributed antenna structure 9 both exceed or approach −10 dB, and bandwidth is also sufficient to meet a coverage requirement of at least one operating frequency band. Therefore, the high-isolation antenna group with the structure shown in (a) in FIG. 58A can provide good radiation performance and high isolation under excitation of the asymmetrical feed signals.

Based on the descriptions in FIG. 47 to FIG. 65, a person skilled in the art should have an accurate understanding of the composition features and achievable effects of the high-isolation antenna pair/antenna group in the orthogonal distribution provided in this application. It should be noted that similar to the foregoing descriptions of the solutions of the series distribution and distribution in parallel, the solution of the orthogonal distribution may alternatively enable the current loop antenna and magnetic loop antenna to be of a structure different from those in the foregoing examples and fed in the coupled manner, which is different from the direct feeding. An effect that the solution of the orthogonal distribution can achieve is similar, and details are not described herein again.

Although this application is described with reference to specific features and embodiments thereof, it is obvious that various modifications and combinations may be made to them without departing from the scope of this application. Correspondingly, this specification and the accompanying drawings are merely used as examples of descriptions of this application defined by the appended claims, and are considered as having covered any of and all of modifications, variations, combinations, or equivalents within the scope of this application. Obviously, a person skilled in the art can make various modifications and variations to this application without departing from the spirit and scope of this application. In this way, if the modifications and variations made to this application fall within the scope of the claims of this application and their equivalent technologies, this application is intended to include these modifications and variations.

1. A terminal antenna system, comprising:
a first antenna; and
a second antenna, wherein the first antenna and the second antenna comprise at least one current loop antenna or magnetic loop antenna,
wherein when the current loop antenna operates, a uniform magnetic field is distributed between a radiating element of the current loop antenna and a reference ground,
wherein when the magnetic loop antenna operates, a uniform electric field is distributed between a radiating element of the magnetic loop antenna and the reference ground, and
wherein the first antenna and the second antenna are either a) arranged at a same edge of an electronic device, or b) arranged at two opposite edges of the electronic device.

2. The terminal antenna system of claim 1, wherein when the first antenna is a magnetic loop antenna, the second antenna is a current loop antenna.

3. The terminal antenna system of claim 1, wherein the first antenna and the second antenna are fed directly, or wherein the first antenna and the second antenna are fed in a coupled manner.

4. The terminal antenna system of claim 1, wherein when the first antenna operates, a ground plane current is excited in a first direction, and wherein when the second antenna operates, a ground plane current is excited in a second direction orthogonal to the first direction.

5. The terminal antenna system of claim 1, wherein the first antenna and the second antenna being arranged at the same edge of the electronic device comprises the first antenna and the second antenna being arranged at a first edge of the electronic device, wherein projections of the first antenna and the second antenna at the first edge do not overlap.

6. The terminal antenna system of claim 5, wherein when the first antenna and the second antenna are fed directly, either a) a feed point of the first antenna is arranged at an end of the first antenna close to the second antenna, and a feed point of the second antenna is arranged at an end of the second antenna close to the first antenna, or b) the feed point of the first antenna is arranged at an end of the first antenna away from the second antenna, and the feed point of the second antenna is arranged at an end of the second antenna away from the first antenna.

7. The terminal antenna system of claim 5, wherein the terminal antenna system further comprises a third antenna arranged at the first edge, wherein projections in a direction perpendicular to the first direction that are of radiating elements of the third antenna, the first antenna, and the second antenna do not overlap, and wherein the second antenna is arranged between the first antenna and the third antenna.

8.-9. (canceled)

10. The terminal antenna system of claim 1, wherein the first antenna and the second antenna being arranged at the same edge of the electronic device comprises the first antenna and the second antenna being arranged at a first edge of the electronic device, wherein projections of the first antenna and the second antenna at the first edge at least partially overlap.

11.-12. (canceled)

13. The terminal antenna system of claim 1, wherein the first antenna and the second antenna being arranged at two opposite edges of the electronic device comprises the first antenna being arranged at a first position at a first edge of the electronic device, and the second antenna being arranged at a second position at a second edge of the electronic device, wherein the first edge and the second edge are both adjacent to a third edge of the electronic device.

14.-15. (canceled)

16. The terminal antenna system of claim 10, wherein when the first antenna and the second antenna are fed directly, a feed point of the first antenna is arranged on a radiating element of the first antenna, a feed point of the second antenna is arranged on a radiating element of the second antenna, and the feed point of the first antenna and the feed point of the second antenna are arranged on a same side of the radiating element of the first antenna and the radiating element of the second antenna.

17. The terminal antenna system of claim 1, wherein the current loop antenna comprises a current loop wire antenna and a current loop slot antenna, wherein at least one first capacitor that is grounded is connected in parallel on a radiating element of the current loop wire antenna, and at least one second capacitor is connected in series on a radiating element of the current loop slot antenna, wherein the first capacitor is configured to adjust a current distribution on the current loop wire antenna to obtain a uniform magnetic field between the current loop wire antenna and the reference ground, and wherein the second capacitor is configured to adjust a current distribution on the current loop slot antenna to obtain a uniform magnetic field between the current loop slot antenna and the reference ground.

18. (canceled)

19. The terminal antenna system of claim 1, wherein the magnetic loop antenna comprises a magnetic loop wire antenna and a magnetic loop slot antenna, wherein at least one first inductor that is grounded is connected in parallel on a radiating element of the magnetic loop wire antenna, and at least one second inductor is connected in series on a radiating element of the magnetic loop slot antenna, wherein the first inductor is configured to adjust a current distribution on the magnetic loop wire antenna to obtain a uniform electric field between the magnetic loop wire antenna and the reference ground, and wherein the second inductor is configured to adjust a current distribution on the magnetic loop slot antenna to obtain a uniform electric field between the magnetic loop slot antenna and the reference ground.

20. (canceled)

21. A terminal antenna system, comprising:
a first antenna; and
a second antenna, wherein the first antenna and the second antenna comprise at least one current loop antenna or magnetic loop antenna,
wherein the first antenna and the second antenna are either a) arranged at a same edge of an electronic device, or b) arranged at two opposite edges of the electronic device,
wherein when the current loop antenna is a current loop monopole antenna or a current loop dipole antenna, a first capacitor that is grounded is arranged at at least one end of a radiating element of the current loop antenna,
wherein when the current loop antenna is a current loop aperture antenna or a current loop left-hand antenna, at least one second capacitor is arranged in series on a radiating element of the current loop antenna,
wherein when an operating frequency band of the current loop antenna is between 450 MHz to 1 GHz, a capacitance value of the first capacitor or the second capacitor is set within [1.5 pF, 15 pF],
wherein when the operating frequency band of the current loop antenna is between 1 GHz to 3 GHz, the capacitance value of the first capacitor or the second capacitor is set within [0.5 pF, 15 pF],
wherein when the operating frequency band of the current loop antenna is between 3 GHz to 10 GHz, the capacitance value of the first capacitor or the second capacitor is set within [1.2 pF, 12 pF]; and
wherein when the magnetic loop antenna is a magnetic loop monopole antenna or a magnetic loop dipole antenna, a first inductor that is grounded is arranged at at least one end of a radiating element of the magnetic loop antenna,
wherein when the magnetic loop antenna is a magnetic loop aperture antenna or a magnetic loop left-hand antenna, at least one second inductor is arranged in series on a radiating element of the magnetic loop antenna,
wherein when an operating frequency band of the magnetic loop antenna is between 450 MHz to 1 GHz, an inductance value of the first inductor or the second inductor is set within [5 nH, 47 nH],
wherein when the operating frequency band of the magnetic loop antenna is between 1 GHz to 3 GHz, the inductance value of the first inductor or the second inductor is set within [1 nH, 33 nH], and
wherein when the operating frequency band of the magnetic loop antenna is between 3 GHz to 10 GHz, the inductance value of the first inductor or the second inductor is set within [0.5 nH, 10 nH].

22. The terminal antenna system of claim 21, wherein when the first antenna is a magnetic loop antenna, the second antenna is a current loop antenna.

23. The terminal antenna system of claim 21, wherein the first antenna and the second antenna being arranged at a same edge of the electronic device comprises the first antenna and the second antenna being arranged at a first edge of the electronic device, wherein projections of the first antenna and the second antenna at the first edge do not overlap.

24. The terminal antenna system of claim 23, wherein the terminal antenna system further comprises a third antenna arranged at the first edge, wherein projections in a direction perpendicular to a first direction that are of radiating elements of the third antenna, the first antenna, and the second antenna do not overlap, and wherein the second antenna is arranged between the first antenna and the third antenna.

25.-27. (canceled)

28. The terminal antenna system of claim 21, wherein the first antenna and the second antenna being arranged at two opposite edges of the electronic device comprises the first antenna being arranged at a first position at a first edge of the electronic device, and the second antenna being arranged at a second position at a second edge of the electronic device, wherein the first edge and the second edge are both adjacent to a third edge of the electronic device, and wherein the first position and the second position are axially symmetrical about a center line of the third edge.

29. (canceled)

30. An electronic device, comprising:
a radio frequency module;
one or more processors coupled to the radio frequency module; and
a terminal antenna system coupled to the radio frequency module, wherein when the electronic device transmits or receives a signal, the signal is transmitted or received through the radio frequency module and the terminal antenna system, wherein the terminal antenna system comprises:
a first antenna; and
a second antenna, wherein the first antenna and the second antenna comprise at least one current loop antenna or magnetic loop antenna,
wherein when the current loop antenna operates, a uniform magnetic field is distributed between a radiating element of the current loop antenna and a reference ground,
wherein when the magnetic loop antenna operates, a uniform electric field is distributed between a radiating element of the magnetic loop antenna and the reference ground, and
wherein the first antenna and the second antenna are either a) arranged at a same edge of the electronic device, or b) arranged at two opposite edges of the electronic device.

31. The electronic device of claim 30, wherein when the current loop antenna is a current loop monopole antenna or a current loop dipole antenna, a first capacitor that is grounded is arranged at at least one end of a radiating element of the current loop antenna,
wherein when the current loop antenna is a current loop aperture antenna or a current loop left-hand antenna, at least one second capacitor is arranged in series on a radiating element of the current loop antenna,
wherein when an operating frequency band of the current loop antenna is between 450 MHz to 1 GHz, a capacitance value of the first capacitor or the second capacitor is set within [1.5 pF, 15 pF],
wherein when the operating frequency band of the current loop antenna is between 1 GHz to 3 GHz, the capacitance value of the first capacitor or the second capacitor is set within [0.5 pF, 15 pF],
wherein when the operating frequency band of the current loop antenna is between 3 GHz to 10 GHz, the capacitance value of the first capacitor or the second capacitor is set within [1.2 pF, 12 pF]; and
wherein when the magnetic loop antenna is a magnetic loop monopole antenna or a magnetic loop dipole antenna, a first inductor that is grounded is arranged at at least one end of a radiating element of the magnetic loop antenna,
wherein when the magnetic loop antenna is a magnetic loop aperture antenna or a magnetic loop left-hand antenna, at least one second inductor is arranged in series on a radiating element of the magnetic loop antenna,
wherein when an operating frequency band of the magnetic loop antenna is between 450 MHz to 1 GHz, an inductance value of the first inductor or the second inductor is set within [5 nH, 47 nH],
wherein when the operating frequency band of the magnetic loop antenna is between 1 GHz to 3 GHz, the inductance value of the first inductor or the second inductor is set within [1 nH, 33 nH], and
wherein when the operating frequency band of the magnetic loop antenna is between 3 GHz to 10 GHz, the inductance value of the first inductor or the second inductor is set within [0.5 nH, 10 nH].
